(19) United States
(12) Patent Application Publication
(10) Pub. No.: US 2010/0141578 A1
(43) Pub. Date: Jun. 10, 2010

(54) IMAGE DISPLAY CONTROL APPARATUS, IMAGE DISPLAY APPARATUS, REMOTE CONTROLLER, AND IMAGE DISPLAY SYSTEM

(75) Inventors: Naoaki Horiuchi, Saitama (JP); Toshio Tabata, Saitama (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 11/996,748

(22) PCT Filed: Jul. 31, 2006
(86) PCT No.: PCT/JP2006/315134

§ 371 Date: Jan. 25, 2008

(30) Foreign Application Priority Data
Jul. 29, 2005 (JP) 2005-219743

(51) Int. Cl. G06F 3/033

(52) U.S. Cl. 345/158

(57) ABSTRACT

An image display control apparatus comprises a menu creating unit displays an operation menu ME on a liquid crystal display unit of an image display apparatus, a camera with an infrared filter capable of recognizing an infrared signal coming from a remote controller, a remote controller position identifying unit identifies the position which the remote controller occupies during image capturing on the basis of the recognition result, a remote controller position signal creating unit displays the identified position of the remote controller on the liquid crystal display unit, and a user operation judging unit determines the operable specification object in the operation menu displayed on the liquid crystal display unit.

### CROSS-REFERENCE TO RELATED APPLICATION

This application is based on Japanese Patent Application No. 2005-219743 filed on Jul. 29, 2005, the contents of which is incorporated hereinto by reference.

### BACKGROUND OF THE INVENTION

1. Field of the Invention

The present invention relates to an image display control apparatus configured to control a display on a display screen, in particular to an image display control apparatus, an image display apparatus, an image display system, and a remote controller used for each of them in remote operation.

2. Description of the Related Art

Fundamentally speaking, handheld remote controllers for operating an image display apparatus such as a television, for example, from a distant location are well known. When performing a remote operation, an operator can execute an operation (channel switching, audio switching, etc.) on the image display apparatus by displaying on the display screen of the image display apparatus, for example, an operable object (operation menu) wherein a plurality of operable specification objects (operation areas) are arranged, and operating the manual operation buttons of the remote controller to select and specify the corresponding area of the plurality of operable specification objects within the operable object.

The remote operation is not limited within the above-described image display apparatus itself, but can also be similarly performed on video output apparatus, content playing apparatus, or other products comprising a function that outputs video to image display apparatus (hereafter adequately referred to as “video output apparatus, etc.”), such as a video deck, DVD player/recorder, CD player/recorder, or MD player/recorder that is connected to a television, etc., outputs video to the television, etc, and further plays and outputs contents such as music, etc. That is, by remotely operating such a video output apparatus, etc., the operator displays an operable object (operation menu) comprising a plurality of operable specification objects (operation areas) related to the video output apparatus, etc., on a display screen of an image display apparatus connected the video output apparatus. Then, by selecting and specifying one of the plurality of operable specification objects, the operator can execute the selected and specified operation (video playing, programmed recording, etc.) of the video output apparatus, etc.

However, when the operator selects and specifies an operable specification object as described above, at first the operator watches the display screen to check which direction the desired operable specification object (operation area) is positioned from the presently selected and specified position (cursor position, etc.). After the check, the operator takes a look at the remote controller in hand and presses the operation button in a direction in which the position should be moved at, Furthermore the operator looks back to the display screen. The operator checks if the selected and specified position has surely been moved to the desired operable specification object and if the operable specification object has been selected as a result of operating the remote controller for sure. If the movement is insufficient, the operator has to look back to the remote controller in hand and repeat the same operation again. With such an extremely complicated and bothersome operation required such as the operator changes his/her line of sight many times, it makes the operator inconvenient.

In response to such issues, techniques have been proposed lately to improve operators remote controllability (for example, JP, A, 2001-5975, JP, A, 2004-178469).

The prior art described in JP, A, 2001-5975 discloses a control apparatus comprising a camera as an image capturing device, a movement detector that detects the movement of an image captured by the camera, and an image recognition device that recognizes the movement and/or shape of the image detected by the movement detector. When the operator moves a finger according to a predetermined pattern (i.e., makes a gesture), the movement of the finger captured by the camera is detected by the movement detector. The change in the movement and/or shape is recognized by the image recognition device. Thereby the operated device is controlled according to the pattern. With this arrangement, the operator can perform the desired operation on the operated device without using a remote controller.

The prior art described in JP, A, 2004-178469 discloses a remote control system comprising an infrared remote controller, an image sensor, and a gesture identifying device. When the operator waves around (i.e., makes a gesture with) the infrared remote controller according to a predetermined pattern, the gesture is identified by the gesture identifying device based on the direction of movement and the acceleration of the remote controller picked up by the image sensor, and the operated device is controlled according to that pattern via a network. With this arrangement, the operator can perform the desired operation on the operated device.

### SUMMARY OF THE INVENTION

In the prior art above described, when an operator wants to operate the operated device remotely, the operator has to memorize in advance the relation between desired operation and each corresponding gestures (for example, what kind of operation is executed how the operator moves he/her fingers or the remote controller). As for not memorized operation, the operator has to refer to the relation separately. Thus, as a result, this design takes a toll on the operator, and it makes the operator inconvenient.

Furthermore, besides the remote controller with the above described infrared communication and radio communication, if the operator uses a remote controller (so-called Pendant type) that is connected by wire (cable), etc. to the operated device and operated separately, There is still a problem, similar to the above one, which an extremely complicated and bothersome operation is required such as the operator changes his/her eyes many times, it makes the operator inconvenient.

It is therefore an object of the present invention to provide an image display control apparatus, an image display apparatus, an image display system, and a remote controller used for them that make it easy that an operator selects and specifies a desired operable specification object without looking away from the display screen, thereby improving the convenience of the operator during operation.

To achieve the above-described object, the present invention described in claim 1 comprises an object display signal generating device that generates an object display signal for displaying an operable object on a display screen provided in an image display apparatus; a second light image capturing device capable of recognizing, in distinction from a first light that comes from the background of a handheld controller, a second light that comes from said controller and shows condition and attributes different from said first light; a position identifying device that identifies the position which said controller occupies during image capturing by said second light image capturing device on the basis of the recognition result of said second light of said second light image capturing device; a position display signal generating device that generates a position display signal for displaying on said display screen the position of said controller identified by said position identifying device; and an operation area determining device that determines the operable specification object of said operable object displayed on said display screen, based on the position of said controller identified by said position identifying device.

To achieve the above-described object, the present invention described in claim 21 comprises a display screen; an object display control device that displays an operable object on said display screen; a second light image capturing device capable of recognizing, in distinction from a first light that comes from the background of a handheld controller, a second light that comes from said controller and shows condition and attributes different from said first light; a position identifying device that identifies the position which said controller occupies during image capturing by said second light image capturing device on the basis of the recognition result of said second light of said second light image capturing device; a position display controlling device that displays on said display screen the position of said controller identified by said position identifying device; and an operation area determining device that determines the operable specification object of said operable object displayed on said display screen, based on the position of said controller identified by said position identifying device.

To achieve the above-described object, the invention described in claim 22 is a handheld remote controller for performing image display operations, comprising an optical signal generating device that generates an optical signal having condition and attributes different from regular visible light; and an optical signal transmitting device that transmits said optical signal generated by said optical generating device to an image display control apparatus; wherein said image display control apparatus comprising a second light image capturing device capable of recognizing, in distinction from said regular visible light, said optical signal; a first device that generates a signal for displaying an operable object on a display screen; a second device that generates a signal for identifying and displaying on said display screen the position which said remote controller occupies during image capturing by said second light image capturing device in the video of the background of said remote controller, on the basis of the recognition result of said optical signal of said second light image capturing device; and a third device that generates a signal for determining and displaying the operable specification object of said operable object displayed on said display screen based on said identified position of said remote controller.

To achieve the above-described object, the invention described in claim 23 is an image display system comprising a handheld controller and an image display control apparatus that generates a signal for displaying an image based on the operation of said controller, wherein: said image display control apparatus comprises an object display signal generating device that generates an object display signal for displaying an operable object on a display screen provided in an image display apparatus; a second light image capturing device capable of recognizing, in distinction from a first light that comes from the background of said controller, a second light that comes from said controller and shows condition and attributes different from said first light; a position identifying device that identifies the position which said controller occupies during image capturing by said second light image capturing device on the basis of the recognition result of the second light of said second light image capturing device; a position display signal generating device that generates a position display signal for displaying on said display screen the position of said controller identified by said position identifying device; and an operation area determining device that determines the operable specification object of the operable object displayed on said display screen, based on the position of said controller identified by said position identifying device.

To achieve the above-described object, the image display system of the invention described in claim 24 comprises a handheld controller; an object display signal generating device that generates an object display signal for displaying an operable object on a display screen provided in an image display apparatus; a second light image capturing device capable of recognizing, in distinction from a first light that comes from the background of said controller, a second light that comes from said controller and shows condition and attributes different from said first light; a position identifying device that identifies the position which said controller occupies during image capturing by said second light image capturing device on the basis of the recognition result of said second light of said second light image capturing device; a position display signal generating device that generates a position display signal for displaying on said display screen the position of said controller identified by said position identifying device; and an operation area determining device that determines the operable specification object of said operable object, based on the position of said controller identified by said position identifying device.

### BRIEF DESCRIPTION OF THE DRAWINGS

FIG. 1 is a system configuration diagram of an image display system according to an embodiment of the present invention.

FIG. 2 is a functional block diagram shows the functional configuration of the remote controller shown in FIG. 1.

FIG. 3 is a functional block diagram shows the functional configuration of the image display control apparatus shown in FIG. 1.

FIG. 4 is a diagram shows an example of a display of a liquid crystal display unit.

FIG. 5 is a diagram shows an example of a display of a liquid crystal display unit.

FIG. 6 is a diagram shows an example of a display of a liquid crystal display unit.

FIG. 7 is a diagram shows an example of a display of a liquid crystal display unit.

FIG. 8 is a diagram shows an example of a display of a liquid crystal display unit.

FIG. 9 is a diagram shows an example of a display of a liquid crystal display unit of an image display system of an exemplary modification wherein instructions for determining an operation area are made by a gesture.

FIG. 10 is a functional block diagram shows the functional configuration of the image display control apparatus of the exemplary modification shown in FIG. 9.

FIG. 11 is a functional block diagram shows the function configuration of an exemplary modification wherein a camera with an infrared filter receives a remote controller instruction operation.

FIG. 12 is a functional block diagram shows the functional configuration of the image display control apparatus of an exemplary modification that employs a cold mirror.

FIG. 13 is a functional block diagram shows an example of a functional configuration of the image display control apparatus of an exemplary modification that performs position correction.

FIG. 14 is an explanatory diagram shows position correction.

FIG. 15 is a functional block diagram shows an example of a functional configuration of the image display control apparatus of another exemplary modification that performs position correction.

FIG. 16 is a characteristics diagram of an example of the sensitivity characteristics of a highly sensitive infrared camera of an exemplary modification that employs a highly sensitive infrared camera.

FIG. 17 is a functional block diagram shows the functional configuration of the image display control apparatus of the exemplary modification shown in FIG. 16.

FIG. 18 is an explanatory diagram for explaining an overview of the technique of an exemplary modification that changes the display magnification according to distance.

FIG. 19 is an explanatory diagram for explaining an overview of the technique of an exemplary modification that changes the display magnification according to distance.

FIG. 20 is an explanatory diagram for explaining an overview of the technique of an exemplary modification that changes the display magnification according to distance.

FIG. 21 is an explanatory diagram for explaining an overview of the technique of an exemplary modification that changes the display magnification according to distance.

FIG. 22 is an explanatory diagram for explaining an overview of the technique of an exemplary modification that changes the display magnification according to distance.

FIG. 23 is a functional block diagram shows the functional configuration of an image display control apparatus.

FIG. 24 is a functional block diagram shows in detail the configuration of a cutout processing unit.

FIG. 25 is a flowchart shows a control procedure executed by the cutout processing unit as a whole.

FIG. 26 is a flowchart shows in detail the procedure of step S50.

FIG. 27 is a functional block diagram shows the functional configuration of a cutout processing unit of an exemplary modification wherein the operator sets the operating arrange by himself/herself.

FIG. 28 is an explanatory diagram for explaining a technique for calculating distance from the size of a graphic of an inputted image.

FIG. 29 is an explanatory diagram for explaining an overview of an exemplary modification wherein the cutout area is changed for the purpose of obstacle avoidance.

FIG. 30 is an explanatory diagram for explaining a technique for creating and registering a database of possible obstacles.

FIG. 31 is an explanatory diagram for explaining an overview of an exemplary modification wherein the menu display area is shifted for the purpose of obstacle avoidance.

FIG. 32 is a functional block diagram shows the functional configuration of an image display control apparatus.

FIG. 33 is a functional block diagram shows in detail the configuration of a cutout processing unit and a secondary video combining unit with an obstacle judging unit.

FIG. 34 is a flowchart shows a control procedure executed by a cutout processing unit, a secondary video combining unit, and an obstacle judging unit, as a whole.

FIG. 35 is an explanatory diagram for explaining an overview of an exemplary modification wherein extension and supplementation is performed to ensure that the operational feeling of passing over an obstacle is obtained.

FIG. 36 is a functional block diagram shows the functional configuration of an image display control apparatus.

FIG. 37 is a flowchart shows a control procedure executed by a supplementation signal generating unit.

FIG. 38 is an explanatory diagram for conceptually explaining how the extended line is drawn.

FIG. 39 is an explanatory diagram for explaining an overview of an exemplary modification wherein intermediate area supplementation is performed to ensure that the operational feeling of passing over an obstacle is obtained.

FIG. 40 is a diagram shows an example of a display of a liquid crystal display unit of an image display apparatus of an exemplary modification applied to specifying a play position of stored contents.

FIG. 41 is a functional block diagram shows the functional configuration of the image display control apparatus of the exemplary diagram shown in FIG. 40.

FIG. 42 is a diagram shows another example of a display of a liquid crystal display unit.

FIG. 43 is a diagram shows an example of a display of a liquid crystal display unit of an image display apparatus of an exemplary modification applied to EPG.

FIG. 44 is a functional block diagram shows the functional configuration of the image display control apparatus of the exemplary diagram shown in FIG. 43.

FIG. 45 is a diagram shows an example of a display of a liquid crystal display unit of an image display apparatus of an exemplary modification wherein the captured image is omitted.

FIG. 46 is a functional block diagram shows the functional configuration of the image display control apparatus of the exemplary modification shown in FIG. 45.

FIG. 47 is a functional block diagram shows an example of a functional configuration of an image display control apparatus of an exemplary modification that employs a wired controller.

FIG. 48 is a diagram shows a display example of a liquid crystal display unit of an exemplary modification that limits the range selectable and specifiable from an operation menu, etc.

FIG. 49 is a diagram shows a display example of a liquid crystal display unit of an exemplary modification wherein all operation areas are selectable within a narrow remote controller movement range.

### DETAILED DESCRIPTION OF THE PREFERRED EMBODIMENTS

The following describes an embodiment of the present invention with reference to accompanying drawings.

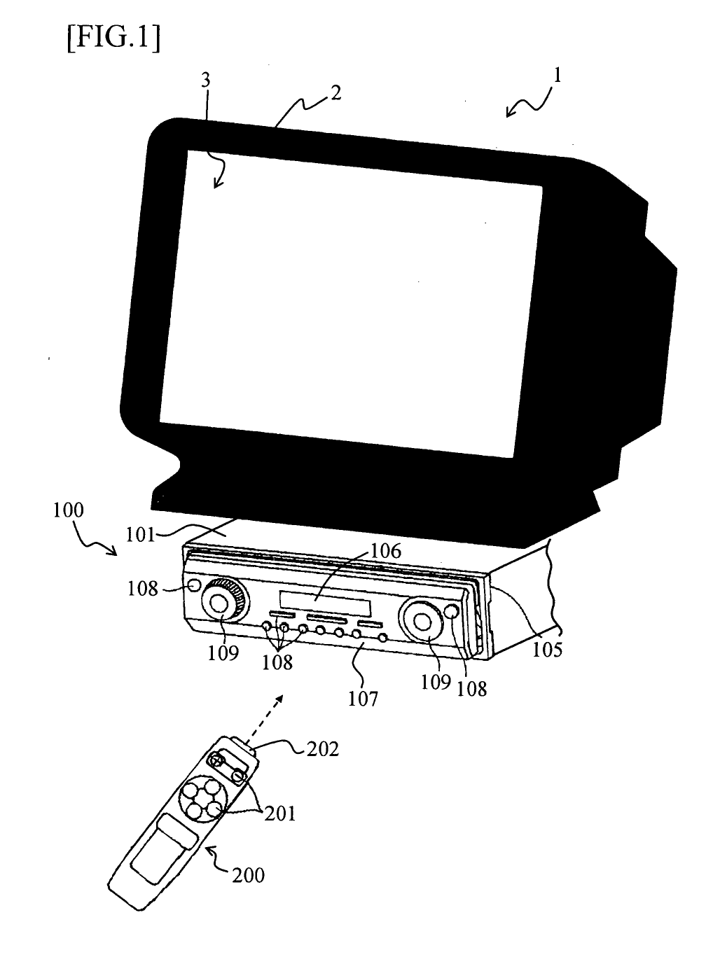

FIG. 1 is a system configuration diagram of an image display system according to the present embodiment. In FIG. 1, the image display system comprises an image display apparatus 1, an image display control apparatus 100 that generates a signal for displaying an image on the image display apparatus 1, and a handheld remote controller (remote control terminal) 200 for remotely controlling the image display control apparatus 100.

The image display apparatus 1 is, for example, a liquid crystal television, and is provided with a liquid crystal display unit 3 (display screen) on the front face of the television body 2. Although detailed drawings and descriptions will be omitted since known configurations will do, the television body 2 is provided with a known channel tuner that receives video waves for projection on the liquid crystal display unit 3, and a demodulation device that demodulates a video signal and an audio signal from the received wave, etc.

The remote controller 200 comprises an operating unit 201 provided with various operation keys and, an infrared driving unit (infrared light emitting unit) 202 provided with for example, an infrared light emitting diode as a light-emitting element.

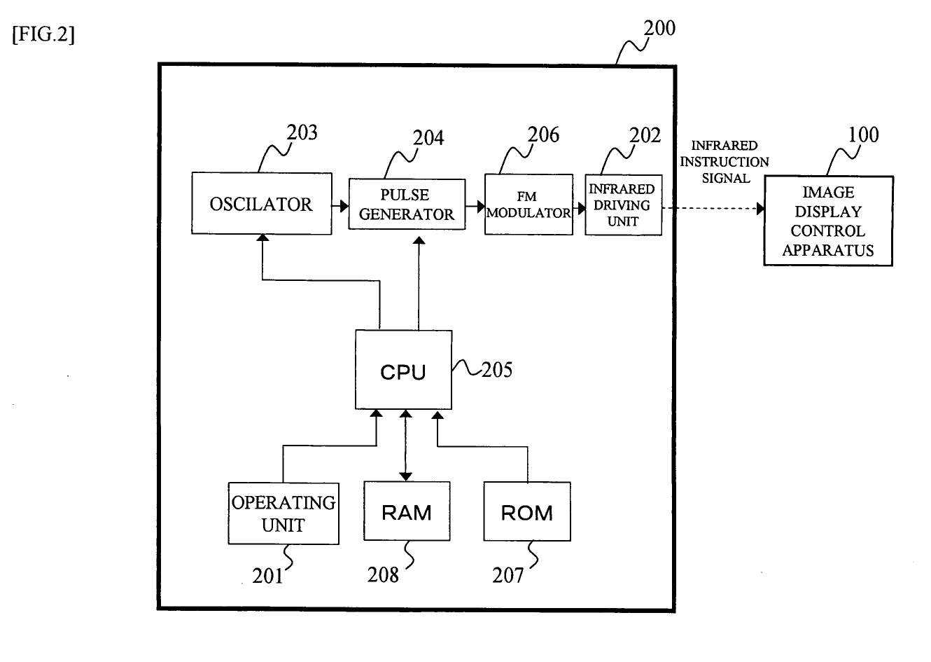

FIG. 2 is a functional block diagram shows the functional configuration of the remote controller 200. In FIG. 2 and the above FIG. 1, the remote controller 200 comprises an oscillator 203 that oscillates the carrier frequency of an identification code (described in detail later), a pulse modulator 204, a CPU 205 that controls the operation of the remote controller 200 in general, the operating unit 201, an FM modulator 206, the infrared driving unit 202 as a transmitting device, a ROM 207 that stores the application program, etc. for the CPU 205, and a RAM 208.

In the above-described configuration, a predetermined (for example, 38 kHz) carrier frequency is oscillated from the oscillator 203 based on a control signal from the CPU 205, and outputs to the pulse modulator 204. On the other hand, the CPU 205 reads the command (identification code) corresponding to the operation of the operating unit 201 from the RAM 207, and supplies the command to the pulse modulator 204. The pulse modulator 204 performs pulse modulation on the carrier frequency from the oscillator 203 using the identification code supplied from the CPU 205, and supplies the pulse modulated signal to the FM modulator 206. The FM modulator 206 performs FM modulation on the signal and supplies the FM modulated signal to the infrared driving unit 202. The infrared driving unit 202 drives (controls turning on and off) the above-described infrared light emitting element using the FM signal supplied from the FM modulator 206, thereby transmits an infrared instruction signal to the image display control apparatus 100.

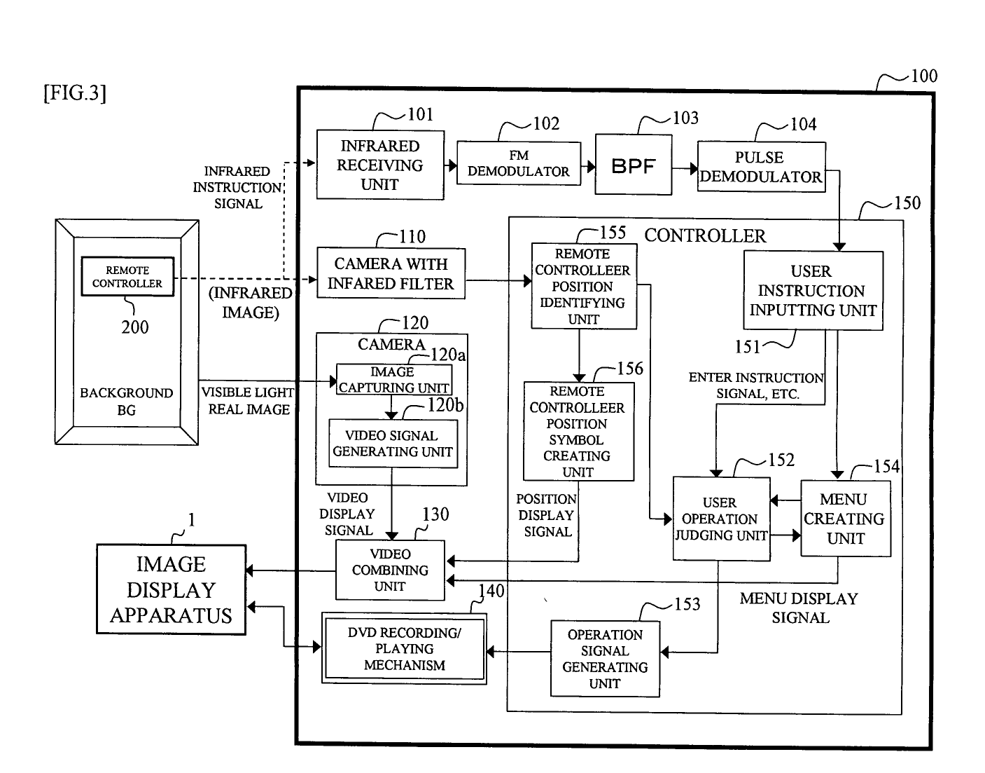

The image display control apparatus 100 is a DVD player/recorder in this example. The apparatus 100 comprises a housing 101 and an operating module 107 provided via a front panel 105 on the front side of the housing 101. On the front side of the operating module 107 is provided various operation buttons 108 as operating devices, a dial 109, and a light receiving port 106. Although detailed drawings and descriptions will be omitted since known configurations will do, a known DVD recording/playing mechanism 140 (refer to FIG. 3 described later) and a DVD storing unit, etc., are provided within the housing 101.

FIG. 3 is a functional block diagram shows the functional configuration of the above-described image display control apparatus 100. In FIG. 3, the image display control apparatus 100 comprises an infrared receiving unit 101 as a receiving device, an FM demodulator 102, a bandpass filter (BPF) 103 that extracts a predetermined (for example, 38 kHz) carrier frequency, a pulse demodulator 104, and a controller 150. The controller 150 comprises a CPU, ROM, RAM, etc. (not shown), and functionally comprises a user instruction inputting unit 151, a user operation judging unit 152, and an operation signal generating unit 153, etc., as shown in the figure.

In the above configuration, an infrared instruction signal emitted from the infrared driving unit 202 of the above mentioned remote controller 200 is received by the infrared receiving unit 101 via the light receiving port 106, subjected to photoelectric conversion by the infrared receiving unit 101, and supplied to the FM demodulator 102. The FM demodulator 102 demodulates and supplies the FM signal inputted from the infrared receiving unit 101 to the BPF 103. The BPF 103 extracts the pulse modulated signal using the above mentioned identification code from the supplied signals, and supplies the signal to the pulse demodulator 104. The pulse demodulator 104 demodulates the pulse modulated signal, and supplies the obtained identification code to the user instruction inputting unit 151 of the controller 150. The user operation judging unit 152 inputs and identifies (decodes) via the user instruction inputting unit 151 the identification code demodulated by the pulse demodulator 104, and outputs the corresponding operation instruction signal to the operation signal generating unit 153. The operation signal generating unit 153 generates a corresponding operation signal according to the operation instruction signal, and outputs to the above mentioned DVD recording/playing mechanism 140. The operation signal generating unit 153 makes DVD recording/playing mechanism 140 performs the corresponding operation (record, play, edit, program, dubbing, erase, clock, program guide, etc.).

With such an image display system having a basic configuration and operation, the greatest feature of the present embodiment is to use the infrared image of the remote controller 200 as a menu selection pointer with the menu screen related to the operation of the DVD recording/playing mechanism 140 is displayed on the image display apparatus 1. In the following, details of the functions will be described one by one.

In the image display control apparatus 100 shown in FIG. 3, a camera 110 with an infrared filter that recognizes, in distinction from visible light, an infrared signal (infrared image, optical signal, second light) emitted by the remote controller 200, a regular camera 120 (that performs image capturing using visible light), and a video combining unit 130 make up the configuration related to the above-described feature of the present embodiment.

The camera 120 comprises an image capturing unit 120a (first light image capturing device) that captures visible light (the first light) that comes from the background BG of the remote controller 200 (that comes from the remote controller 200 itself as well), and a video signal generating unit 120b (video display signal generating device) that generates a video display signal for displaying the captured background BG of the remote controller 200 on the liquid crystal display unit 3 of the image display apparatus 1.

The controller 150, in addition to the previously described configuration, comprises a menu creating unit 154 (object display signal generating device), a remote controller position identifying unit 155 (position identifying device), and a remote controller position symbol creating unit 156 (position display signal generating device).

When the operator S intends to perform a predetermined operation on the image display control apparatus 100 and stands in front of the image display control apparatus 100 with the remote controller 200 in hand, the captured video of the real world where the operator S exists (i.e., the video of the remote controller 200 and background BG) is captured by the image capturing unit 120a of the camera 120, and the video signal is inputted to the image display apparatus 1 via the video combining unit 130 from the video signal generating unit 120b. With this arrangement, the real world in which the operator S exists is displayed on the liquid crystal display unit 3 of the image display apparatus 1.

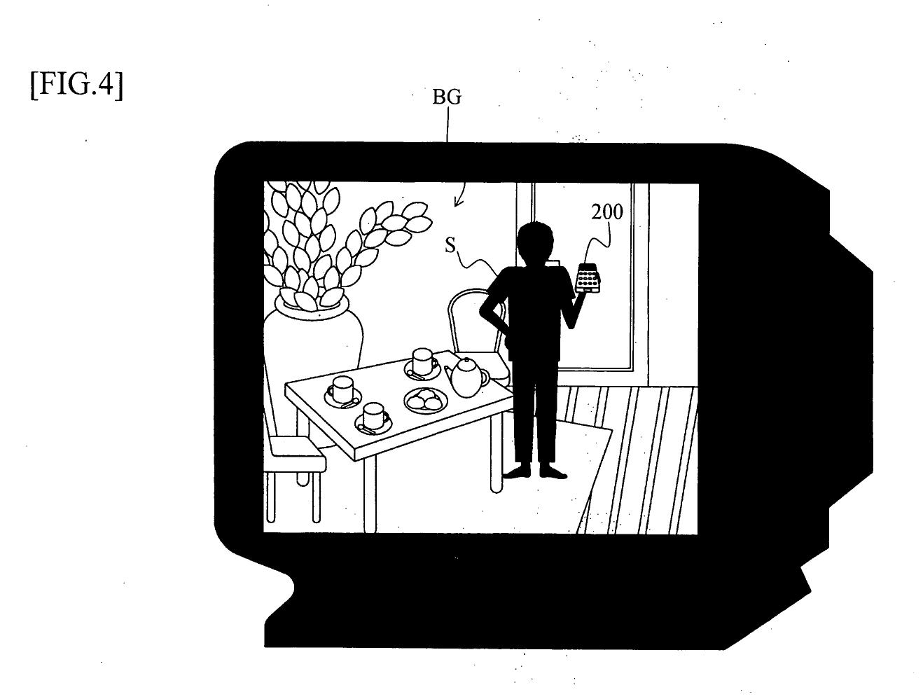

FIG. 4 is a diagram shows an example of a display of the liquid crystal display unit 3 at this time. In the example of FIG. 4, the operator S holding the remote controller 200 and the landscape of the room where the operator S exists (in this example, the door, floor, floor carpet, and furniture such as a table and chairs, etc.) are displayed on the screen as the background BG.

In this state, when the operator S holds the remote controller 200 and appropriately operates the operating unit 201 to display the operation menu of the image display control apparatus 100, an identified corresponding infrared instruction signal is emitted from the infrared driving unit 202. The signal is received by the infrared receiving unit 101 of the image display control apparatus 100, and the identification code corresponding to the user instruction inputting unit 151 of the controller 150 is inputted and decoded via the FM demodulator 102, the BPF 103, and the pulse demodulator 104. In the user instruction inputting unit 151, a created instruction signal is inputted to the menu creating unit 154 in response. The menu creating unit 154 generates a menu display signal (object display signal) for displaying the operation menu (operable object) comprising a plurality of operation areas (described later) on the liquid crystal display unit 3 of the image display apparatus 1. This menu display signal is combined with a video display signal from the video signal generating unit 120b of the camera 120 and the combined signal is outputted to the image display apparatus 1 by the video combining unit 130. Thereby the liquid crystal display unit 3 displays a combined video of the video captured by the camera 120 and the menu display from the menu creating unit 154 (transitioning the mode to menu selection mode or, in other words, a screen position selection mode). While the mode is transitioned to menu selection mode (until menu selection mode ends), the identified infrared instruction signal (preferably with low power consumption) is continually transmitted from the remote controller 200, thereby relaying to the image display control apparatus 100 that the mode is in menu selection mode (a screen position selection mode).

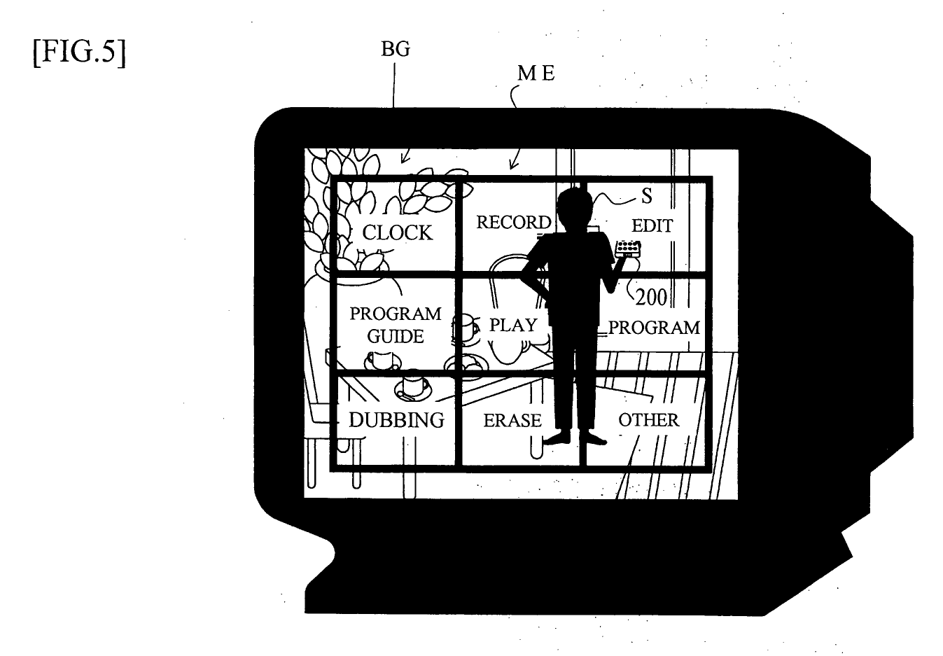

FIG. 5 is a diagram shows an example of a display of the liquid crystal display unit 3 at this time. In the example of FIG. 5, similar to FIG. 4, the operator S holding the remote controller 200 and the background BG (in this example, the door, floor, floor carpet, and furniture such as a table and chairs, etc.) of the room where the operator S exists are displayed as captured video based on the video display signal from the video signal generating unit 120b. Additionally an operation menu ME comprises a plurality of areas indicating each operation such as “Clock (Set Time),” “Record,” “Edit,” “Program Guide,” “Play,” “Program,” “Dubbing,” “Erase,” and “Other,”, which are displayed based on the menu display signal from the menu creating unit 154.

On the other hand, the identified infrared instruction signal to be outputted from the remote controller 200 held by the operator S is captured and recognized by the camera 110 with an infrared filter as an infrared image, and the captured signal is inputted to the remote controller position identifying unit 155. The remote controller position identifying unit 155 identifies the position which the remote controller 200 occupies during image capturing by the camera 110 with an infrared filter, based on the recognition result of the infrared image by the remote controller 200 of the camera 110 with an infrared filter.

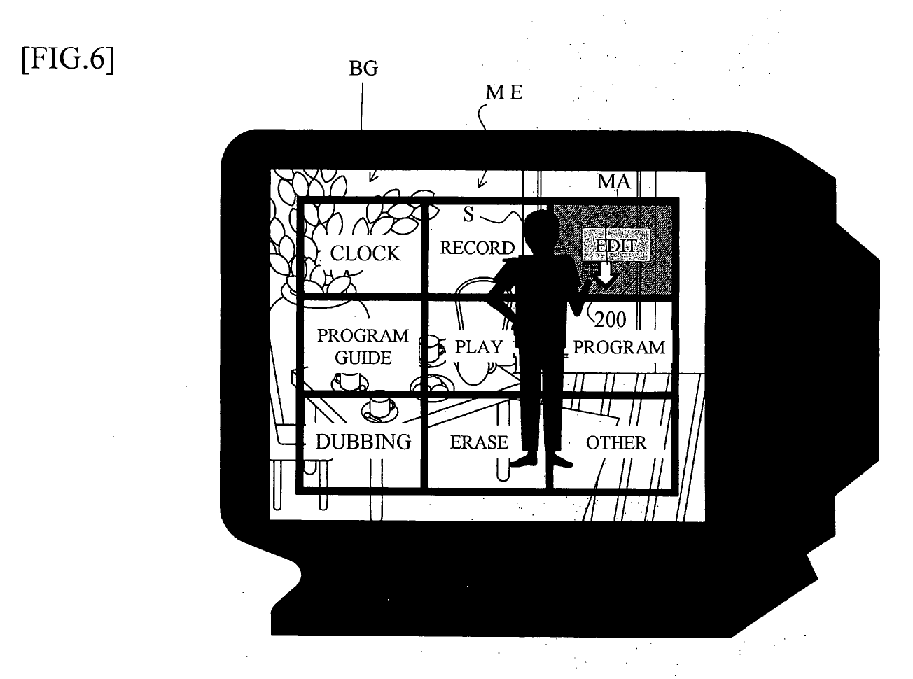

The position information of the remote controller 200 identified by the remote controller position identifying unit 155 is inputted to the remote controller position symbol creating unit 156. A position display signal for displaying the position of the remote controller 200 on the liquid crystal display unit 3 is generated. The generated position display signal is inputted to the video combining unit 130, thereby superimposing and displaying a predetermined position display MA (in this example, arrow symbol; refer to FIG. 6 described later) at (or near) the captured position of the remote controller 200 on liquid crystal display unit 3. With this arrangement, by holding the remote controller 200 and moving its position (spatially changing its location), the operator S can move on the liquid crystal display unit 3 the position display MA of the remote controller 200 that displayed superimposed on the operation menu ME on the liquid crystal display unit 3.

On the other hand, the position information of the remote controller 200 identified by the remote controller position identifying unit 155 is also inputted to the user operation judging unit 152. At this situation, information (what kind of contents, arrangement, and condition it is) related to the menu display of the menu display signal created by the menu creating unit 154 is also inputted to the user operation judging unit 152.

When the operator S moves the handheld remote controller 200 to shift the position display MA on the liquid crystal display unit 3, and appropriately operates the operating unit 201 (presses the “Enter” button, for example) to determine the operation of the operation area when the position display MA arrives in the desired operation area of the operation menu ME. The corresponding infrared instruction signal is emitted from the infrared driving unit 202 and received by the infrared receiving unit 101 of the image display control apparatus 100. The identification code corresponding to the user instruction inputting unit 151 of the controller 150 is inputted and decoded via the FM demodulator 102, the BPF 103, and the pulse demodulator 104 (the instruction signal inputting device). In response, in the user instruction inputting unit 151, the enter instruction signal is inputted to the user operation judging unit 152.

The user operation judging unit 152 to which the enter instruction signal was inputted determines the selected and specified operation area (operable specification object) of the operation menu ME displayed on the liquid crystal display unit 3 based on the position information of the remote controller 200 acquired from the above mentioned remote controller position identifying unit 155 and the menu display information acquired from the menu creating unit 154. The user operation judging unit 152 inputs the corresponding signal to the menu creating unit 154. The menu creating unit 154 generates and outputs to the video combining unit 130 a menu display signal such as a signal that displays the selected and specified operation area in a form different from the other areas, based on the inputted signal.

FIG. 6 is a diagram shows an example of a display of the liquid crystal display unit 3 at this time. The example of FIG. 6 shows the state when the operator S intends to edit the DVD as below. The operator puts the handheld remote controller at the “Edit” area on the operation menu ME on the liquid crystal display unit 3. The operation menu ME comprises the “Clock,” “Record,” “Edit,” “Program Guide,” “Play,” “Program,” “Dubbing,” “Erase,” and “Other” areas (refer to the arrow symbol). The operator S presses the above mentioned “Enter” button. In this example, the selected and specified “Edit” area is displayed in a color different from that of the other areas based on the menu display signal from the menu creating unit 154. Then, in this case, the operation instruction signal corresponding to the selection and specification of the “Edit” area is outputted from the user operation judging unit 152 to the operation signal generating unit 153. The operation signal generating unit 153 outputs in response the corresponding operation signal to the DVD recording/playing mechanism 140, and the corresponding edit operation is performed.

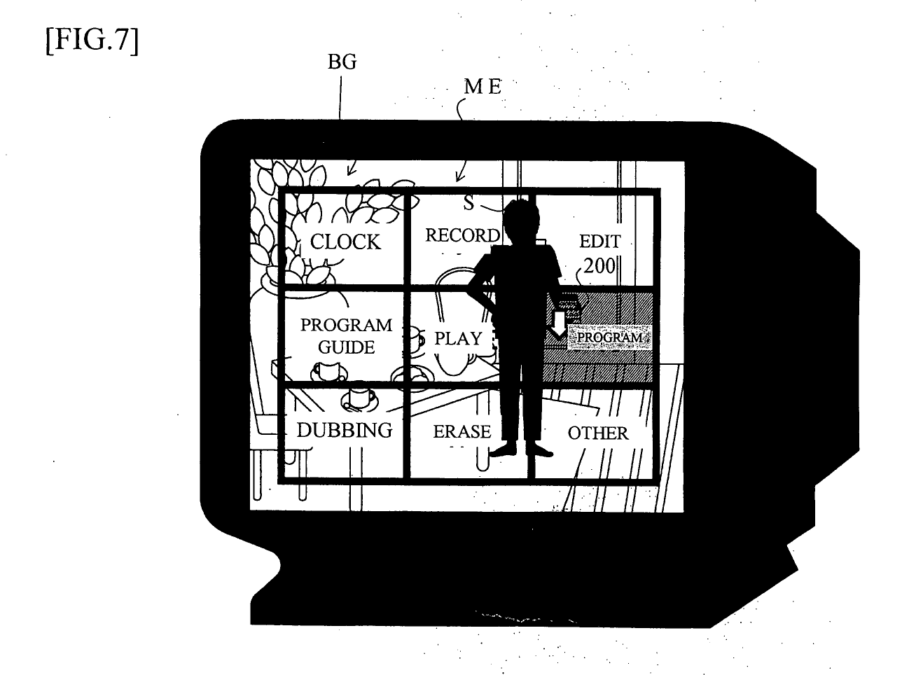

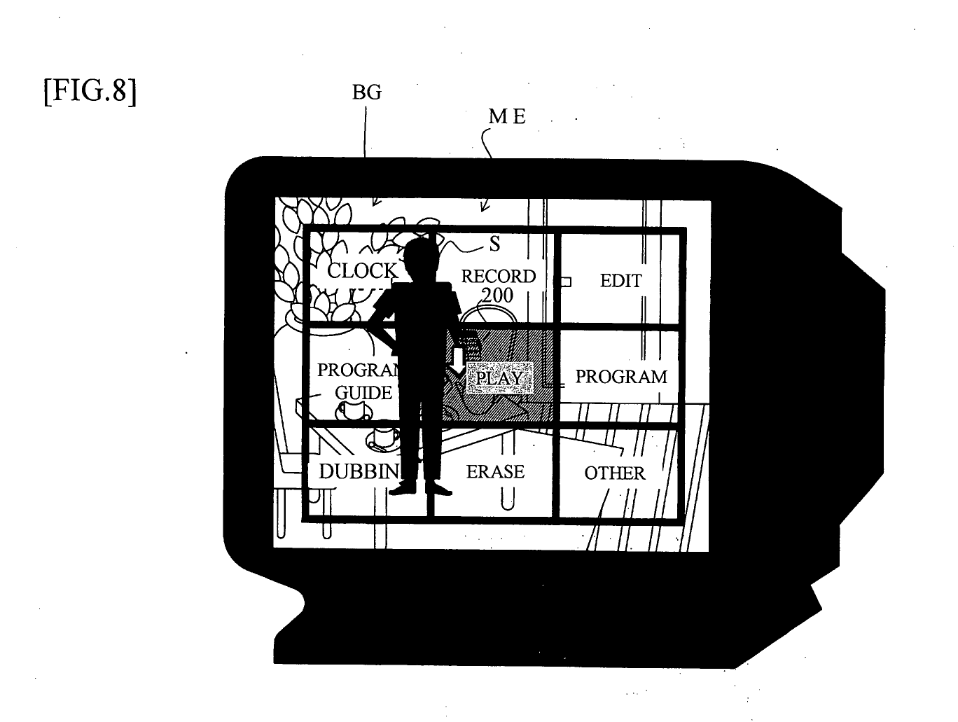

Similarly, FIG. 7 shows the state when the operator S intends to program a recording on a DVD, and shifts moves the position of the remote controller 200 on the liquid crystal display unit 3 to the “Program” area and presses the “Enter” button. FIG. 8 shows the state when the operator S, intends to play a DVD and shift the position of the remote controller 200 on the liquid crystal display unit 3 to the “Play” area and presses the “Enter” button. Then, in each of these cases, it is similar to the above described, the operation instruction signal corresponding to the selection and specification of the “Program” or “Play” area is outputted from the user operation judging unit 152 to the operation signal generating unit 153. The corresponding operation signal from the operation signal generating unit 153 is outputted to the DVD recording/playing mechanism 140. The corresponding program or play operation is performed. Almost same operation are needed for the other “Clock,” “Record,” “Program Guide,” “Dubbing,” “Erase,” and “Other” areas.

In the above, the oscillator 203, the pulse modulator 204, the FM modulator 206, etc. on the remote controller 200 constitute the optical signal generating device described in each claims that generates an optical signal with condition and attributes different from regular visible light. The infrared driving unit 202 comprises an optical signal transmitting device that transmits the optical signal generated by the optical generating device to an image display control apparatus; wherein the image display control apparatus comprising a second light image capturing device capable of recognizing, in distinction from the regular visible light, the optical signal; a first device that generates a signal for displaying an operable object on a display screen; a second device that generates a signal for identifying and displaying on the display screen the position which the remote controller occupies during image capturing by the second light image capturing device in the video of the background of the remote controller on the basis of the recognition result of the optical signal of the second light image capturing device; and a third device that generates a signal for determining and displaying the operable specification object of the operable object displayed on the display screen, based on the identified position of the remote controller.

As described above, the present embodiment comprises the menu creating unit 154 that creates a menu display signal for displaying an operation menu ME on the liquid crystal display unit 3 provided in the image display apparatus 1; the camera 110 with an infrared filter capable of recognizing, in distinction from visible light that comes from the background of the remote controller 200, an infrared signal that comes from the remote controller 200 and shows condition and attributes different from the visible light; the remote controller position identifying unit 155 that identifies the position which the remote controller 200 occupies during image capturing by the camera 110 with an infrared filter on the basis of the recognition result of the infrared signal of the camera 110 with an infrared filter; the remote controller position signal creating unit 156 that generates a position display signal for displaying on the liquid crystal display unit 3 the position of the remote controller 200 identified by the remote controller position identifying unit 155; and the user operation judging unit 152 that determines the operation area of the operation menu ME displayed on the liquid crystal display unit 3 based on the position of the remote controller 200 identified by the remote controller position identifying unit 155, thereby enabling use of the position display MA of the remote controller 200 on the liquid crystal display unit 3 as a pointer (operation position specifying device) for selecting and specifying an operation area from the operation menu ME. As a result, the operator S can easily select and specify a desired operation area of the operation menu ME and perform the corresponding operation using the very physically and intuitively easy-to-understand operation of moving the position of the remote controller 200 itself without looking away from the liquid crystal display unit 3. At this time, there is no need for the operator S to memorize gestures as in the case of prior art, thereby eliminating any increase of the burden on the operator and improving the convenience of the operator during remote control.

The present embodiment particularly comprises the image capturing unit 120a of the camera 120 that captures the image of visible light coming from the background BG of the remote controller 200, and a video signal generating unit 120b that generates a video display signal for displaying on the liquid crystal display unit 3 the background BG captured by the image capturing unit 120a. With this arrangement, when the operator S holds the remote controller 200 and shifts its position to utilize the position display MA of the remote controller 200 as a pointer of the operation menu ME, a real video of the background BG of the remote controller 200 captured by the camera 120 appears on the liquid crystal display unit 3. That makes the operator S moves the remote controller 200 while checking the operation condition and operation distance, etc., on the display screen. That also makes the operator S has a more intuitive and easy-to-understand operation. Since it is also possible for the operator S to recognize the light receivable area of the camera 110 with an infrared filter based on the video projected on the liquid crystal display unit 3, the present embodiment prevents the operator S from moving the remote controller 200 outside the light receivable area, thereby improving operation certainty.

Furthermore, in the present embodiment, in particular the menu creating unit 154, the remote controller position signal creating unit 156, and the video signal generating unit 120b generate a menu display signal, a position display signal, and a video display signal for displaying the operation menu ME, the position of the remote controller 200, and the background BG of the remote controller 200 superimposed on the liquid crystal display unit 3. With this arrangement, the operation menu ME and the position display MA of the remote controller 200 are displayed on the liquid crystal display unit 3 so that they are superimposed on the captured video of the background BG of the remote controller 200 captured by the camera 210. Thereby it is possible for the operator S to perform to intuitively comprehend which position of the liquid crystal display unit 3 he or she is specifying, resulting in an even easier-to-understand intuitive operation.

Furthermore, in the present embodiment, particularly the menu creating unit 154 generates a menu display signal for displaying on the liquid crystal display unit 3 the operation area determined by the user operation judging unit 152 of the operation menu ME in condition different from that of the other areas. With this arrangement, the color of the operation area of the operation menu ME specified as the operation target by the operator S changes from that of the other operation areas, making the specified position visually obvious at a glance. As a result, it is possible for the operator S to surely recognize witch operation area the operator S specified and to make the operator S feel easy to complete specification of the operation area for sure.

The present embodiment particularly comprises a user instruction inputting unit 150 that inputs an instruction signal corresponding to the “Enter” operation from the remote controller 200. The user operation judging unit 152 determines the operable specification object of the operation menu ME according to the position of the remote controller 200 identified by the remote controller position identifying unit 155 and the enter instruction signal inputted by the user instruction inputting unit 151. That is, the operation area of the operation target of the operation menu ME is finally determined when the operator S performs an appropriate operation (presses the “Enter” button) using the remote controller 200 and the enter instruction signal is inputted from the user instruction inputting unit 151 to the user operation judging unit 152. With this arrangement, a true operational feeling of the operator S is ensured, it is possible to prevent for the operator S to mistake specifying an unintended operation area. That makes the operator S feels easy. The instruction signal to be outputted when the operator S presses the “Enter” button on the controller 200 to provide an enter instruction signal is not limited within an infrared instruction signal, but another radio signal such as an electromagnetic wave that includes visible light.

In the present embodiment, it is also possible to perform the operation of prior art using only the operating unit 201 of the remote controller 200. In this operation, the infrared instruction signal from the remote controller 200 is received by the infrared receiving unit 101, and the operation signal from the operation signal generating unit 153 is inputted to the DVD recording/playing mechanism 140 via the FM demodulator 102, the BPF 103, the pulse demodulator 104, the user instruction inputting unit 151, and the user operation judging unit 152.

Note that various modifications may be made according to the present embodiment without departing from the spirit and scope of the invention, in addition to the above-described embodiment. The following descriptions will be given of such exemplary modifications one by one.

(1) When the Operation Area is Determined by a Gesture

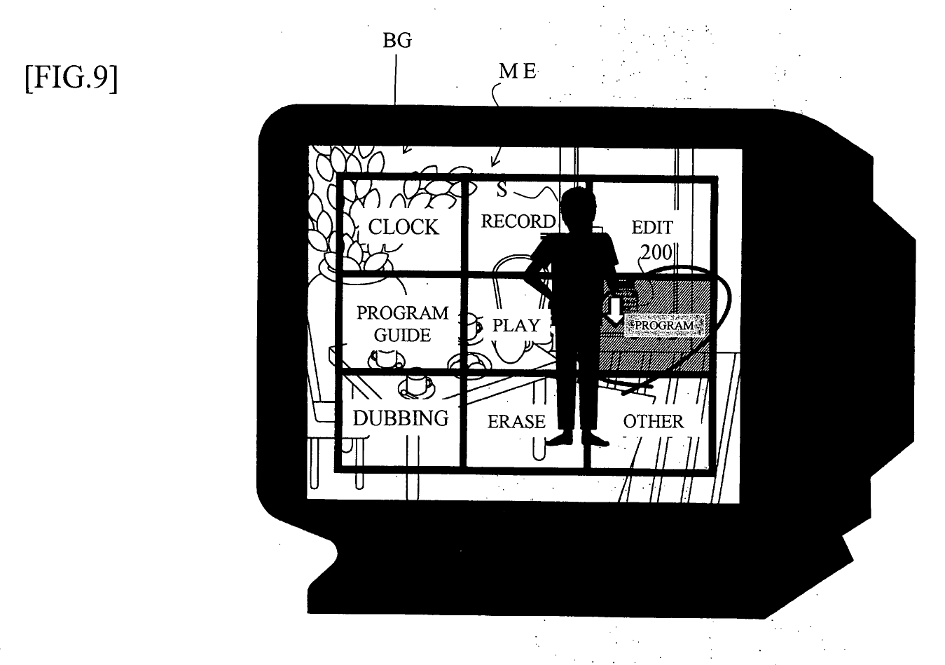

FIG. 9 is a diagram shows an example of a display of the liquid crystal display unit 3 of the image display apparatus 1 in the image display system of the present exemplary modification, and corresponds to the above mentioned FIG. 6. Note that the component parts identical to those in FIG. 6 are denoted by the same reference numerals. In the foregoing embodiment, for example, in a case where the operator S intends to edit a DVD, the operator S positions the position of the handheld remote controller 200 on the liquid crystal display unit 3 in the “Edit” area of the operation menu as shown in FIG. 6, and selects and specifies the operation area by pressing the “Enter” button, for example. In the present exemplary modification, however, rather than pressing the “Enter” button, the operator selects and specifies the operation area by moving the remote controller 200 in a predetermined shape (in a circle in this example; equivalent to a gesture), as shown in FIG. 9. In the example shown in FIG. 9, the operator S, intending to program a DVD for recording, positions the position of the handheld remote controller 200 on the liquid crystal display unit 3 to the “Program” area of the operation menu ME, and selects and specifies the “Program” operation area by waving around the remote controller 200 in or near the area as if drawing a roughly circular or elliptical shape.

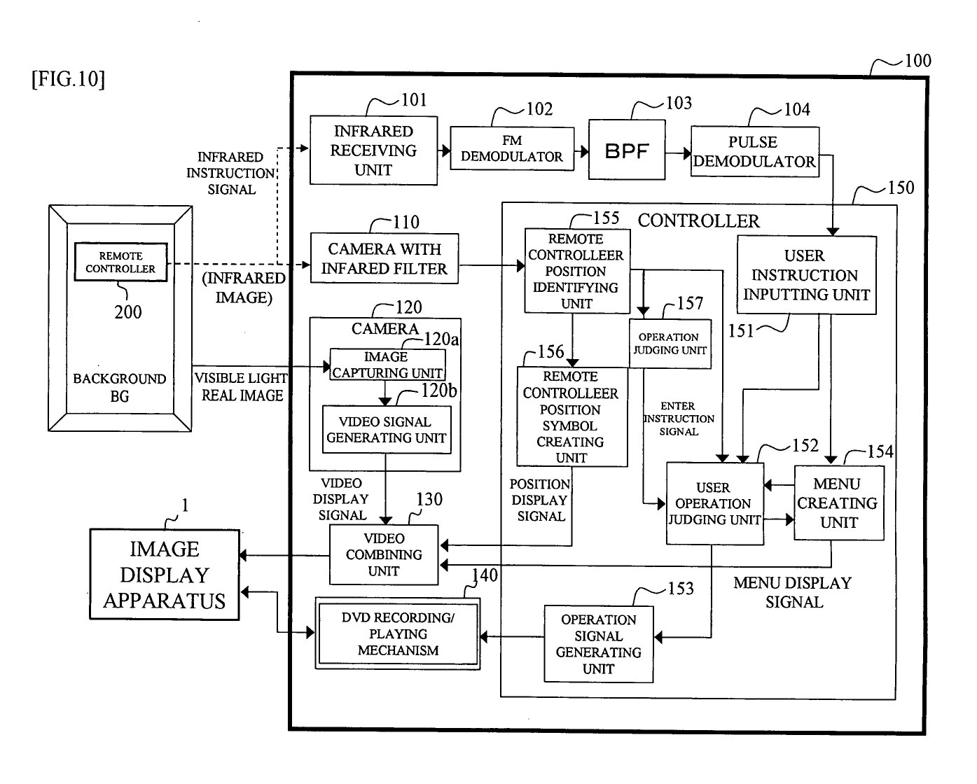

FIG. 10 is a functional block diagram shows the functional configuration of the image display control apparatus 100 of the present exemplary modification, and corresponds to FIG. 3 of the foregoing embodiment. Note that the parts identical to those in FIG. 3 are denoted using the same reference numerals, and descriptions thereof will be suitably omitted. In FIG. 10, unlike FIG. 3, a movement judging unit 157 that judges the movement of the infrared image of the remote controller 200 is newly provided in the controller 150.

That is, similar to the foregoing embodiment, when the operator S moves the handheld remote controller 200 to move the position display MA on the liquid crystal display unit 3 and the position display MA arrives in the desired operation area of the operation menu ME, the operator S waves around the remote controller 200 in or near the area as if drawing a roughly circular or elliptical shape to enter the operation of the operation area. At this time, the infrared image of the remote controller 200 is captured and recognized by the camera 110 with an infrared filter as described above, and the captured signal is inputted to the remote controller position identifying unit 155 and then inputted from the remote controller position identifying unit 155 to the movement judging unit 157. When the remote controller 200 is waved around as described above, the movement judging unit 157 recognizes the waving movement, judges that the operator S has selected and specified the area as the operation target, and inputs the enter instruction signal to the user operation judging unit 152. The subsequent operations are the same as the foregoing embodiment, and descriptions thereof will be omitted.

The exemplary modification above also provides advantages similar to those in the foregoing embodiment. Further, because final confirmation of the selection and specification of the operation area does not require operation of the operating unit 200 of the remote controller 200, the operator S can more assuredly perform the operation without looking away from the liquid crystal display unit 3.

(2) When the Camera with an Infrared Filter Receives the Remote Controller Instruction Operation

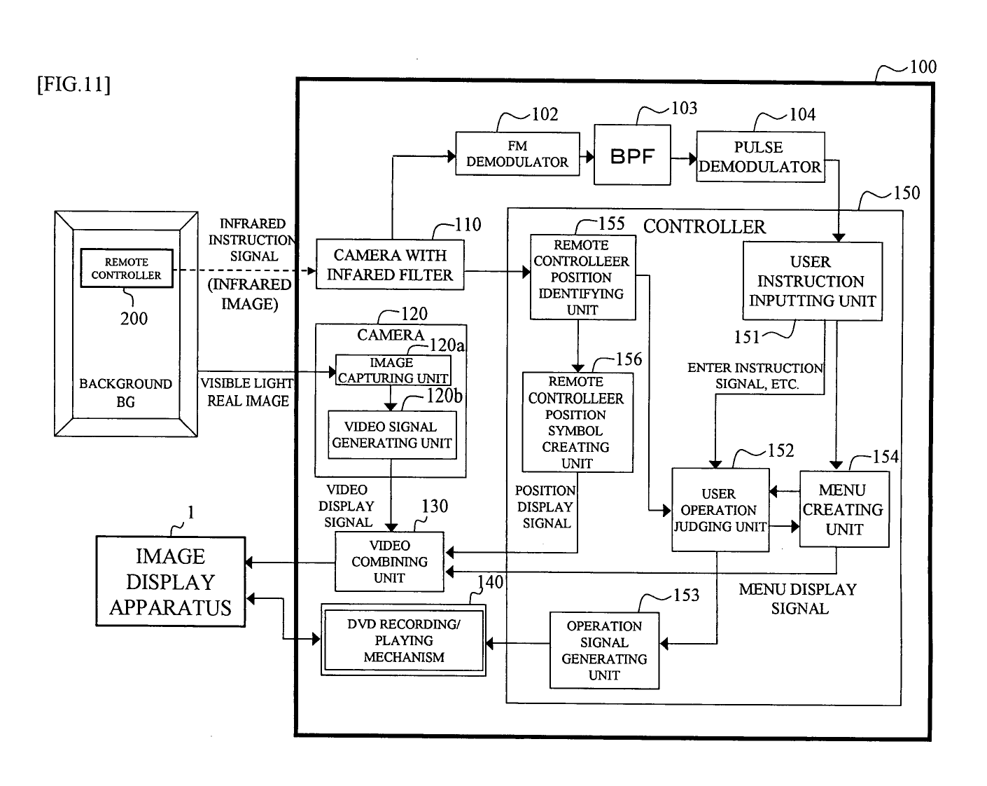

FIG. 11 is a functional block diagram shows the functional configuration of the image display control apparatus 100 of the present exemplary modification, and corresponds to FIG. 3 of the foregoing embodiment. Note that the parts identical to those in FIG. 3 are denoted using the same reference numerals, and descriptions thereof will be suitably omitted. In FIG. 11, unlike FIG. 3, the infrared receiving unit 101 is omitted, and the infrared instruction signal from the remote controller 200 is received by the camera 110 with an infrared filter and supplied to the FM demodulator 102 after optical/electrical conversion by a converting device provided in the camera 110 with an infrared filter (not shown; may be provided separately from the camera 110). The subsequent operations are the same as the foregoing embodiment, and descriptions thereof will be omitted.

The present exemplary modification also provides advantages similar to those in the foregoing embodiment.

(3) When a Cold Mirror is Used

For example, when the camera 110 with an infrared filter and the regular camera 120 are provided separately, as shown in FIG. 3 of the foregoing embodiment, although the respective images captured do not exactly match due to the variance in the lens positions of the two cameras 110 and 120, when the operator S is a sufficient distance away from the cameras, the difference between the two cameras 110 and 120 is unproblematic from a practical standpoint. Nevertheless, that difference increases to the extent that it can no longer be ignored as the operator S comes closer to these cameras 110 and 120, resulting in the possibility, for example, of increasing variance between the position of the remote controller 200 identified by the remote controller position identifying unit 155 based on the captured signal of the camera 110 with an infrared filter, and the real video of the remote controller 200 displayed on the liquid crystal display unit 3 based on the video display signal from the camera 120. The present exemplary modification is designed to support such a case.

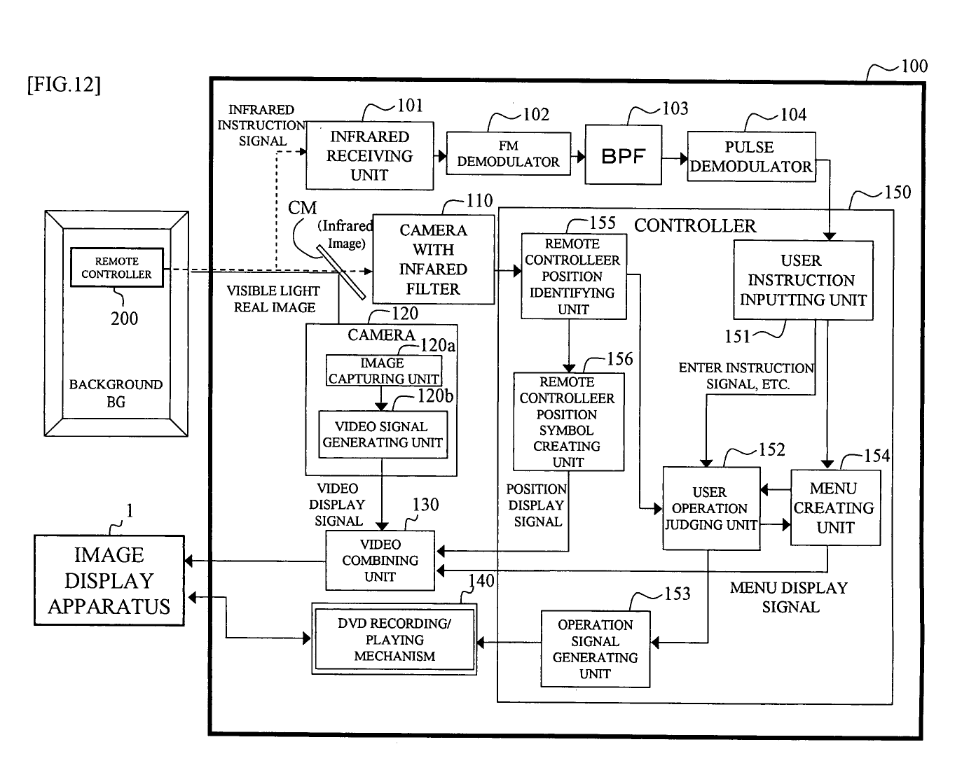

FIG. 12 is a functional block diagram shows the functional configuration of the image display control apparatus 100 of the present exemplary modification, and corresponds to the above FIG. 3 and FIG. 11. Note that the parts identical to those in FIG. 3 are denoted using the same reference numerals, and descriptions thereof will be suitably omitted. In FIG. 12, in the exemplary embodiment, a known cold mirror CM comprising a function that transmits infrared light to and reflects visible light from the incoming side of the camera 110 with an infrared filter (i.e., a dispersing function) is provided so that the infrared light from the remote controller 200 and the visible light from the background BG of the remote controller 200 are introduced to the camera 110 with an infrared filter at the same optical axis. Then, the cold mirror CM provided on that optical axis disperses the infrared light from the remote controller 200 and the visible light from the background BG of the remote controller 200, thereby transmitting and introducing the infrared light as is to the camera 110 with an infrared filter, and reflecting the visible light so as to change its direction and introduce the light to the camera 120. The subsequent operations are the same as the foregoing embodiment, and descriptions thereof will be omitted.

In the present exemplary modification of the above configuration, the video inputted to the two cameras 110 and 120 is the same. As a result, a difference in image capturing does not occur between the two cameras 110 and 120 even if the operator S is in a position sufficiently near the cameras 110 and 120, thereby achieving the advantage of reliably preventing any adverse effects caused by such a variance in the position of the remote controller 200 as described above.

(4) When Position Correction is Performed

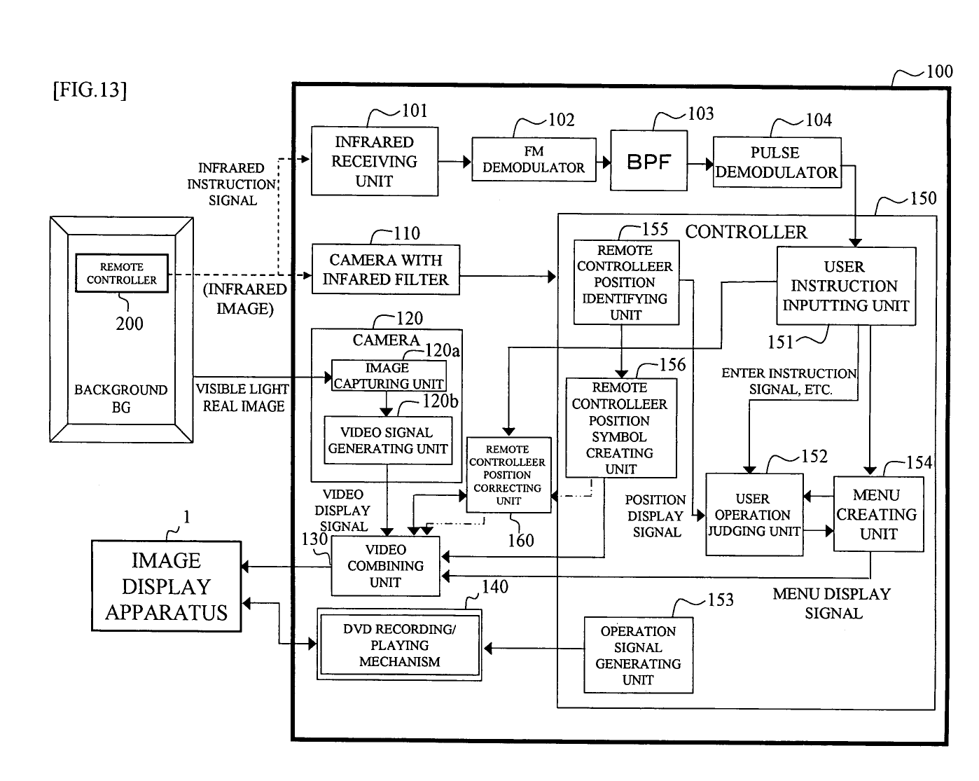

As described above, in a case where the camera 110 with an infrared filter and the regular camera 120 are provided, the respective images captured do not exactly match (position variance occurs) due to the variance in the lens positions of the two cameras 110 and 120. When this difference increases to the extent that it can no longer be ignored, rather than using a technique that eliminates the difference in image capturing itself by using a cold mirror CM as in (3) above, the position of one of the signals may be corrected (calibrated) to eliminate that difference. This exemplary modification will now be described with reference to FIG. 13 to FIG. 15.

FIG. 13 is a functional block diagram shows an example of the functional configuration of the image display control apparatus 100 of this exemplary modification, and corresponds to the above FIG. 3 and FIG. 11. Note that the parts identical to those in FIG. 3 are denoted using the same reference numerals, and descriptions thereof will be suitably omitted. In FIG. 13, in the present exemplary modification, a remote controller position correcting unit 160 (correcting device) for performing the above-described signal correction is newly provided. This remote controller position correcting unit 160 performs a predetermined correction (described in detail later) on the position display signal identified by the remote controller position identifying unit 155, generated by the remote controller position symbol creating unit 156, and inputted to the video combining unit 130, according to the instruction signal (described in detail later) from the user instruction inputting unit 151. The position display signal after this correction is inputted to the video combining unit 130 and combined with the video display signal from the video signal generating unit 120b.

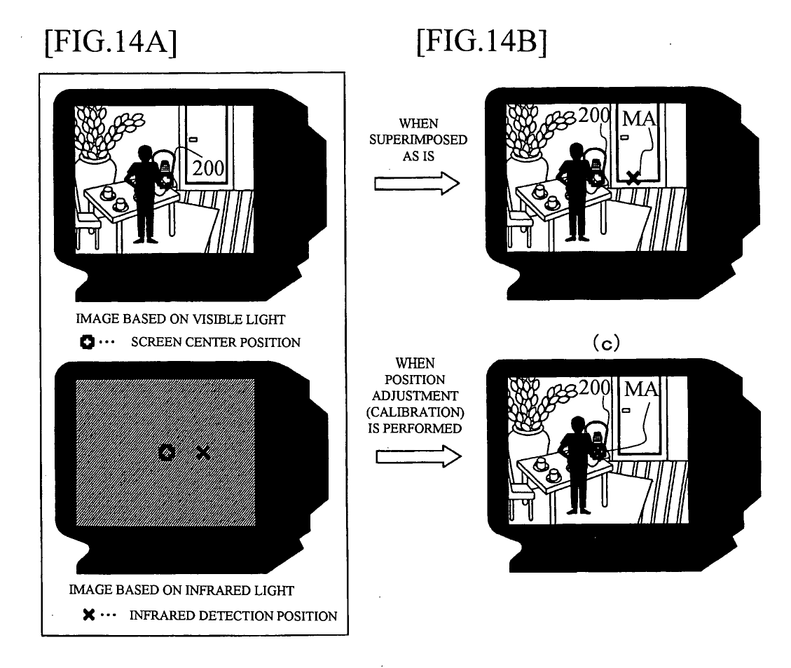

FIG. 14A to FIG. 14C are explanatory diagrams shows the state of the above-described position correction. In the present exemplary modification, for example, position correction is performed as follows.

As described with reference to FIG. 4 in the foregoing embodiment, when the operator S stands in front of the image display control apparatus 100 with the remote controller 200 in hand, the captured video of the real world in which the operator S exists is displayed on the liquid crystal display unit 3 of the image display apparatus 1 based on the video display signal from the camera 120. At this time, the predetermined position for position correction among the display positions of the liquid crystal display unit 3 (the screen center position in this example; refer to the white cross symbol) is fixed in advance. With the intention of correcting the position, the operator S adjusts his/her standing position or the height, etc., of the handheld remote controller 200 so as to display the real video of the remote controller 200 in the predetermined position (screen center position). The top half of FIG. 14A shows the state at this time.

On the other hand, the diagram in the lower half of FIG. 14B conceptually shows the state when the position of the remote controller 200 identified by the remote controller position identifying unit 155 based on the captured signal of the camera 110 with an infrared filter and displayed on the liquid crystal display unit 3 (i.e., the infrared light detection position; specifically indicated by X in the figure) deviates from the screen center position (to the right side in this example) due to the position variance described above. Furthermore, this symbol X may be actually generated and displayed on the liquid crystal display unit 3 by the remote controller position symbol creating unit 156 based on an appropriate operation performed on the remote controller 200 by the operator S.

FIG. 14B shows the state when the real video of the remote controller 200 based on the video display signal from the camera 120 (refer to FIG. 14A) and the position display MA of the remote controller 200 identified by the remote controller position identifying unit 155 and generated by the remote controller position symbol creating unit 156 are displayed superimposed on the liquid crystal display unit 3 as is (that is, without correction).

In this state, when the operator S performs an appropriate correction instruction operation using the remote controller 200, the identified corresponding infrared instruction signal is inputted to the user instruction inputting unit 151 via the infrared receiving unit 101, the FM demodulator 102, the BPF 103, and the pulse demodulator 104, as described above. Then, the user instruction inputting unit 151 in response outputs the control signal to the remote controller position correcting unit 160, and the remote controller position correcting unit 160 accesses the video combining unit 130 accordingly (outputs an inquiry signal, for example). The video combining unit 130 in response performs predetermined operation processing, and calculates how much the position display signal (position display MA) from the remote controller position symbol creating unit 156 inputted at that moment deviates from the center position of the liquid crystal display unit 3 (corresponding to the captured video position of the remote controller 200) (the deviation amount).

The calculated deviation amount and the position display signal from the remote controller position symbol creating unit 156 are inputted to the remote controller position correcting unit 160. The remote controller position correcting unit 160 determines the correction constant for correcting the deviation based on the deviation amount. When the position on the screen of the liquid crystal display unit 3 is displayed on a two-dimensional plane comprising an x axis and a y axis, for example, given the deviation amount (dx, dy), the correction constant may be set to (−dx, −dy). Then, after correcting the position display signal inputted from the video combining unit 130 using this correction constant, the remote controller position correcting unit 160 outputs the corrected position display signal to the video combining unit 130. Furthermore, the remote controller position correcting unit 160 may correct the position display signal directly inputted from the remote controller position symbol creating unit 156 using the correction constant (refer to the dashed-two dotted line), or may correct the position information of the remote controller 200 identified by the remote controller position identifying unit 155.

The corrected position display signal inputted to the video combining unit 130 is combined with the video display signal from the video signal generating unit 120b as described above so as to match the corrected position display MA of the remote controller 200 with the screen center position (white arrow symbol) of the liquid crystal display unit 3. FIG. 14C shows the state at this time. The subsequent operations are the same as the foregoing embodiment, and descriptions thereof will be omitted.

While the above is based on the premise that the operator S makes adjustments in advance so that the remote controller 200 aligns with the center position of the liquid crystal display unit 3, the present invention is not limited thereto. The operator S may make adjustments so that the remote controller 200 aligns with another predetermined position of the liquid crystal display unit 3 (for example, a screen corner area or area near a screen corner, an identified position corresponding to the background BG, etc.) and the position display signal, etc., may be corrected accordingly. Further, the present invention is not limited within a technique wherein the operator S aligns the remote controller 200 to a predetermined position. Rather, regardless of the position of the remote controller 200 (at any arbitrary position), the video combining unit 130 may perform predetermined known image recognition processing or analytical processing to identify the position of the remote controller 200 in the real video at that point in time, and the deviation amount of the remote controller 200 may be calculated and corrected based on infrared detection with respect to the identified position of the remote controller 200.

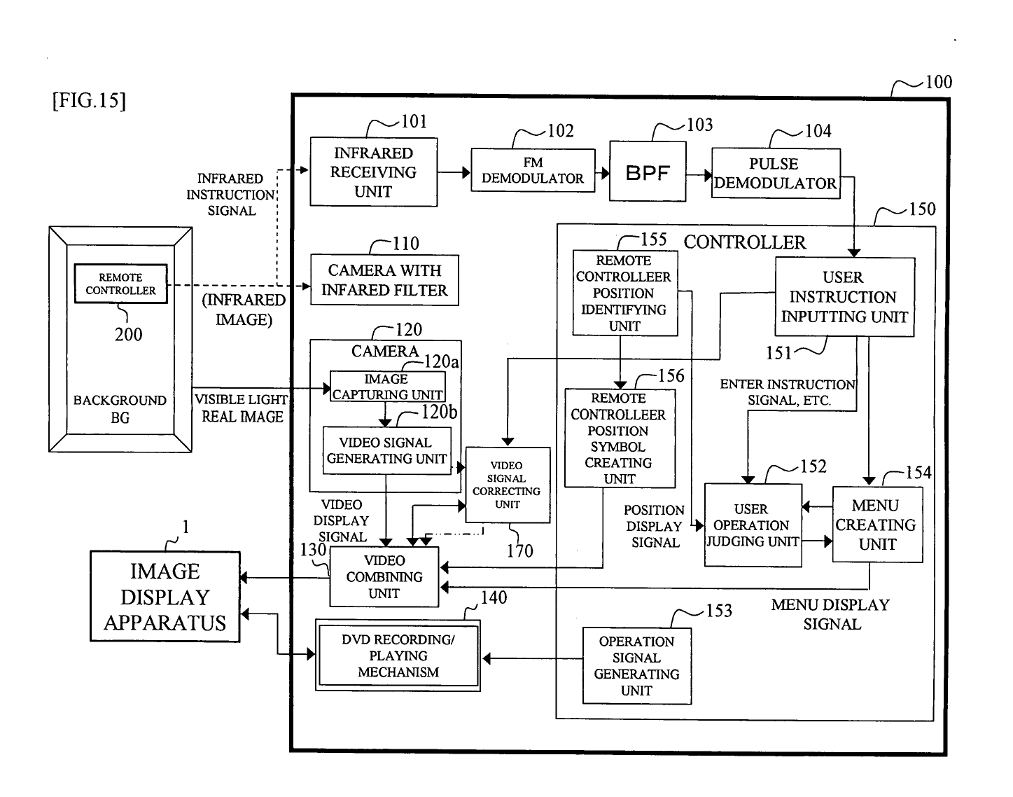

Furthermore, rather than making corrections so that the position of the remote controller 200 matches the video signal side based on infrared detection as described above, conversely corrections may be made so that the video signal matches the position of the remote controller 200 based on infrared detection. FIG. 15 is a functional block diagram shows an example of the functional configuration of the image display control apparatus 100 in this case, and corresponds to the above FIG. 13. Note that the parts identical to those in FIG. 13 are denoted using the same reference numerals, and descriptions thereof will be suitably omitted.

In FIG. 15, in this example, a video signal correcting unit 170 (correcting device) for performing the above-described signal correction is newly provided. This video signal correcting unit 170 performs predetermined correction according to deviation amount in the same manner as the remote controller position correcting unit 160 on the video display signal generated by the video signal generating unit 120b, inputted to the video combining unit 130, and subjected to deviation amount calculation, in accordance with an instruction signal from the user instruction inputting unit 151. Then, the corrected video display signal is inputted to the video combining unit 130 and combined with the position display signal from the remote controller position symbol creating unit 156. Furthermore, the video signal correcting unit 170 may correct the video display signal directly inputted from the video signal generating unit 120b using the correction constant (refer to the dashed-two dotted line).

These two exemplary modifications comprise a correcting device (the remote controller position correcting unit 160 or the video signal correcting unit 170) that corrects the position of the remote controller 200 based on the identification of the remote controller position identifying unit 155, or corrects the video display signal generated by the video signal generating unit 120b, according to the image capturing result by the camera 120 and the image capturing result by the camera 110 with an infrared filter. With this arrangement, if the is any difference in image capturing that may occur between the two cameras 110 and 120, it is possible to prevent without fail differences caused by position variance.

(5) When a Highly Sensitive Infrared Camera is Used

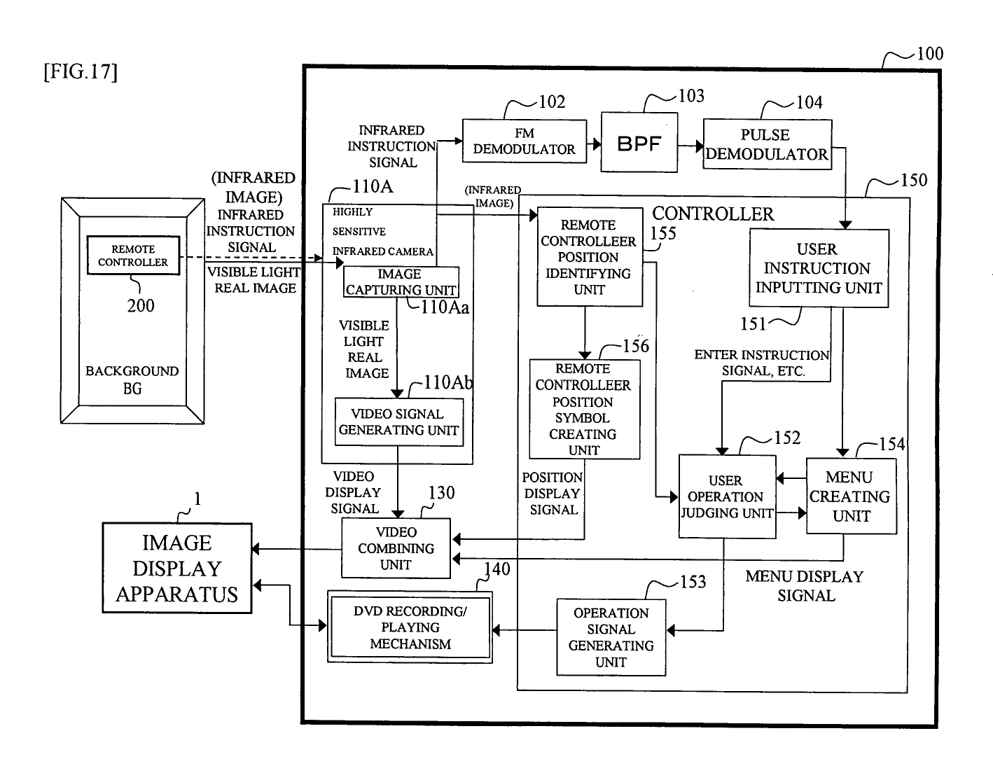

This exemplary modification shows a case where a single highly sensitive infrared camera 110A (refer to FIG. 17 described later) is used in place of the camera 120 as a first light image capturing device and the camera 110 with an infrared filter as a second light image capturing device in the foregoing embodiment. In this case, the highly sensitive infrared camera 110A exhibits higher sensitivity toward the infrared light serving as the second light than toward the visible light serving as the first light.

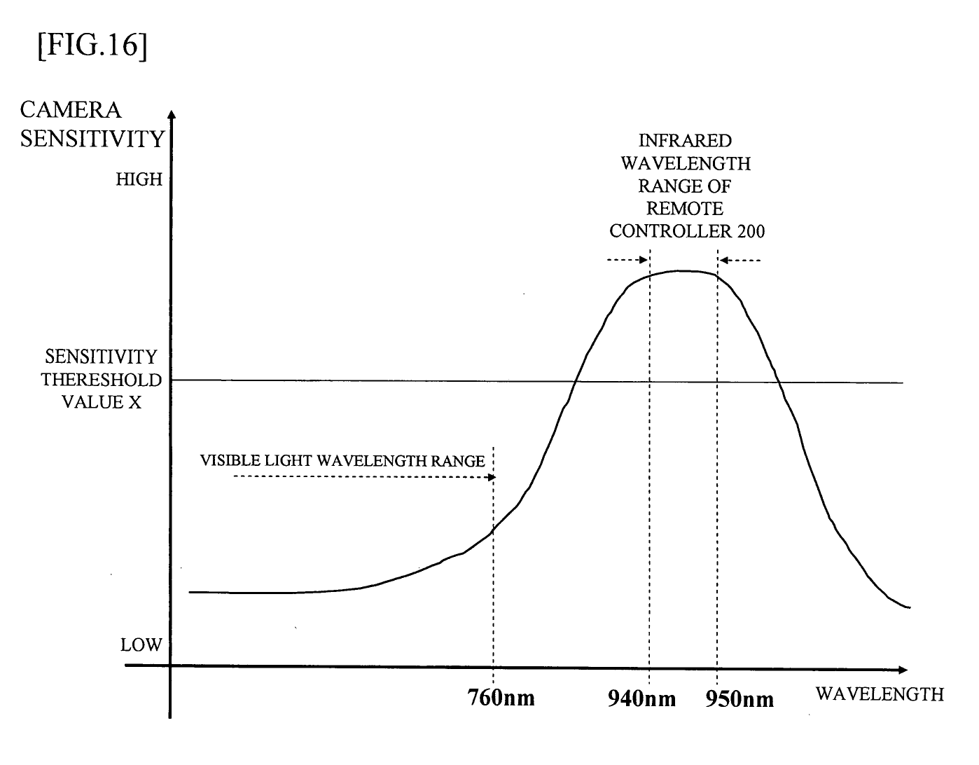

FIG. 16 is a characteristics diagram shows an example of the sensitivity characteristics of this highly sensitive infrared camera 110A. The figure is illustrated with wavelength (nm) on the horizontal axis and camera sensitivity (relative value) on the vertical axis. In FIG. 16, in this example, the sensitivity of the camera 110A is given a peak wavelength range of 940 nm to 950 nm, and decreases rapidly with both shorter wavelengths and longer wavelengths. With such sensitivity characteristics of the camera 110A, a significant distinction can be made between the sensitivity when visible light (wavelength range: 760 nm or less) from the background BG of the remote controller 200 is received, and the sensitivity when infrared light from the remote controller 200 is received by using the infrared light from the remote controller 200 within the above wavelength range of 940 nm to 950 nm. Based on this characteristic, given a sensitivity threshold value X shown in FIG. 16 between the above two high and low sensitivity values, even when the visible light from the background BG of the remote controller 200 and the infrared light from the remote controller 200 are received by the single camera 110A, the processing can be divided so that the image captured at a sensitivity higher than the threshold value X is processed as an infrared image (infrared instruction signal), and the image captured at a sensitivity lower than the threshold value X is processed as a visible light image.

FIG. 17 is a functional block diagram shows the functional configuration of the image display control apparatus 100 of the present exemplary modification, and corresponds to the above-described FIG. 11. Note that the parts identical to those in FIG. 11 are denoted using the same reference numerals, and descriptions thereof will be suitably omitted. In FIG. 17, in the present exemplary modification, the highly sensitive infrared camera 110A comprising the above-described sensitivity characteristics is provided in place of the camera 110 with an infrared filter and the regular camera 120. Both the visible light real image from the background BG of the remote controller 200, and the infrared image from the remote controller 200 are inputted to the image capturing unit 110Aa of the highly sensitive infrared camera 110A. In the image capturing unit 110Aa, the infrared image (infrared instruction signal) on the high sensitivity side and the visible light image on the low sensitivity side are separately captured based on the above principle. The infrared image and infrared instruction signal are then respectively outputted to the remote controller position identifying unit 155 and the FM demodulating unit 102 in the same manner as FIG. 11, and the visible light image is supplied to the image signal generating unit 110Ab. The video signal generating unit 110Ab generates and outputs the corresponding video display signal to the video combining unit 130. The subsequent operations are the same as that of the exemplary modification (2) shown in the above FIG. 11, and descriptions thereof will be omitted.

According to the present exemplary modification, the highly sensitive infrared camera 110A is used as a second light image capturing device functioning as a first light image capturing device as well, wherein the sensitivity toward infrared light is set higher than that toward visible light. With this arrangement, the same advantages as the foregoing embodiment can be achieved with a single camera, without using an infrared filter.

Furthermore, as in the above-described FIG. 3, the infrared instruction signal may be received by the infrared receiving unit 101, and the infrared image alone may be captured by the highly sensitive infrared camera 110A.

(6) When Images are Enlarged and Displayed According to Distance to Operator

While the display magnification of the background BG displayed on the liquid crystal display unit 3 of the image display unit 1 is fixed based on the video display signal from the camera 120, etc., in the foregoing embodiment and the exemplary modifications (1) to (5), the present invention is not limited thereto and the display magnification may be changed according to the distance to the operator S.

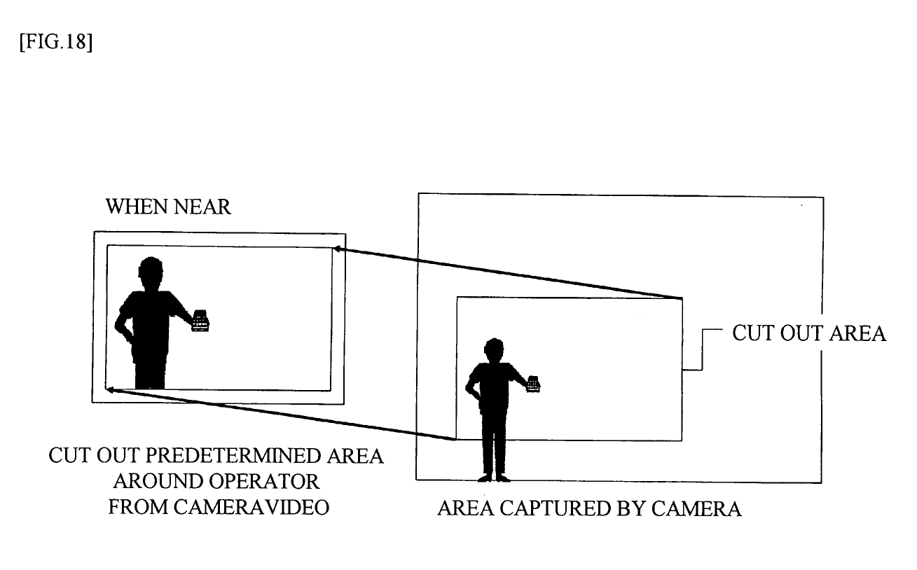

FIG. 18 to FIG. 22 are exemplary diagrams for explaining an overview of a technique for changing the display magnification according to this distance.

FIG. 18 shows an example of a case where the operator S (in other words, the controller 200; hereinafter the same) is first positioned at a distance relatively close to the camera 120. In this case, a predetermined range of the area captured by the camera 120 that is near the operator S is cut out and displayed on the liquid crystal display unit 3 at the same magnification.

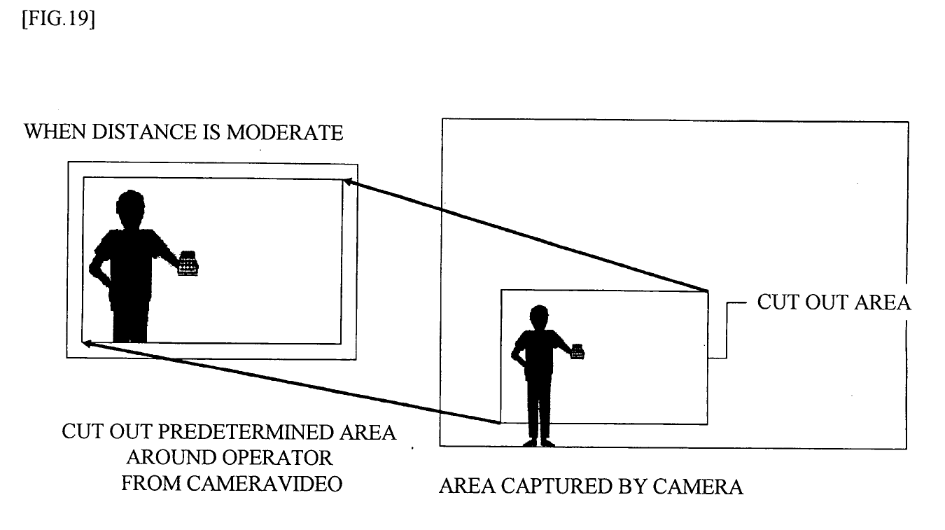

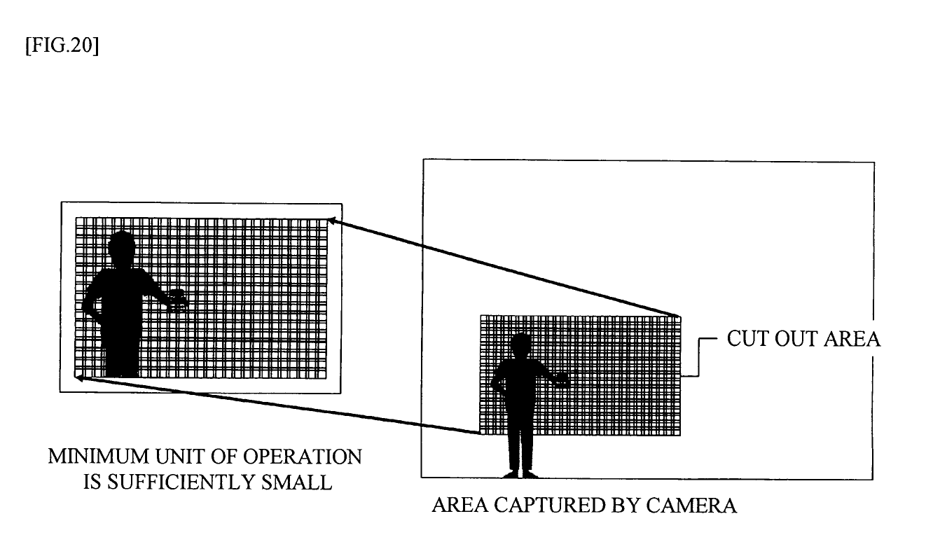

FIG. 19 shows an example in a case where the distance from the camera 120 to the operator S is moderate and, similar to FIG. 18, a predetermined range of the area captured by the camera 120 is displayed as is at the same magnification on the liquid crystal display unit 3. At this time, as described above, the operator S moves the remote controller 200, thereby enabling use of the position display MA of the liquid crystal display unit 3 as a pointer for selecting and specifying the operation area from the operation menu ME. FIG. 20 is a diagram that shows the minimum unit for that movement operation and, since the image is cut out at the same magnification without enlargement as described above, the minimum unit in this case is sufficiently small. As a result, the operator S can smoothly select and specify the operation area by moving the remote controller 200 using his/her hand or arm to sensitively and smoothly move the position display MA on the liquid crystal display unit 3.

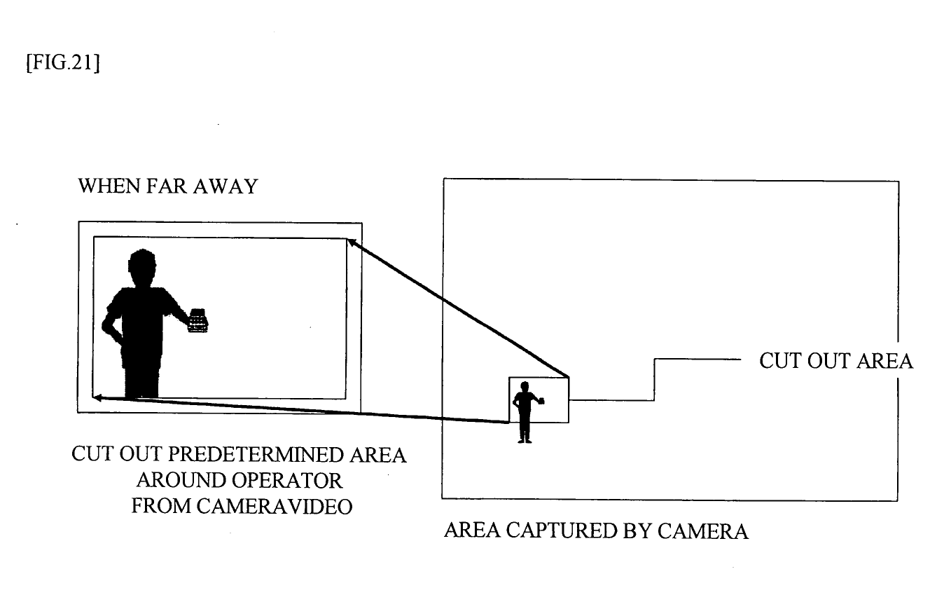

FIG. 21 shows an example of a case where the operator S is positioned relatively far away from the camera 120. In this case, the predetermined range of the area captured by the camera 120 that is near the operator S appears extremely small on the liquid crystal display unit 3 since it is displayed as is at the same magnification, making it difficult to display the position display MA and operation menu E on the liquid crystal display unit 3. To avoid this, the cut out range is enlarged so that it appears bigger on the liquid crystal display unit 3.

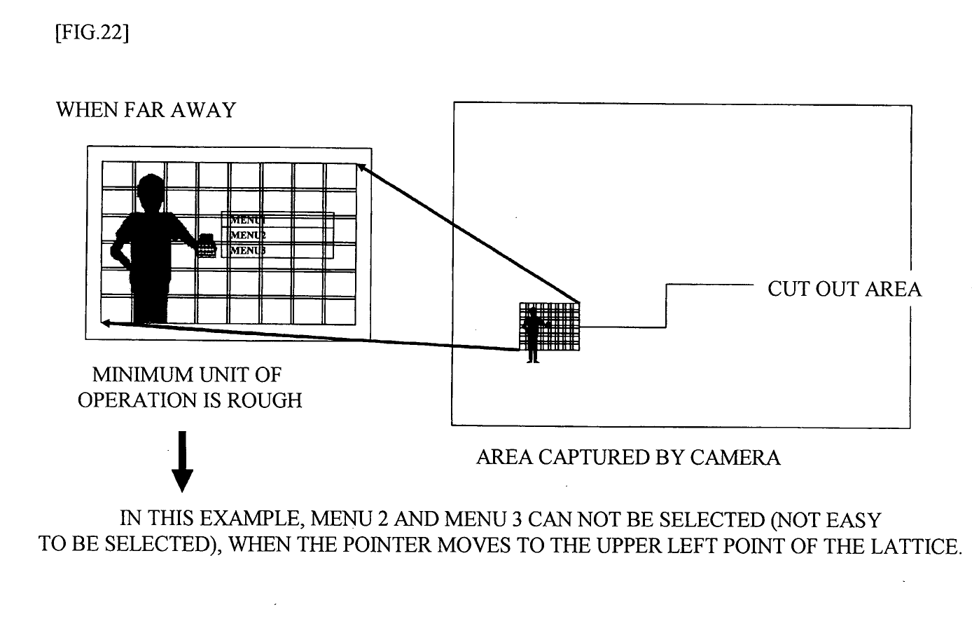

Nevertheless, in relation to the enlarged display after cutout, the minimum unit of the movement operation, as shown in FIG. 22, is large and relatively course in this case. As a result, when the remote controller 200 is moved by the movement of the hand or arm of the operator S, it becomes difficult or impossible to sensitively and smoothly move the position display MA on the liquid crystal display unit 3 (the position display MA stops at one point then suddenly jumps to a distant point, or the movement appears jerky). Here, in this case, a separate virtual movement position is newly estimated between two neighboring points of the operation minimum unit and, using the estimated movement position, the position display MA is displayed in a supplemented form (when the actual controller 200 is moved from one position to the next, the position display MA moves slower than and follows the actual movement of the controller 200 so that an estimated position is continually interposed between two positions, such as from “one position”→“the movement position estimated between these two positions”→“the next position”; the intermediate area does not necessarily need to be the middle point), thereby preventing a decrease in operability.

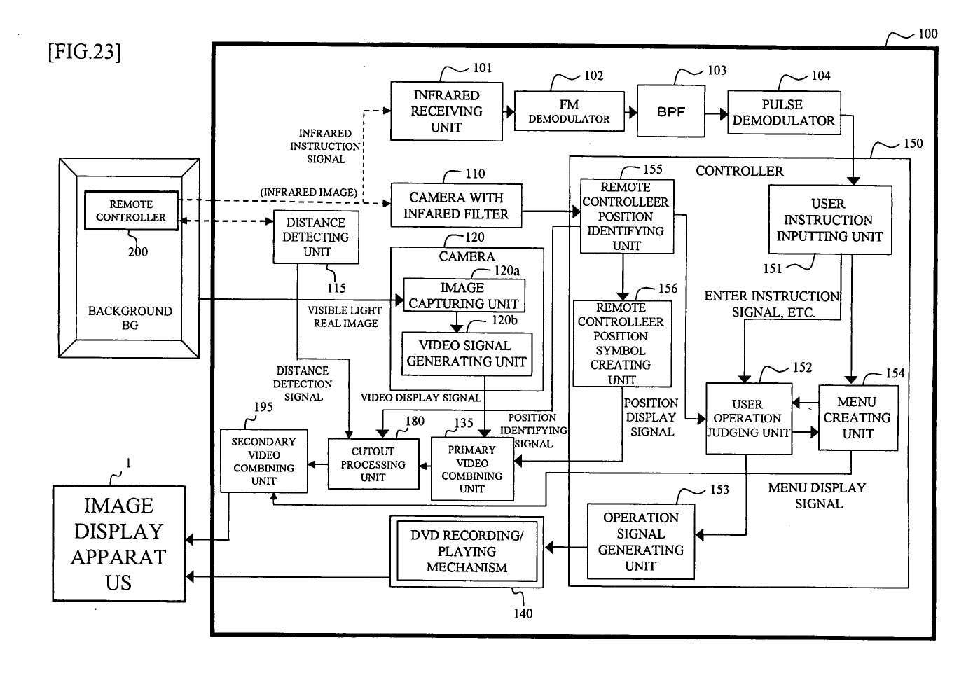

FIG. 23 is a functional block diagram shows the functional configuration of the image display control apparatus 100 of the present exemplary modification for realizing the above-described technique, and corresponds to FIG. 3, etc., of the foregoing embodiment. In FIG. 23, the image display control apparatus 100 of the exemplary modification provides a primary video combining unit 135 in place of the video combining unit 130 of the configuration shown in FIG. 3, and a new distance detecting unit 115, cutout processing unit 180, and secondary video combining unit 195.

The distance detecting unit 115 measures the distance from the remote controller 200 using a known technique, employing an ultrasonic detector, for example. The detected distance is inputted to the cutout processing unit 180 as a distance detection signal.

The primary video combining unit 135, similar to the video combining unit 130 of FIG. 3, receives a video signal from the video signal generating unit 120b based on the image captured by the image capturing unit 120a of the camera 120, and a position display signal from the remote controller symbol creating unit 156 based on the identification made by the remote controller position identifying unit 155. With this arrangement, a video signal in a state where a predetermined position display MA is superimposed on (or near) the position of the remote controller 200 captured on the liquid crystal display unit 3 is achieved.

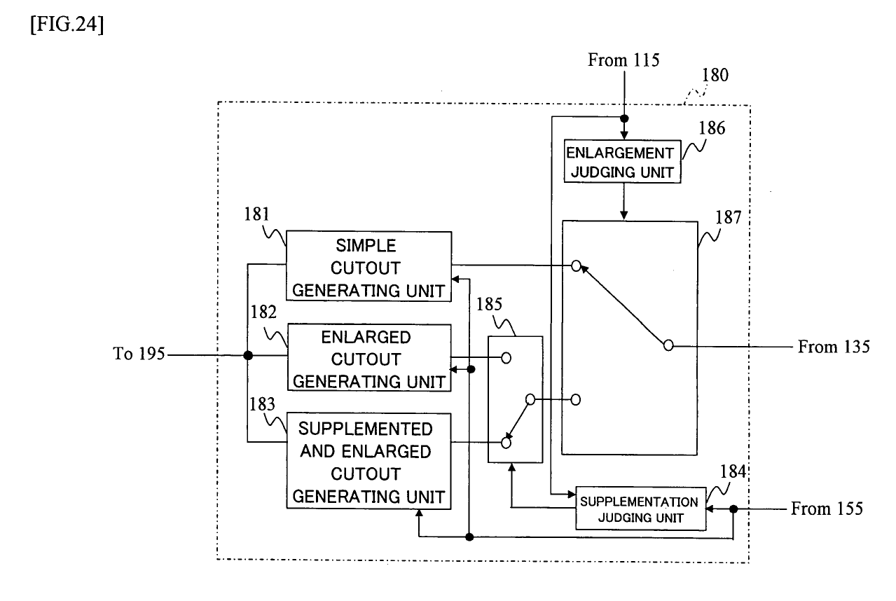

The cutout processing unit 180 receives the captured video signal with a position display MA from the primary video combining unit 135, the distance detection signal from the distance detecting unit 155, and the position identification signal from the remote controller position identifying unit 155. Then, a predetermined area near the position of the controller 200 identified by the position identification signal is cut out from the captured video with a position display MA, the magnification used when the cut out video is displayed on the liquid crystal display unit 3 is set according to the extent of the distance of the distance detection signal, and the captured video signal with a position display MA that is enlarged to that magnification is outputted to the secondary video combining unit 195 (for details, refer to FIG. 24 described later)

The secondary video combining unit 195 combines the (adequately enlarged) captured video signal with the position display MA from the cutout processing unit 180 with the menu display signal from the menu creating unit 154. Then, the combined signal is outputted to the image display apparatus 1, thereby displaying on the liquid crystal display unit 3 the combined video of the captured video with a position display MA based on the captured image of the camera 120 and the menu display from the menu creating unit 154.

FIG. 24 is a functional block diagram shows in detail the signal with a position display MA from the primary video combining unit 135, the distance detection signal from the distance detecting unit 155, and the position identification signal from the remote controller position identifying unit 155. Then, a predetermined area near the position of the controller 200 identified by the position identification signal is cut out from the captured video with a position display MA, the magnification used when the cut out video is displayed on the liquid crystal display unit 3 is set according to the extent of the distance of the distance detection signal, and the captured video signal with a position display MA that is enlarged to that magnification is outputted to the secondary video combining unit 195 (for details, refer to FIG. 24 described later).

The secondary video combining unit 195 combines the (adequately enlarged) captured video signal with the position display MA from the cutout processing unit 180 with the menu display signal from the menu creating unit 154. Then, the combined signal is outputted to the image display apparatus 1, thereby displaying on the liquid crystal display unit 3 the combined video of the captured video with a position display MA based on the captured image of the camera 120 and the menu display from the menu creating unit 154.

FIG. 24 is a functional block diagram shows in detail the configuration of the cutout processing unit 180.

In FIG. 24, the cutout processing unit 180 comprises a simple cutout generating unit 181 for generating a simple cutout without enlargement; an enlarged cutout generating unit 182 for generating a cutout with enlargement; a supplemented and enlarged cutout generating unit 183 for generating an enlarged cutout and performing supplementation involving the above-described estimated movement position; a supplementation judging unit 194 that judges whether or not the above-described supplementation is to be performed according to the mode (operation resolution, movement resolution, velocity, etc.; described in detail later) of the movement of the remote controller 200 based on the distance detection signal from the distance detecting unit 115 and the signal from the remote controller position identifying unit 155; a switch 185 configured to selectively output the input from the switch 187 (described later) to either the enlarged cutout generating unit 182 or the supplemented and enlarged cutout generating unit 183, switched by a switching control signal from the supplementation judging unit 184; an enlargement judging unit 186 that judges whether or not the enlarged display is to be enlarged according to the distance detection signal from the distance detecting unit 115; and a switch 187 configured to selectively output the output from the primary video combining unit 135 to either the simple cutout generating unit 181 or the switch 185, switched by the switching control signal from the enlargement judging unit 186.

The simple cutout generating unit 181, the enlarged cutout generating unit 182, and the supplemented and enlarged cutout generating unit 183 each respectively receive the position identification signal from the remote controller position identifying unit 155 and, based on the identified position of the controller 200, cut out the predetermined range (fixed in advance, for example) near the position of the controller 200.

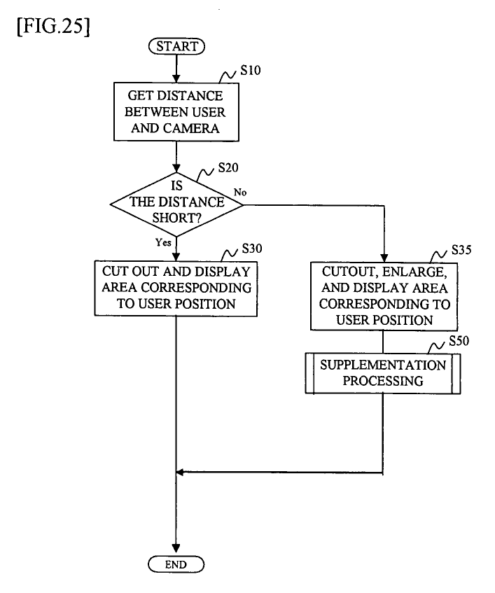

FIG. 25 is a flowchart shows a control procedure executed by the cutout processing unit 180 as a whole.

In FIG. 25, first, in step S10, the enlargement judging unit 186 obtains the distance between the operator S (controller 200) and the camera 120 detected by the distance detecting unit 115.

Then, in step S20, the enlargement judging unit 186 judges whether or not the distance obtained in step S10 is relatively short (less than a predetermined threshold value, for example). When the distance is short, the conditions of step S20 are satisfied and the process transits to step S30. In step S30, the enlargement judging unit 186 outputs a switching control signal to the switch 187 to switch to the simple cutout generating unit 181. As a result, the video signal with a position display MA from the primary video combining unit 135 is supplied to the simple cutout generating unit 181, regular cutout without enlargement is performed. The flow is terminated.

When the distance is long, the conditions of step S20 are not satisfied and the process transits to step S35. In step S35, the enlargement judging unit 186 outputs a switching control signal to the switch 187 to switch to the switch 185 side. As a result, the video signal with a position display MA from the primary video combining unit 135 is supplied to the enlarged cutout generating unit 182 or supplemented and enlarged cutout generating unit 183, and cutout processing with enlargement is performed. Subsequently, the process transits to stop S50, supplementation processing is performed, and the flow is terminated.

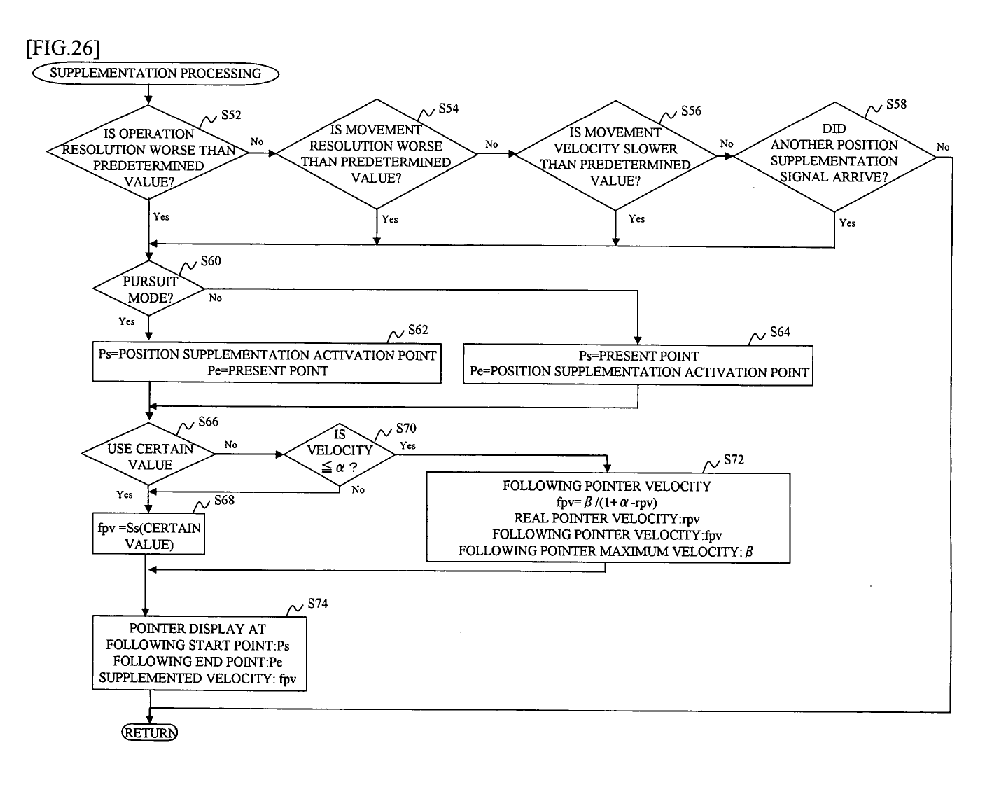

FIG. 26 is a flow chart shows in detail a procedure included in the above mentioned step S50.

At first, in step S52, the supplementation judging unit 184 judges whether or not the operation resolution, which tends to decrease as distance increases, is worse than a threshold value, according to a distance detection signal from the distance detecting unit 115 (in a case where magnification by the enlarged cutout generating unit 182 or supplemented and enlarged cutout generating unit 183 is estimated according to that distance). When the operation resolution is worse than the threshold value, conditions are satisfied, the supplementation judging unit 184 judges that operation will be jerky and operability will deteriorate if conditions are left as is (supplementation is necessary), and the process transits to step S60 described later. When the operation resolution is greater than or equal to the threshold value, conditions are not satisfied and the process transits to step S54.

In step S54, the supplementation judging unit 184 judges whether or not the read resolution (movement resolution) read as the position identification signal has, for some reason, become worse than the predetermined threshold value, based on the position identification signal (and its behavior within a predetermined time range) from the remote controller position identifying unit 155. When the movement resolution is worse than the threshold value, conditions are satisfied, the supplementation judging unit 184 judges that, due to the existence of obstacles (described later), for example, reading will become fragmented and smooth operation will become difficult to achieve as is (supplementation is required), and the process transits to step S60. When the movement resolution is greater than or equal to the threshold value, conditions are not satisfied and the process transits to step S56.

In step S56, the supplementation judging unit 184 judges whether or not the actual movement velocity of the controller 200 is less (slower) than a predetermined threshold value, based on the position identification signal (and its behavior within a predetermined time range) from the remote controller position identifying unit 155. When the movement velocity is less than the threshold value, conditions are satisfied, the supplementation judging unit 184 judges that the operator S is nicely and easily following the high-precision operation, for example, and the process transits to step S60 described later. When the movement velocity is greater than or equal to the threshold value, conditions are not satisfied and the process transits to step S58.

In step S58, the supplementation judging unit 184 judges whether or not a supplementation instruction signal from the operator S has been inputted. That is, in the present exemplary modification, regardless of whether or not the conditions of step S52, step S54, and step S56 have been satisfied, an operating device by which the operator S can intentionally (forcibly) instruct supplementation by the supplemented and enlarged cutout generating unit 183 is provided, and a supplementation instruction signal based on this operating device is inputted to the supplementation judging unit 184. This step S58 judges whether or not the supplementation instruction signal has been inputted. When there is a supplementation execution instruction from the operator S, conditions are satisfied and the process transits to step S60 described later. When there is not a supplementation execution instruction, conditions are not satisfied and the flow is terminated.

In step 60 to which the process transits when the conditions of step S52, step S54, step S56, or step S58 have been satisfied, the supplementation judging unit 184 judges whether or not supplementation is to be executed in “pursuit mode.”

That is, the supplementation processing executed in the present exemplary modification comprises two modes: pursuit mode wherein supplementation is performed so that the controller 200 is followed from its presumed position slightly before its current position to its current position (i.e., so that the position display MA is slightly behind and smoothly pursues the real movement of the controller 200), and return mode wherein supplementation is performed so that the controller 200 is tracked back from its current position to its presumed position slightly before the current position (i.e., so that the position display MA appears to smoothly go back a bit in the direction opposite the real movement of the controller 200), based on the position identification signal (and its behavior within a predetermined time range) from the remote controller position identifying unit 155. Then, a selecting device that enables the operator S to instruct the system to use one of the two modes during supplementation processing is provided, and the mode selection signal from the selecting device is inputted to the supplementation judging unit 184. This step S60 judges whether or not pursuit mode has been selected by the mode selection signal.

When the operator S selects pursuit mode, the conditions of step S60 are satisfied and the process transits to step S62. In step S62, the supplemented and enlarged cutout generating unit 183 establishes the following operation start point Ps for when the position display MA follows behind the real movement of the controller 200 as described above as the supplementation start (activation) point on the movement locus of the controller 200 (the position between the current position of the controller 200 and a position slightly before that position, for example; not necessarily the center point), and establishes the following end point Pe for when the following operation is displayed as the current position.

On the other hand, when the operator S selects return mode, the conditions of step S60 are not satisfied and the process transits to step S64. In step S64, the supplemented and enlarged cutout generating unit 183 establishes the following operation start point Ps as the current position of the controller 200, and establishes the following end point Pe for when the following operation is displayed as the supplementation start (activation) point.

When step S62 or step S64 ends, the process transits to step S66.

In step S66, the supplementation judging unit 184 judges whether or not the following (movement) velocity of the position display MA is a certain value when the position display MA follows behind the actual controller 200 while supplemented.

That is, the following velocity of the position display MA during supplementation processing executed in the present exemplary modification has two modes: constant velocity mode wherein following is performed at a predetermined constant velocity (regardless of the actual movement velocity of the controller 200), and variable velocity mode wherein the following velocity changes according to the actual movement velocity of the controller 200. Then, a selecting device that enables the operator S to instruct the system to use either of the two modes is provided, and the mode selection signal from the selecting device is inputted to the supplementation judging unit 184. This step S66 judges whether or not the constant velocity mode has been selected by the mode selection signal.

When the operator S selects constant velocity mode, the conditions of step S66 are satisfied and the process transits to step S68. In step S68, the supplemented and enlarged cutout generating unit 183 establishes the following velocity fpv of the position display MA (pointer) when the position display MA appears behind the actual movement of the controller 200 as described above as a predetermined certain value Ss.

On the other hand, when the operator S selects variable mode, the conditions of step S66 are not satisfied and the process transits to step S70. In step S70, the supplementation judging unit 184 judges whether or not the actual movement velocity of the controller 200 is less than or equal to a predetermined threshold value a (preset), based on the position identification signal (and its behavior within a predetermined time range) from the remote controller position identifying unit 155. When the movement velocity of the controller 200 is not so slow, the conditions of step S70 are not satisfied and the process transits to the above-described step S68. When the movement velocity of the controller 200 is sufficiently slow, the conditions of step S70 are satisfied and the process transitions to step S72.

In step S72, the supplemented and enlarged cutout generating unit 183 calculates the following velocity fpv of the position display MA (pointer) when the position display MA appears behind the actual movement of the controller 200 as described above using the following equation:

fpv=β/(1+α−rpv) (Equation 1)

Here, rpv means the real movement velocity (real pointer velocity) of the controller 200 (real position display MA). β means the maximum following pointer velocity set as the fixed upper limit in advance, a means the threshold value of the above mentioned movement velocity in step S70.

The above Equation 1 has the following significance: Because the conditions are satisfied, so the real movement velocity of the controller 200 is less equal than α at the moment, α−rpv of Equation 1 is the value 0 or higher and increases as the real movement velocity of the controller 200 decreases (i.e., increases to the extent the operation is slow). As a result, with the addition of one, the value 1+α−rpv is the value 1 or higher and increases to a value greater than 1 to the extent that the operation is slow. By dividing the maximum following pointer velocity β by such a value, a following pointer velocity fpv that does not exceed the upper limit and decreases to the movement the operation is slow is achieved.

When step S68 or step S72 ends, the process transits to step S74. In step S74, the supplemented and enlarged cutout generating unit 183 performs predetermined delay processing on the position display (pointer) MA created by the remote controller position symbol creating unit 156 and inputted via the primary video combining unit 135, recombines the signals so that the position display MA is displayed (behind the real movement of the controller 200) according to the following pointer velocity fpv determined in step S68 or step S72, from the following operation start point Ps to the following end point Pe determined in step S62 or step S64, and outputs the result to the secondary video combining unit 195. Furthermore, similar to the supplementation signal generating unit 165 of exemplary modification (8) described later, the supplemented and enlarged cutout generating unit 183 outputs a signal to the remote controller position symbol creating unit 156 based on the position identification signal from the remote controller position identifying unit 155 to correct (calibrate) the position display signal itself created by the remote controller position symbol creating unit 156 and obtain the same effect even if the same display is performed. After step S74 ends, the routine is terminated.

The image display apparatus 1 of the present exemplary modification comprises an extraction processing device (the cutout processing units 180 and 180A in this example) for extracting a part of the background of the controller 200 in the video display signal generated by the video display signal generating device 120b and enabling enlarged display on the display screen.

With this arrangement, in a case where the operator S is relatively far away and the video of the operator S occupies a small percentage of the image of the entire background of the controller 200 captured by the first light image capturing device 120a, the size of the operation area on the display screen 3 can be increased by extracting and enlarging the video in the vicinity of the operator S when the area in which the controller 200 can be moved (the operation area) occupies a small percentage of the image of the entire background BG. As a result, the level of operation difficulty is decreased, thereby improving operability.

Further, the image display control apparatus 1 of the present exemplary modification comprises a distance detecting device (the distance detecting unit 115 in this example) that detects the distance to the controller 200, and the extraction processing device 180 determines the condition of the extraction and enlargement (including whether the enlargement is needed or not) according to the detection result by the distance detecting device 115.

With this arrangement, in a case where the distance to the controller 200 detected by the distance detecting device 115 is relatively long, the extraction processing device 180 extracts and enlarges the video in the vicinity of the operator S, thereby increasing the size of the operation area on the display screen 3. As a result, operation in a larger range than necessary is no longer required, and the operation position is no longer restricted.

Further, in the image display control apparatus 1 of the present exemplary modification, the estimated position determining device (the supplemented and enlarged cutout generating unit 183 in this example) determines an estimated movement position located in the intermediate area between two neighboring points successively identified by the position identifying device 155 when the controller 200 is moved.

With this arrangement, in a case where the movement locus of the controller 200 on the display screen 3 is rough and jerky, an estimated movement position is set between two neighboring points to virtually fill in the movement locus on the display screen 3 and express the rough movement locus in detail, thereby improving the smoothness of the operation.

Furthermore, while the simple cutout generating unit 181, the enlarged cutout generating unit 182, and the supplemented and enlarged cutout generating unit 183, based on the position of the controller 200 identified using the position identification signal from the remote controller position identifying unit 155, cut out a fixed predetermined area near the controller 200 (regarded as the operable range of the operator S) when cutout processing is performed by the cutout processing unit 180 in the above exemplary modification (6), the present invention is not limited thereto and the operator S may set the operation range (operable range) by himself or herself so that the range is recognized on the apparatus side.

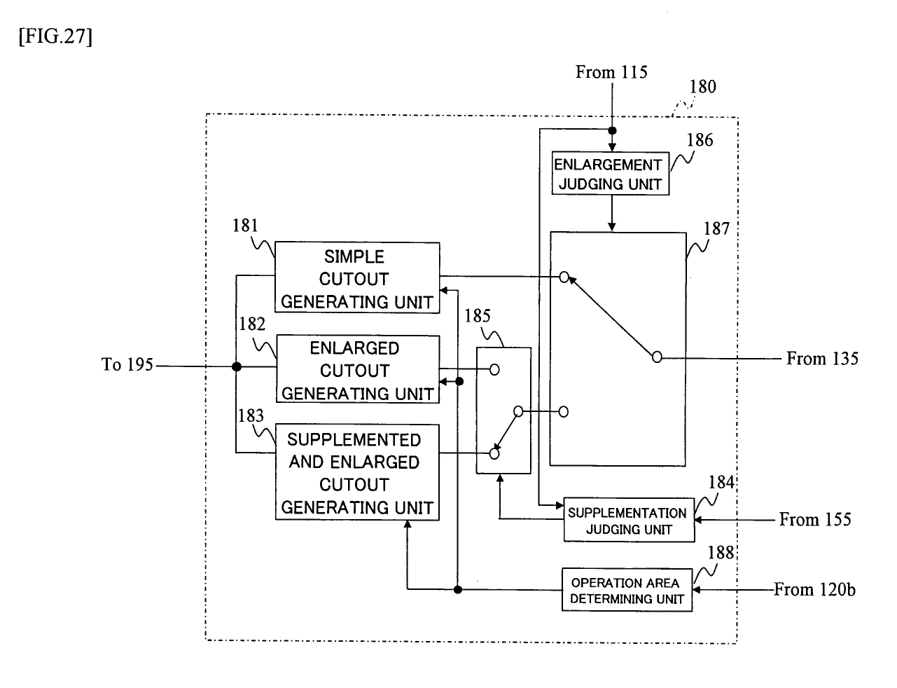

FIG. 27 is a functional block diagram shows the functional configuration of the cutout processing unit 180A of such an exemplary modification, and corresponds to the above FIG. 24. As shown in FIG. 27, the cutout processing unit 180A according to this exemplary modification is newly provided with an operation area determining unit 188. The operation area determining unit 188 sets the operation area of the operator S in response to the movement area of the controller 200 within a predetermined time range, based on the position identification signal from the remote controller position identifying unit 155.

That is, the operation area determining unit 188 applies a known moving object recognition technique, for example, to the video signal from the video signal generating unit 120b of the camera 120 (or the position identification signal from the remote controller position identifying unit 155), and detects the moving object area (the area in which movement within the moving object image is pronounced) within the predetermined time range (immediately after or immediately before a base point in time, for example). Then, with the assumption that the detected moving object area is the area near the arm of the operator S, the operable area of the operator S can be estimated. This area is then outputted as the operation area to the simple cutout generating unit 181, enlarged cutout generated unit 182, and supplemented and enlarged cutout generating unit 183, thereby enabling these cutout generating units 181 to 183 to execute cutout processing on the area.

In the image display apparatus 1 of this exemplary modification, the extraction processing device 180A determines the condition of extraction and enlargement (including whether the enlargement is needed or not) according to the movement (range) information of the controller 200 recognized based on the video display signal generated by the video display signal generating device 120b or the position identification result from the position identifying device 155.

With this arrangement, in a case where the movement range of the controller 200 is small and the operation area occupies a small percentage of the image of the entire background BG, the extraction processing device 180A extracts and enlarges the video in the vicinity of the operator S, thereby increasing the size of the operation area on the display screen 3. As a result, operation in a larger range than necessary is no longer required, and the operation position is no longer restricted.

Furthermore, various methods other than use of the above ultrasonic detector may be considered for distance detection by the distance detecting unit 115.

That is, for example, if a known facial recognition technique is applied, the face of the operator S may be captured by the image capturing unit 120a of the camera 120 and recognized by a video signal generated by the video signal generating unit 120b, and the size of the face may be compared to the average value of the standard face size of a person to find the distance to the operator S. Furthermore, in this case, the area of a predetermined range surrounding the facial recognition area may be established as the operation area and cut out by the cutout generating units 181 to 183. Or, the facial recognition area and a predetermined range that includes the controller 200 identified by the above mentioned remote controller position identifying unit 155 may be established as the operation area and cut out by the cutout generating units 181 to 183. Additionally, the distance may also be measured using a known image recognition technique on an area other than the face.

Further, as described in the above exemplary modification (3), when the camera 110 with an infrared filter and the regular camera 120 are provided separately in the configuration shown in FIG. 3, for example, the respective images do not exactly match and a disparity occurs due to the variance in the lens positions of the two cameras 110 and 120. The distance may then be measured by utilizing such a camera disparity, i.e., by providing, for example, a left camera and a right camera for distance detection (where at least one of these may be used as the camera 110 or 120 as well) and using the disparities to measure the distance.

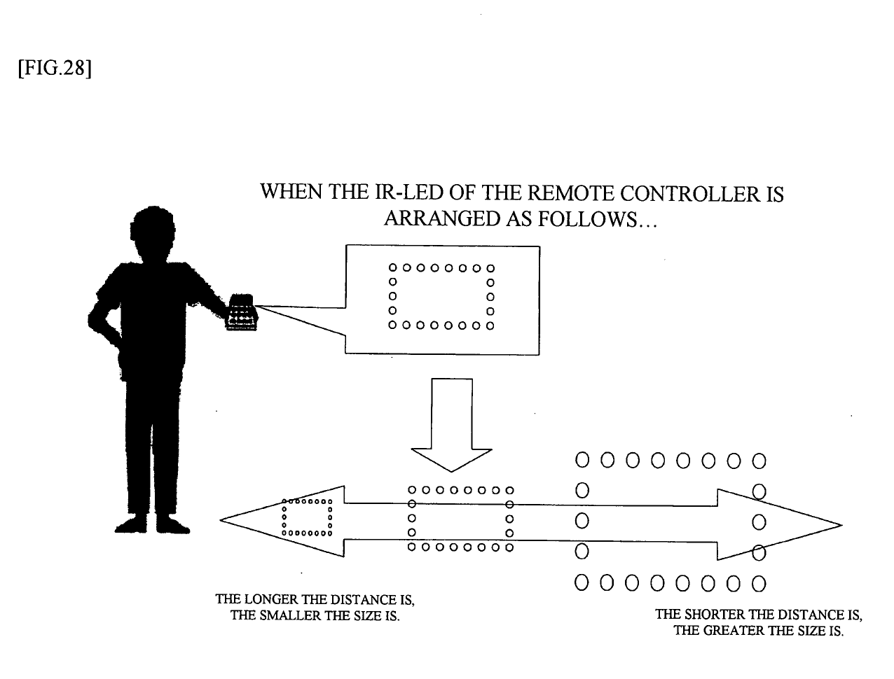

There is also a technique that calculates the size of a graphic of an inputted image. FIG. 28 is an explanatory diagram of this technique. In FIG. 28, given that an IR-LED is set in a roughly square shape as shown in the figure at the end of the controller 200, for example, the size of the IR-LED square in the video signal captured by the camera 120 decreases to the extent the distance to the controller 200 increases. The distance to the controller 200 can then be calculated in reverse by using this correlation and obtaining the size of the square in the video signal.

(7) When Measures are Taken to Avoid Obstacles

That is, in a case where there are obstacles that obstruct the operation range of the controller 200 between the operator S and the camera 120, a technique for avoiding the adverse effects of the obstacles may be used.

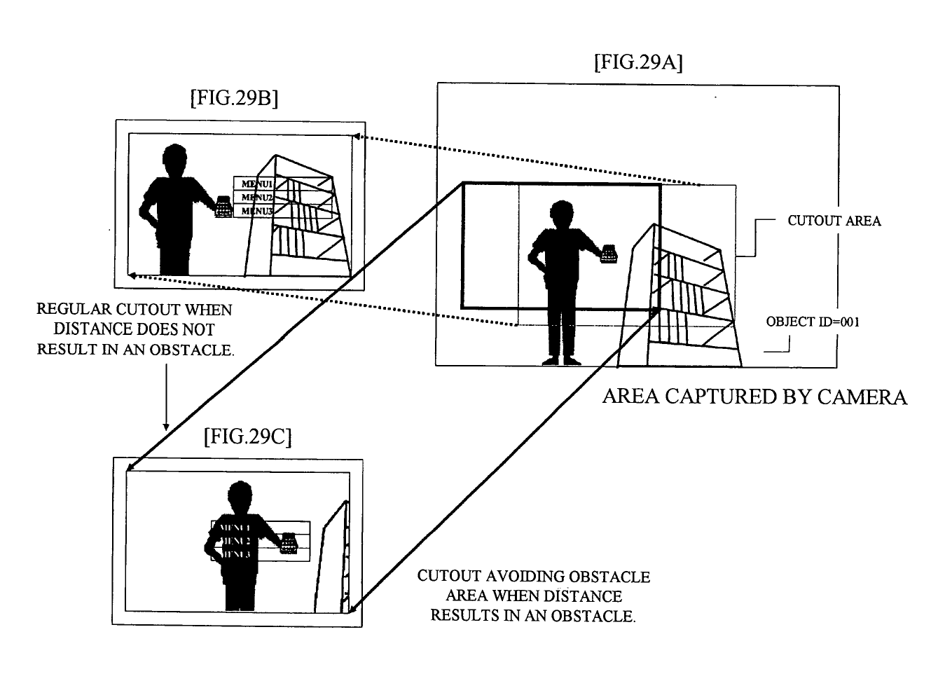

FIG. 29A, FIG. 29B, and FIG. 29C are explanatory diagrams for explaining an overview of an exemplary modification of an obstacle avoidance technique whereby the cutout area is changed.

FIG. 29A is a diagram corresponding to the above FIG. 18, etc., and shows the positional relationship between the area captured by the camera 120 and the area cut out. In a case where the operator S is positioned relatively close (in front of the obstacle as viewed from the camera 120), as shown in FIG. 29B, a predetermined area of the area captured by the camera 120 that is in the vicinity of the operator S is cut out and displayed on the liquid crystal display unit 3 at the same magnification. In this state, the operation menu ME appears on top of the obstacle (a bookcase, in this example) as shown in the figure, but because the operator S is positioned in front of the obstacle, the operator S can position the position display MA on the operation menu ME covering the bookcase by waving his or her arm holding the controller 200 and then perform an operation as usual.

On the other hand, when the operator S is standing toward the back at a lower position and the obstacle appears in front of the operator S from the viewpoint of the camera 120, the operator S is positioned farther back than the obstacle from the viewpoint of the camera 120, not allowing the operator S to position the position display MA on the operation menu ME or perform an operation even when the operation menu ME is displayed as is on the obstacle (bookcase) as described above and the operator S waves his/her arm.

Here, in the present exemplary modification, if such a state occurs, the cutout position is shifted to avoid the obstacle (so the obstacle is not included to the extend possible), as shown in FIG. 29C and FIG. 29A. With this arrangement, as shown in FIG. 1529C, the operation menu ME can be displayed in a state that is virtually not affected by the obstacle, and the operator S can position the position display MA on the operation menu ME by waving his/her arm holding the controller 200.

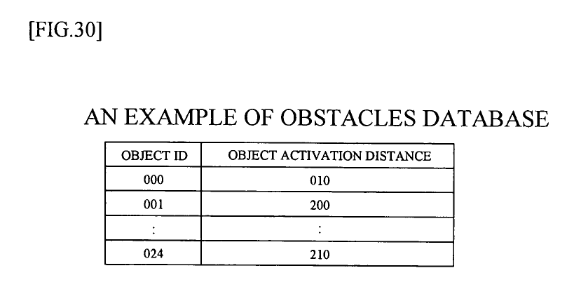

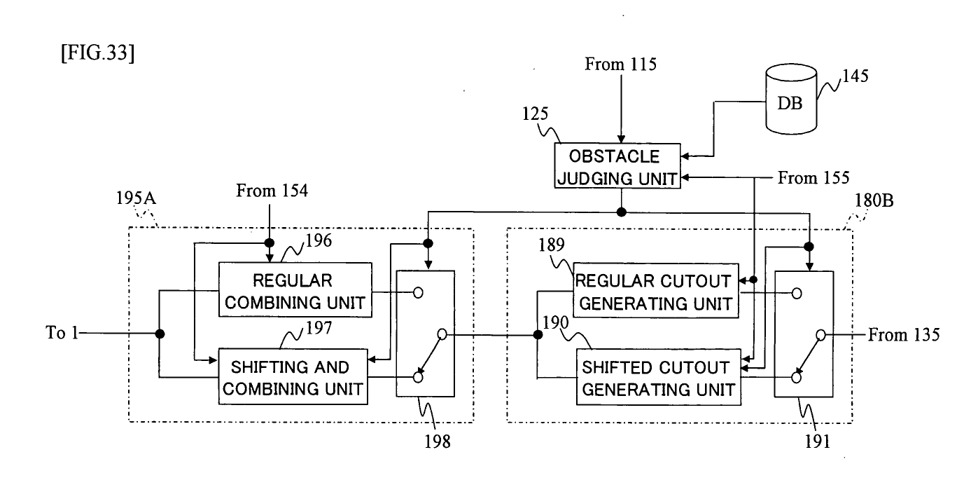

Furthermore, various techniques for distinguishing the state shown in FIG. 29B (the non-activated state of the obstacle when the operator S appears in front of the obstacle as viewed from the camera 120) and the state shown in FIG. 290 (the activated state of the obstacle when the obstacle appears in front of the operator S as viewed from the camera 120) may be considered. For example, as shown in FIG. 30, in one technique potential obstacles are registered in advance in a database in a form that relates the obstacles to the distance from the camera 120 (refer to database 145 of FIG. 33 described later). In FIG. 30, the right column is the distance (activation distance) from the camera 120 to each obstacle. When the distance from the distance detecting unit 115 to the operator S is longer than this activation distance, the object is regarded as an obstacle. At this time, a known object recognition technique [refer to Digital Image Processing (CG-ARTS Society), p. 192-200, for example] may also be used in combination.

Further, an obstacle in an activated state may be considered detected when the controller 200 is continually moved in a certain direction but the movement locus cannot be detected based on the position identification signal of the remote controller position identifying unit 155 from a certain point in time (also refer to exemplary modification (8) described later). This technique is further reliable if confirmation can be made that the movement locus of the controller 200 is detectable when moved slightly back in the opposite direction (i.e., returned to the non-activated state).

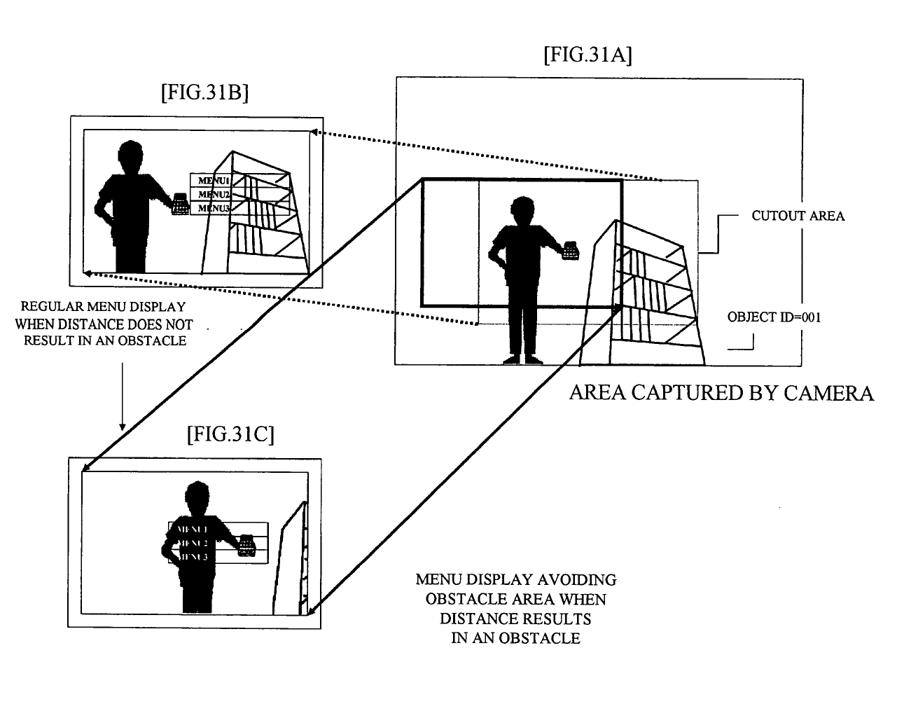

FIG. 31A, FIG. 31B, and FIG. 31C are explanatory diagrams for explaining an overview of an exemplary modification of another obstacle avoidance technique whereby the menu display area is shifted.

FIG. 31A is a diagram corresponding to the above FIG. 29A and FIG. 18, etc. FIG. 31A shows the positional relationship between the area captured by the camera 120 and the area cut out. In a state where the operator S appears in front of the obstacle as viewed from the camera 120, as shown in FIG. 31B, the operation menu ME appears on top of the obstacle (bookcase), for example, as usual. In this state, because the operator S is positioned in front of the obstacle, the operator S can position the position display MA on the operation menu ME that appears on top of the bookcase by waving his/her arm holding the controller 200, and perform an operation as usual.

On the other hand, when the operator S is standing toward the back in lower position and the obstacle appears in front of the operator S from the viewpoint of the camera 120, as described above, the operator S is positioned farther back than the obstacle from the viewpoint of the camera 120, not allowing the operator S to position the position display MA on the operation menu ME even when the operator S waves his/her arm.

In the present exemplary modification, when conditions develop as described above, the display position of the operation menu is shifted to a position where the obstacle is avoided (not included to the extend possible; to the left in the example shown in the figure), as shown in FIG. 31C (when a cutout is generated in the same manner as this example, the cutout position is never changed). With this arrangement, as shown in FIG. 31C, the operation menu ME not covered by the obstacle as viewed from the camera 120 (in a state substantially not affected by the obstacle) can be displayed, and the operator S can position the position display MA on the operation menu ME by waving his/her arm holding the controller 200.

Furthermore, for distinguishing between the non-activated state and activated state of the obstacle, the same technique as described above will suffice.

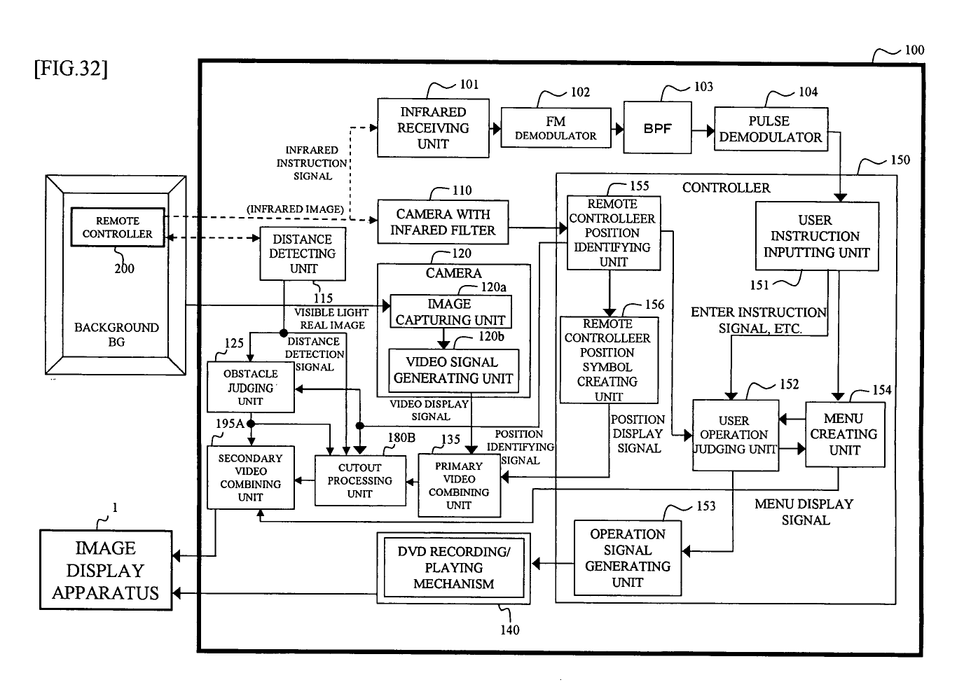

FIG. 32 is a functional block diagram shows the functional configuration of the image display control apparatus 100 of the present exemplary modification for realizing the above-described technique, and corresponds to the above mentioned FIG. 23, FIG. 3, etc. In FIG. 32, the image display control apparatus 100 of the present exemplary modification is provided with a cutout processing unit 180B and a secondary video combining unit 195A comprising functions respectively corresponding to the cutout processing unit 180 and the secondary video combining unit 195 of the configuration shown in FIG. 23 of exemplary modification (6) described earlier, and is newly provided with an obstacle judging unit 125.

The obstacle judging unit 125 receives the distance detection signal from the distance detecting unit 115 and the position identification signal from the remote controller position identifying unit 155, and determines whether or not the obstacle is in a non-activated state or an activated state as described above.

The cutout processing unit 180B in this example is not provided with an enlargement function as in the above-described cutout processing units 180 and 180A, and cuts out a video signal with the position display MA from the primary video combining unit 135 in a form (regular cutout or shifted cutout) corresponding to the above obstacle judgment result, based on the judgment result signal of the obstacle judging unit 125 and the position identification signal from the remote controller position identifying unit 155 (for details, refer to FIG. 33 described later).

The secondary video combining unit 195A combines the operation menu ME inputted from the menu creating unit 154 with the video cut out by the cutout processing unit 180B in the form (regular menu display position or shifted menu display position) corresponding to the judgment result of the obstacle judging unit 125.

FIG. 33 is a functional block diagram shows in detail the configuration of the cutout processing unit 1805 and the secondary video combining unit 195 along with the obstacle judging unit 125.

In FIG. 33, the cutout processing unit 180B comprises a regular cutout generating unit 189 for generating a regular cutout without shifting to avoid obstacles, a shifted cutout generating unit 190 for generating a cutout with shifting to avoid an obstacle, and a switch 191 that switches according to the switching control signal from the obstacle judging unit 125 and selectively outputs the input from the primary video combining unit 135 to either the regular cutout generating unit 189 or the shifted cutout generating unit 190.

The regular cutout generating unit 189 receives the position identification signal from the remote controller position identifying unit 155 and, based on the identified position of the controller 200, cuts out a predetermined range (fixed in advance, for example) in the vicinity of the position of the controller 200. The shifted cutout generating unit 190 receives the same position identification signal from the remote controller position identifying unit 155 and the obstacle judgment result (including obstacle position information) from the obstacle judging unit 125 and, based on the position of the controller 200 and the position of the obstacle, cuts out a predetermined range in the vicinity of the position of the controller 200 while shifting the position as described above to avoid the obstacle to the extent possible.

On the other hand, the secondary video combining unit 195A comprises a regular combining unit 196 for combining video for regular menu display without the shifting designed to avoid obstacles, a shifting and combining unit 197 that combines video for menu display with the shifting designed to avoid obstacles, and a switch 198 that switches according to a switch control signal from the obstacle judging unit 125 and selectively outputs the input from the cutout processing unit 180B to either the regular combining unit 196 or the shifting and combining unit 197.

The regular combining unit 196 receives the menu display signal from the menu creating unit 154 and combines the video so that the inputted operation menu ME moves to a predetermined position (fixed in advance, for example) of the image inputted from the cutout processing unit 180B. The shifting and combining unit 197 receives the same menu display signal from the menu creating unit 154 and the obstacle judgment result (including obstacle judgment information) from the obstacle judging unit 125 and, based on the obstacle position information, combines the inputted operation menu ME while shifting the position to avoid the obstacle position to the extent possible as described above.

While this examples shows a case where both the cutout processing unit 180B capable of executing the shifted cutout generating function illustrated in the above FIG. 29, and the secondary video combining unit 195A capable of executing the shifted menu display function illustrated in the above FIG. 31 are used together, in a case where it is acceptable to execute only one of these functions, the opposite side may simply comprise standard functions. For example, in a case where obstacle corrective measures are performed using only the shifted cutout generating function of the cutout processing unit 180B, the shifting and combining unit 197 (along with the switch 198) of the secondary video combining unit 195A may be omitted. Similarly, in a case where obstacle corrective measures are performed using only the shifted menu display function of the secondary video combining unit 195A, the shifted cutout generating unit 190 (along with the switch 191) of the cutout processing unit 180B may be omitted.

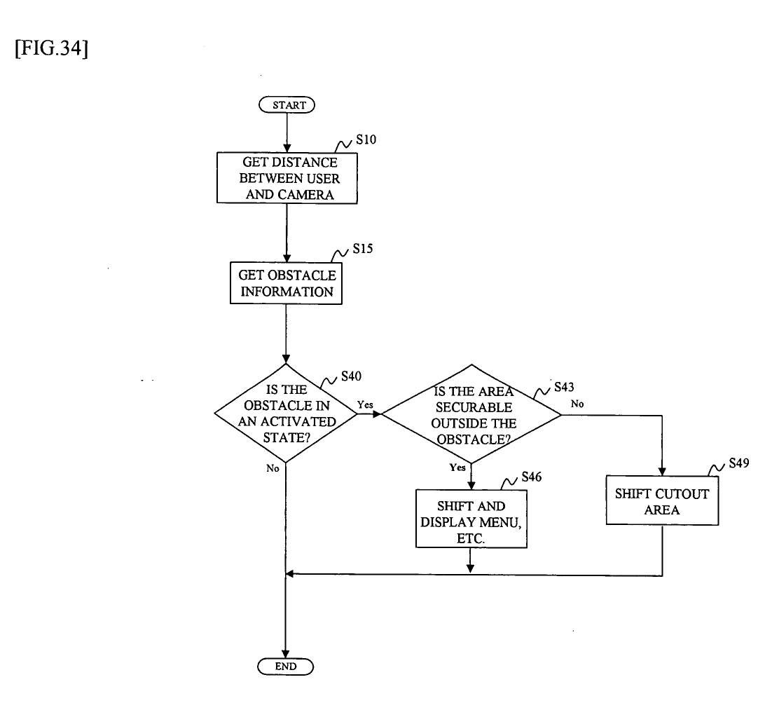

FIG. 34 is a flowchart shows a control procedure executed by the cutout processing unit 180B, the secondary video combining unit 195A, and the obstacle judging unit 125, as a whole. Note that the steps identical to those in FIG. 25 are denoted using the same reference numerals, and descriptions thereof will be suitably simplified.

In FIG. 34, first, in step S10, the obstacle judging unit 125 obtains the distance between the operator S (controller 200) and the camera 120 detected by the distance detecting unit 115.

Next, in step S15, the obstacle judging unit 125 obtains information related to the problematic obstacle (including at least activation distance, and possibly including obstacle size, etc.) from a database 145 comprising the above mentioned obstacle information compiled into a database.

Then, the process transits to step S40 in which the obstacle judging unit 125 judges whether or not the obstacle is in an activated state (in front of the operator S as viewed from the camera 120) based on the distance obtained in the above step S10 and the obstacle information obtained in the above step S15. If the obstacle is not in an activated state, conditions are not satisfied and the flow is terminated.

If the obstacle is in an activated state, the conditions of step S40 are satisfied and the flow proceeds to step S43. In step S43, the obstacle judging unit 125 judges whether or not sufficient display space for the operation menu ME can be secured in the area outside the obstacle (without generating a shifted cutout designed to avoid the obstacle) based on the above obstacle information.

For example, in a case where the obstacle itself is relatively far away from the camera 120, or in a case where the size of the obstacle itself is not so large, and the display space can be secured, the conditions of step S43 are satisfied and the process transits to step S46. In step S46, the obstacle judging unit 125 outputs the switching control signal to the switch 191 to switch to the regular cutout generating unit 189, and outputs the switching control signal to the switch 198 to switch to the shifting and combining unit 197. With this arrangement, the video signal with the position display MA from the primary video combining unit 135 is supplied to the regular cutout generating unit 189 to generate a regular cutout without shifting, the cutout video signal from the regular cutout generating unit 189 is supplied to the shifting and combining unit 197 to combine video for the shifted menu display designed to avoid an obstacle as described above, and the flow is terminated.

On the other hand, in the above step S43, for example, in a case where the obstacle itself is relatively near the camera 120, or in a case where the obstacle size itself is large, and sufficient display space for the operation menu ME cannot be secured in the area outside the obstacle, the conditions of step S43 are not satisfied and the process transits to step S49.

In step S49, the obstacle judging unit 125 outputs the switching control signal to the switch 191 to switch to the shifted cutout generating unit 190 side, and outputs the switching control signal to the switch 198 to switch to the regular combining unit 196 side. With this arrangement, the video signal with the position display MA from the primary video combining unit 135 is supplied to the shifted cutout generating unit 190 to generate a shifted cutout that avoids obstacles as described above, the cutout video signal from the shifted cutout generating unit 190 is supplied to the regular combining unit 196 to combine video for non-shifted regular menu display, and the flow is terminated.

In the image display control apparatus 1 of the present exemplary modification, the extraction processing device (the cutout processing unit 180B in this example) determines the extraction and enlargement mode (including whether the enlargement is needed or not) to avoid the video of the obstacle between the apparatus 1 and the controller 200 in the video display signal generated by the video display signal generating device 120b.

With this arrangement, in a case where an obstacle exists between the controller 200 and the apparatus 1, the operation area of the controller 200 can be secured without being blocked by he video of the obstacle on the display screen 3 by performing extraction and enlargement so as to avoid the video of that obstacle, thereby preventing a decrease in operability. Additionally, the operation position is no longer restricted.

Further, in the image display control apparatus 1 of the present exemplary modification, the apparatus 1 has an object position setting device (the secondary video combining unit 195A in this example) for setting the display position on the display screen 3 of the operable object ME generated by the object display signal generating device 154 so as to avoid the video of the obstacle between the apparatus 1 and the controller 200 in the video display signal generated by the video display signal generating device 120b.

With this arrangement, in a case where an obstacle exists between the controller 200 and the apparatus 1 and the area in which the controller 200 can be moved (the operation area) occupies a small percentage of the image of the entire background as is, the operation area of the controller 200 on the display screen 3 can be secured by displaying the operable object ME so as to avoid the video of the obstacle, thereby preventing a decrease in operability.

(8) When the Operational Feeling of Passing Over an Obstacle is to be Achieved

That is, in a case where there is an obstacle that interferes with the operation range of the controller 200 between the operator S and the camera 120, a technique whereby the operator S is given the operational feeling of passing over the obstacle as if the obstacle were not there may also be used.

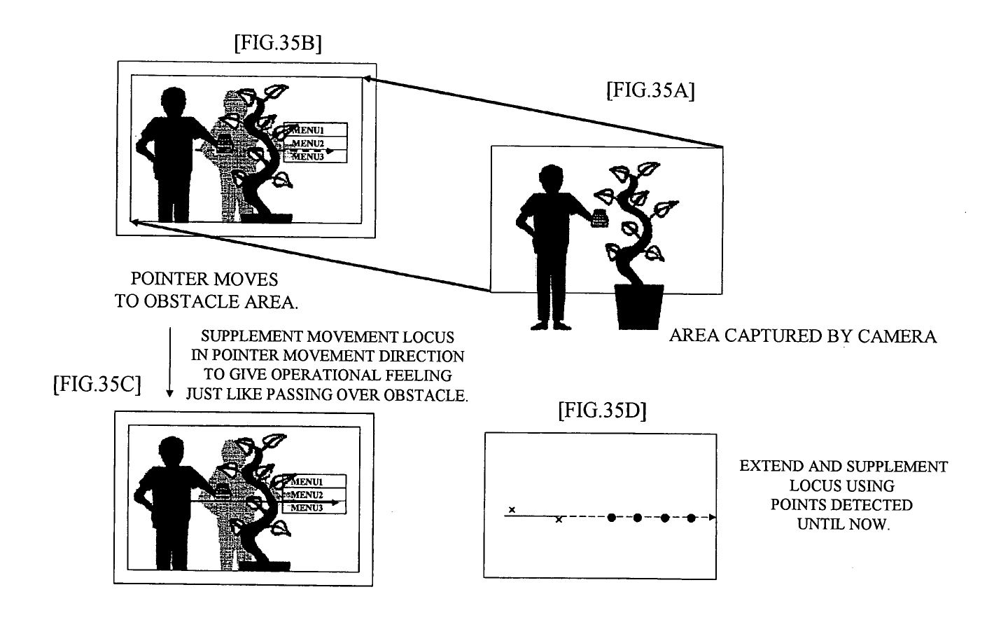

FIG. 35A, FIG. 35B, FIG. 35C, and FIG. 35D are explanatory diagrams for explaining an overview of an exemplary modification that achieves such an operational feeling.

FIG. 35A corresponds to the above-described FIG. 18, etc., shows the area captured by the camera 120 and, in this example, shows the area captured by the camera 120 on the liquid crystal display unit 3 at the same magnification as is. Here, as shown in the figure, a case where an obstacle is positioned in front of the operator S and the operation menu ME is displayed on top of the obstacle (a house plant in this example) as shown in the figure is presumed. In this case, even if the operator S holds the controller 200 and waves his or her arm on the side of the operation menu ME, the position display MA cannot be positioned on the operation menu ME, since identification of the position of the controller 200 by the remote controller position identifying unit 155 becomes difficult or impossible with the controller 200 on top of the house plant, as shown in FIG. 35B.

In the present exemplary modification, the movement locus of the identified position (indicated by a symbol “x”) of the controller 200 identified until now (until the controller 200 appears on top of the house plant) by the remote controller position identifying unit 155 is used to estimate a separate new virtual movement position so as to extend the movement locus. Based on the estimated movement position, the position display MA is displayed in a supplemented form (indicated by circular points in black). As a result, the operator S is given the operational feeling that the obstacle does not exist (that the operation can be performed by passing over the obstacle), thereby preventing a decrease in operability.

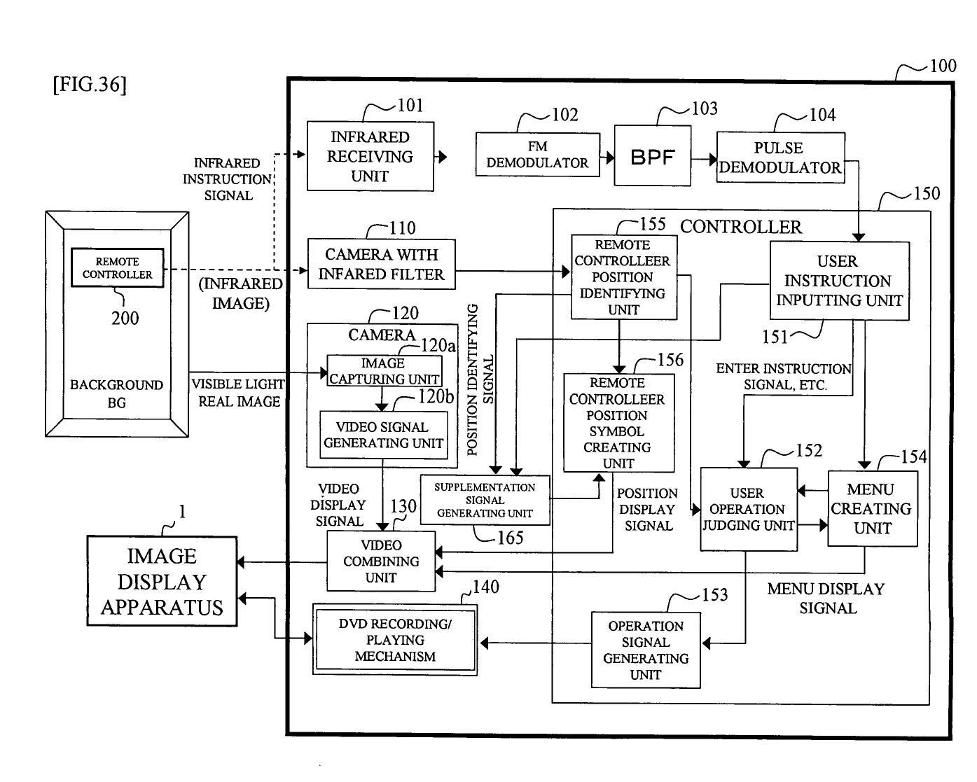

FIG. 36 is a functional block diagram shows the functional configuration of the image display control apparatus 100 of the present exemplary modification for realizing the above-described technique, and corresponds to FIG. 3, etc., of the foregoing embodiment. In FIG. 36, the image display control apparatus 100 of this exemplary modification is newly provided with a supplementation signal generating unit 165 in the configuration shown in FIG. 3.

The supplementation signal generating unit 165 receives a position identification signal from the remote controller position identifying unit 155, separately and newly estimates based on this signal the virtual movement position of the controller 200 so as to extend the movement locus of the identified position of the controller 200. The supplementation signal generating unit 165 generates a supplementation signal for supplementing and displaying the position display MA using this estimated movement position, and outputs the supplementation signal to the remote controller position symbol creating unit 156.

With this arrangement, the remote controller position symbol generating unit 156 generates a position display MA for displaying on the liquid crystal display unit 3 the position of the remote controller 200 in the position identified by the position identification signal from the remote controller position identifying unit 155 as usual, and generates and outputs to the video combining unit 130 the position display MA according to the supplementation signal inputted from the supplementation signal generating unit 165 if the display appears on top of an obstacle and the position identification signal from the remote controller position identifying unit 155 is no longer inputted. With this arrangement, the position display MA corresponding to the estimated movement position of the remote controller 200 is displayed superimposed on the captured obstacle video on the liquid crystal display unit 3.

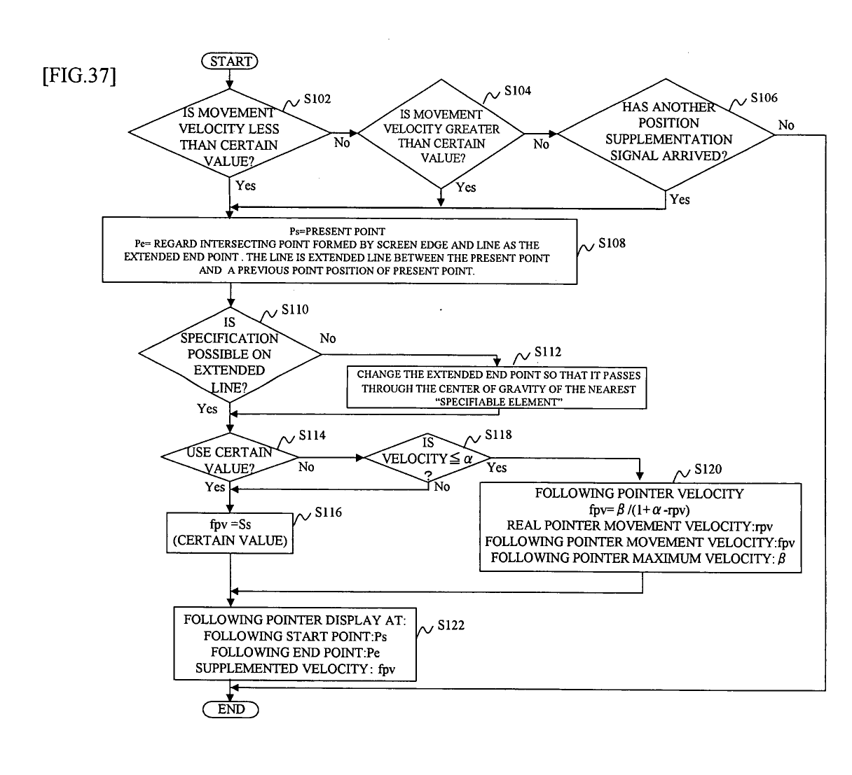

FIG. 37 is a flowchart shows the control procedure executed by the supplementation signal generating unit 165, and corresponds to the above-described FIG. 25 and FIG. 26.

In FIG. 37, first, in step S102, the supplementation signal generating unit 165 judges whether the real movement velocity of the controller 200 is less (slower) than a predetermined threshold value or not, based on the position identification signal (and its behavior within a predetermined time range) from the remote controller position identifying unit 155. When the movement velocity is less than the threshold value, conditions are satisfied, the supplementation signal generating unit 165 judges that the operator S is aware of the existence of the obstacle and is following the passing-over-obstacle operation, for example, and the process transits to step S108. When the movement velocity is greater than or equal to the threshold value, conditions are not satisfied and the process transits to step S104.

In step S104, the supplementation signal generating unit 165 judges whether or not the real movement velocity of the controller 200 is greater (faster) than a predetermined threshold value (a value greater than the threshold value of step S102) based on the position identification signal (and its behavior within a predetermined time range) from the remote controller position identifying unit 155. When the movement velocity is greater than the threshold value, conditions are satisfied, the supplementation signal generating unit 165 judges that the operator S is aware of the existence of the obstacle and is following the passing-over-obstacle operation, for example, and the process transits to step S108. When the movement velocity is less than the threshold value, conditions are not satisfied and the process transits to step S106.

In step S106, the supplementation signal generating unit 165 judges whether or not a supplementation instruction signal from the operator S has been inputted. That is, an operating device that enables the operator S to intentionally (forcibly) instruct supplementation execution by the supplementation signal generating unit 165 is provided, and the supplementation instruction signal from this operating device is inputted to the supplementation signal generating unit 165 (refer to the arrow from the user instruction inputting unit 151 in FIG. 36), regardless of whether or not the conditions of step S102, step S104, etc., have been satisfied. This step S106 is for judging whether or not the supplementation instruction signal has been inputted. When there is a supplementation execution instruction from the operator S, conditions are satisfied and the process transits to step S108 described later. When there is not a supplementation execution instruction, conditions are not satisfied and the flow is terminated.

In step S108 that results when the each conditions of step S102, step S104, or step S106 was satisfied, the extended operation start point Ps at the time the above-described real movement locus of the controller 200 stops and the extended display begins is set as the current position of the controller 200. Further, the extended operation end point Pe is determined as follows.

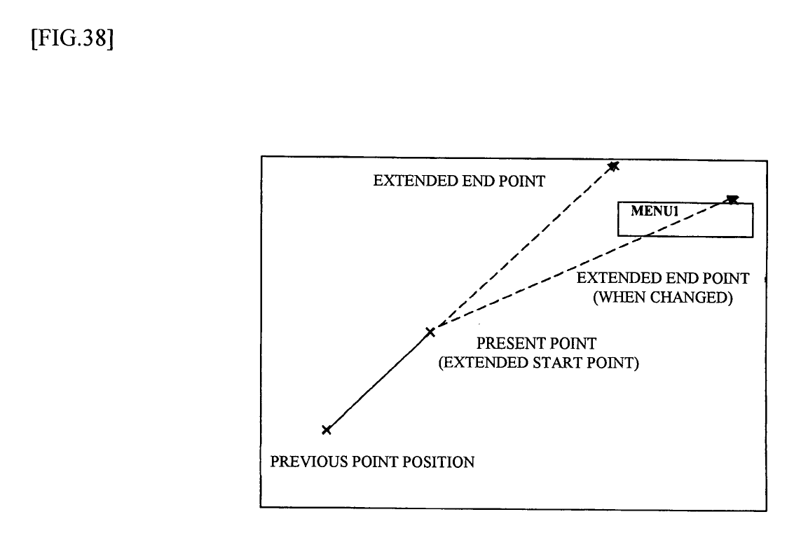

That is, as conceptually shown in FIG. 38, a line segment is drawn between the current position of the controller 200 and the position slightly prior to that position, a line that extends that line segment is drawn from the slightly prior position in the direction toward the current position, and the intersecting point of that extended line and the display screen edge is set as extended end point Pe. After the extended start point Ps and extended endpoint Pe are determined according to this rule, the process transits to step S110.

In step S110, the supplementation signal generating unit 165 judges whether or not the point determined as the extended end point Pe in step S108 (the intersecting point of the extended line and display screen edge) can be actually specified as the extended operation end point. For example, in a case where the end point clearly deviates from the operable range as viewed from the standard height, etc., of the operator S and cannot be specified, the conditions are not satisfied and the process transits to step S112. In a case where the point can be specified, the conditions of step S110 is satisfied and the process transits to the above-described step S114.

In step S112, the supplementation signal generating unit 165 changes the position of the extended end point Pe so that the extended line passes through a predetermined location (the center of gravity in this example) of a different specifiable element (on the operation ME displayed from the menu display signal from the menu creating unit 154; refer to FIG. 38) that is different from the extended end point Pe determined in step S108. Subsequently, the process transits to step S114.

In step S114, the supplementation signal generating unit 165 judges whether or not the extension supplementation (following) velocity of the position display MA at the time extension supplementation (following) is performed so as to extend the extended line is set to a certain value.

That is, even in the present exemplary modification, the following velocity of the position display MA during extension supplementation processing executed similar to that described in the previous exemplary modification (6) has two modes: constant velocity mode wherein following is performed at a predetermined constant velocity (regardless of the real movement velocity of the controller 200), and variable velocity mode wherein the following velocity changes according to the real movement velocity of the controller 200. Then, a selecting device that enables the operator S to instruct the system to use one of the two modes during the above extension supplementation processing is provided, and the mode selection signal from the selecting device is inputted to the supplementation signal generating unit 165. This step S114 judges whether or not constant velocity mode has been selected by that mode selection signal.

When the operator S selects constant velocity mode, the conditions of step S114 are satisfied and the process transits to step S116. In step S116, the following velocity fpv of the position display MA (pointer) at the time following is performed so as to extend the movement locus of the actual controller 200 as described above is set to a predetermined certain value Ss.

On the other hand, when the operator S selects variable mode, the conditions of step S114 are not satisfied and the process transits to step S118. In step S118, the supplementation signal generating unit 165 judges whether or not the real movement velocity of the controller 200 is less than or equal to a predetermined threshold value a (set in advance), based on the position identification signal (and its behavior within a predetermined time range) from the remote controller position identifying unit 155. When the movement velocity of the controller 200 is not so slow, the conditions of step S118 are not satisfied and the process transits to the above-described step S116. When the movement velocity of the controller 200 is sufficiently slow, the conditions of step S118 are satisfied and the process transitions to step S120.

In step S120, the following velocity fpv of the position display MA (pointer) at the time following is performed so as to extend the real movement locus of the controller 200 as described above is calculated from the following equation, which is the same as the above mentioned equation 1:

fpv=β/(1+α−rpv) (Equation 2)

As previously described, rpv is the real movement velocity (real pointer velocity) of the controller 200 (real position display MA), and β is the maximum following pointer velocity set as the fixed upper limit in advance. Additionally, α is the threshold value of the above mentioned movement velocity in step S118.

The above Equation 2 has the same significance as the above mentioned Equation 1. That is, because the real movement velocity of the controller 200 at the moment conditions of step S118 are satisfied and the process transits to step S120 is rpv≦α, α−rpv of Equation 2 is the value 0 or higher and increases as the real movement velocity of the controller 200 decreases (increases to the extent the operation is slow). As a result, with the addition of one, the value 1+α−rpv equals 1 or higher, increasing to a value greater than 1 to the extent the operation velocity is slow. A following pointer velocity fpv that does not exceed the upper limit and decreases to the extent the operation is slow is achieved by dividing the maximum following pointer velocity β using such a value.

When step S116 or step S120 ends, the process transits to step S122. In step S122, the supplementation signal generating unit 165 performs the above-described extension supplementation processing on the position display (pointer) MA created and inputted by the remote controller position symbol creating unit 156 and, from the extended start point PS to the extended end point Pe determined in step S108 (or step S112), outputs a supplementation signal to the remote controller position symbol creating unit 156 so that the position display MA is displayed according to the following pointer velocity fpv determined in step S116 or step S120. After step S122 ends, the routine is terminated.

Furthermore, in the above-described embodiment, etc., when the operator S moves the handheld remote controller 200 to move the position display MA on the liquid crystal display unit 3 and the position display MA arrives in the desired operation area of the operation menu ME, the operator S appropriately operates (presses the “Enter” button, for example) the operating unit 201 to enter the operation of the operation area. Then, as a result, the corresponding infrared instruction signal is emitted from the infrared driving unit 202 and processing is performed based on this signal on the image display control apparatus 100 side so that the corresponding operation signal is outputted to the DVD recording/playing mechanism 140 and the corresponding operation is performed.

In the present exemplary modification, it is impossible or difficult to receive the corresponding infrared instruction signal on the image display control apparatus 100 side in a state where the position display MA arrives on the extended line blocked by the obstacle as described above, and operation of that operation area cannot be entered when the position display MA arrives on the desired operation area of the operation menu ME as is. The operation area at which the position display MA arrives after a predetermined amount of time has passed since the start of the extension supplementation operation may therefore be automatically regarded as the operation area entered by the operator S, or a separate instructing device (for entering the operation area) may be established to perform the enter instruction.

The image display control apparatus 1 of the present exemplary modification comprises an estimated position setting device (the supplementation signal generating unit 165) that sets an estimated movement position of the controller 200 that is different from the identified position, based on the movement information of the controller 200 recognized on the basis of the position identification result from the position identifying device 155.

With this arrangement, in a case where the movement locus of the controller 200 can no longer be detected due to the existence of an obstacle, for example, the movement position is estimated and set in addition to the position identification result of the controller 200, thereby virtually supplementing and continually expressing the movement locus on the display screen 3 and improving operability.

In the image display control apparatus 1 of the present exemplary modification, the estimated position setting device 165 sets estimated movement positions so that the positions appear on an extended line in the movement direction successively identified by the position identifying device 155 when the controller 200 is moved.

With this arrangement, in a case where the movement locus can no longer be detected due to the existence of an obstacle, etc., the movement position on the extended line in the movement direction of the controller 200 is estimated to virtually supplement the movement locus on the display screen 3 and reconstruct the broken movement locus, thereby improving operability.

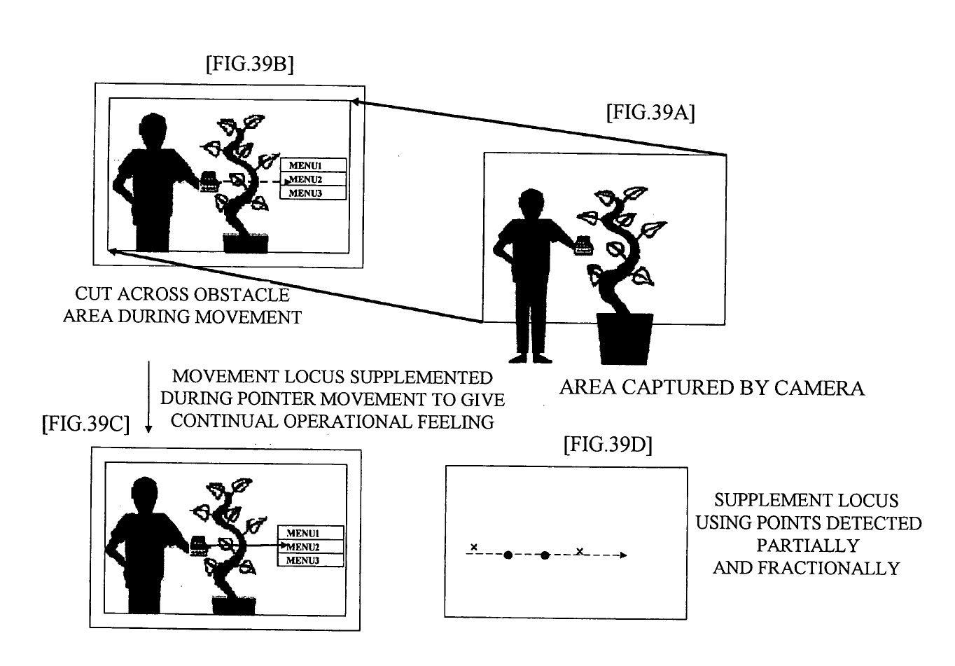

Furthermore, while the above has been described using as an example a case where the controller 200 is completely blocked by an obstacle when the controller 200 is moved in the direction of the obstacle, causing the movement locus to no longer be detected and, in response, the movement position is estimated on an extended line in the movement direction, the present invention is not limited thereto. That is, for example, consider a case as in FIG. 39A where an obstacle is positioned in front of the operator S (a house plant in this example) and the operation menu ME is displayed across from the obstacle on the side opposite the operator S (so the operation menu ME itself is not covered by the obstacle). In this case, the operator S can hold the controller 200 and wave his/her arm (so that the operation menu ME is not covered by the obstacle), thereby ultimately positioning the position display MA on the operation menu ME, enabling normal operation. Nevertheless, in the intermediate stage up to the point when the position display MA is positioned on the operation menu ME as described above, identification of the position of the controller 200 by the remote controller position identifying unit 155 becomes difficult or impossible when the controller 200 appears on top of the house plant, as shown in FIG. 39B, resulting in the possibility that the position display MA will only be displayed discretely in fragments (blocked by the branches of the house plant, for example) or that movement resolution will decrease.

In such a case, the technique of extension supplementation of exemplary modification (8) may be applied to the supplementation of the movement locus intermediate area, in the same manner as above. That is, as shown in FIG. 39C and FIG. 39 C, before the controller 200 appears on top of the houseplant and in a state where the controller 200 appears fragmented through the leaves, the movement locus of the identified position (indicated by “x”) of the controller 200 identified by the remote controller position identifying unit 155 is used to separately and newly estimate a virtual movement position to connect the fragments (to connect two neighboring points of the identified position of the controller 200) and display the position display MA in a supplemented form based on this estimated movement position (indicated by a black circle). As a result, the operator S is given a continual operational feeling, as if there is no interference caused by the obstacle.

In the image display control apparatus 1 of the present exemplary modification, the estimated position setting device 165 sets the estimated movement position so that the position appears in the intermediate area between two neighboring points successively identified by the position identifying device 155 when the controller 200 is moved.

With this arrangement, in a case where the movement locus of the controller 200 on the display screen 3 can only be detected discretely in fragments due to the existence of an obstacle, an estimated movement position is set between two neighboring points to virtually supplement and continually express the movement locus on the display screen 3, thereby improving the smoothness of the operation.

(9) When the Present Invention is Applied to Specifying the Play Position of Stored Contents

The above described the present invention using as an example a case where the menu screen related to the operation of the DVD recording/playing mechanism 140 is displayed on the image display apparatus 1, and the infrared image of the remote controller 200 is used as a pointer for menu selection. Nevertheless, the use of the pointer is not limited thereto, and may be applied to other scenarios as well. The present exemplary modification is an example of a case where the function of the pointer is applied to the flexible specification of a play position of stored contents.

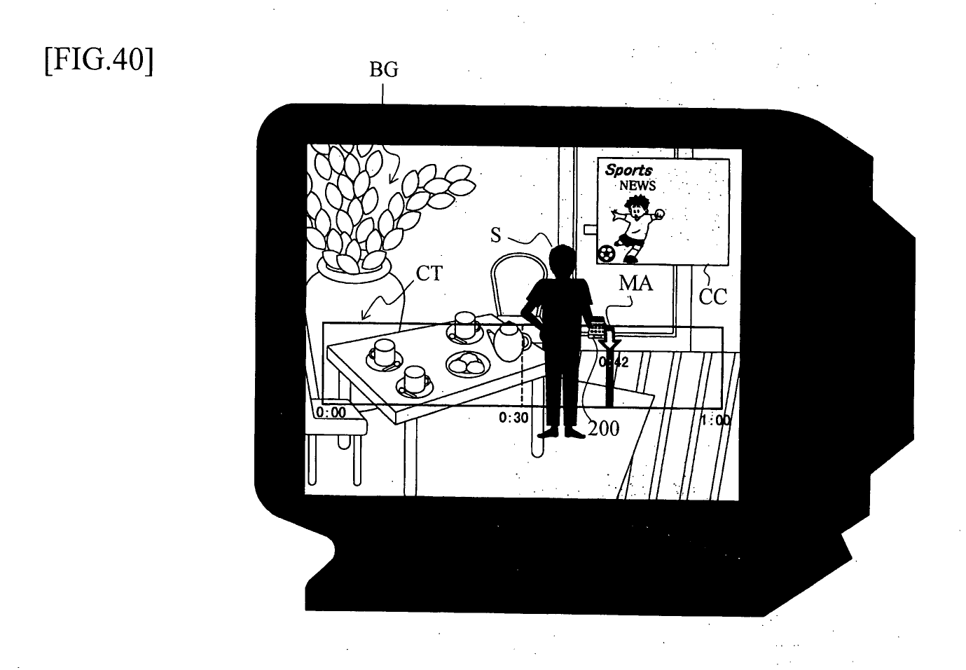

FIG. 40 is a diagram shows an example of a display of the liquid crystal display unit 3 of the image display apparatus 1 of the image display system of the present exemplary modification, and corresponds to the above mentioned FIG. 6. Note that the component parts identical to those in FIG. 6 are denoted by the same reference numerals. FIG. 40 shows a case where the operator S has created a contents (programs, etc.) display CT of the contents of one hour in length that are prerecorded on a DVD stored in the above-described storing area (not shown) of the image display control apparatus 100 and, intending to play the contents from a desired time position (42 minutes from the play start position in the example shown in the figure), positions the position of the handheld remote controller 200 on the liquid crystal display unit 3 to the 42-minute point of the contents display CT (refer to the arrow), and presses the “Enter” button to specify the selection. In this example, the image CC (static image or animation) of the contents at the 42-minute point (play start position) is displayed in split screen format in the upper right area of the liquid crystal display unit 3. Note that, in place of the contents image CC, an image of a present broadcast of a predetermined channel unrelated to the specification of the content play start position may be displayed in this position.

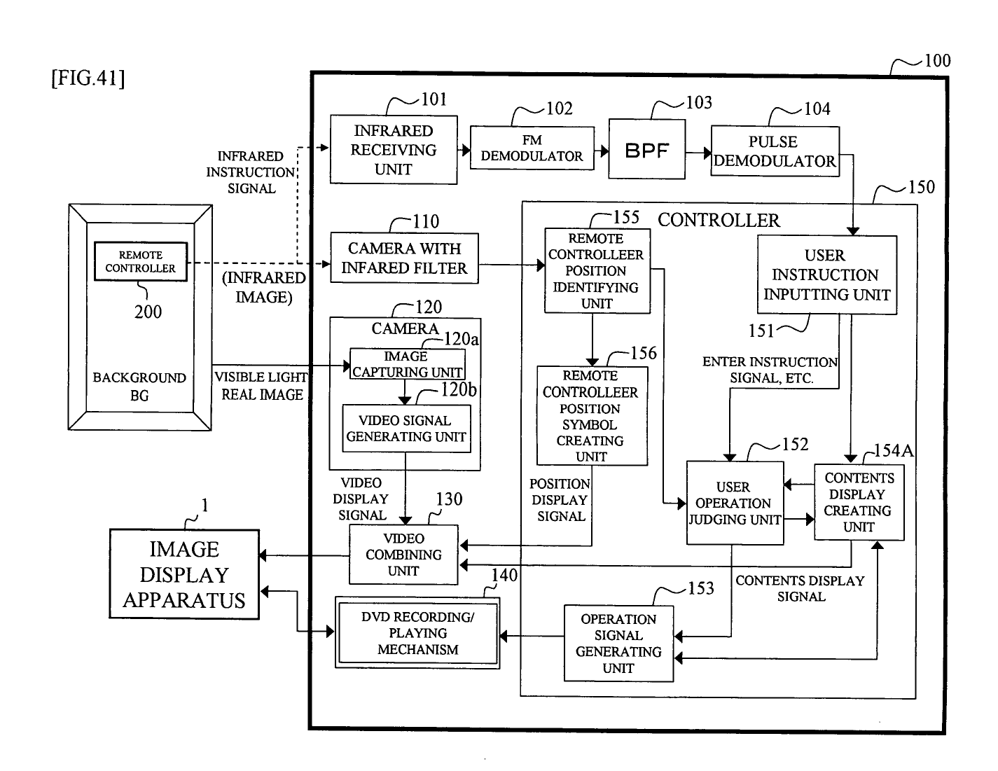

FIG. 41 is a functional block diagram shows the functional configuration of the above-described image display control apparatus 100. In FIG. 41, the image display control apparatus 100 comprises a contents display creating unit 154A that generates a signal for displaying the contents on the liquid crystal display unit 3, in place of the menu display creating unit 154 shown in FIG. 3, etc.

In the present exemplary modification, when the real world in which the operator S exists is displayed on the liquid crystal display unit 3 of the image display apparatus 1 based on the video display signal from the camera 120 as described above and the operator S holds the remote controller 200 in hand and appropriately operates the operating unit 201, an identified corresponding infrared instruction signal (corresponding to contents play position specification mode) is emitted from the infrared driving unit 202 and, similar to the above, received by the infrared receiving unit 101 of the image display control apparatus 100. In response, the user instruction inputting unit 151 receives and decodes the identification code via the FM demodulator 102, the BPF 103, and the pulse demodulator 104. The user instruction inputting unit 151 in response inputs the creation instruction signal to the contents display creating unit 154A, and the content display creating unit 154A inquires about the play contents corresponding to the DVD recording/playing mechanism 140, acquires that information (contents existence or nonexistence, total recording time, etc.), and generates a contents display signal (object display signal) for displaying a contents time frame (operable object) comprising a strip-shaped display such as shown in FIG. 40 on the liquid crystal display unit 3 of the image display apparatus 1.

This contents display signal, as described above, is combined with a video display signal from the video signal generating unit 120b of the camera 120 and the combined signal is outputted to the image display apparatus 1 by the video combining unit 130, thereby displaying on the liquid crystal display unit 3 a combined video of the video captured by the camera 120 and the contents display CT from the contents display creating unit 154A (transitioning the mode to contents play position specification mode or, in other words, screen position selection mode). Furthermore, in the present exemplary modification as well, as described above, the identified infrared instruction signal (low power consumption) is continually issued from the remote controller 200 while the mode is transitioned to contents play position specification mode (until the mode ends).

On the other hand, at this time, as described above, the identified infrared instruction signal issued from the remote controller 200 held by the operator S is captured by the camera 110 with an infrared filter, the position occupied by the remote controller 200 during image capturing by the camera 110 with an infrared filter is identified by the remote controller position identifying unit 155, and a position display signal is generated by the remote controller position symbol creating unit 156 based on that position information and inputted to the video combining unit 130, thereby displaying the position display MA (arrow symbol, refer to FIG. 40) on (or near) the position of the captured remote controller 200 on the liquid crystal display unit 3. With this arrangement, by holding the remote controller 200 and moving its position (spatially changing its location), the operator S can move on the liquid crystal display unit 3 the position display MA of the remote controller 200 displayed superimposed on the contents display CT on the liquid crystal display unit 3.

On the other hand, as described above, the position information of the remote controller 200 identified by the remote controller position identifying unit 155 is also inputted to the user operation judging unit 152, and the contents display related information (the contents of what type and what time length are to be displayed) of the contents display signal created by the contents display creating unit 154A is also inputted to the user operation judging unit 152 at this time.

When the operator S moves the remote controller 200 to move the position display MA on the liquid crystal display unit 3 and appropriately operates the operating unit 201 (presses the “Enter” button, for example) to enter the selection when the position display MA arrives at the desired play start position of the contents display CT as described above, the corresponding infrared instruction signal is emitted from the infrared driving unit 202 and received by the infrared receiving unit 101 of the image display control apparatus 100, the corresponding identification code is inputted to and decoded by the user instruction inputting unit 151 of the controller 150 via the FM demodulator 102, the BPF 103, and the pulse demodulator 104 (the instruction signal inputting device), and the enter instruction signal is then inputted to the user operation judging unit 152.

The user operation judging unit 152 to which the enter instruction signal is inputted determines (operation area determining device), as described above, the selected and specified play start position (operable specification object) of the contents display CT displayed on the liquid crystal display unit 3, based on the position information of the remote controller 200 obtained from the remote controller position identifying unit 155 and the contents display information obtained from the contents display creating unit 154, and inputs the corresponding signal to the contents display creating unit 154A. The contents display creating unit 154A generates and outputs to the video combining unit 130 a contents display signal such as a signal that displays the selected and specified play start position and its nearby area in a form different from the other areas based on the inputted signal.

As a result, the selected and specified 42-minute position from the play start position and nearby area are displayed in this example in a color different from the other areas, as shown in FIG. 40. Then, the operation instruction signal corresponding to the selection and specification of the play start position is outputted from the user operation judging unit 152 to the operation signal generating unit 153, the operation signal generating unit 153 outputs the corresponding operation signal to the DVD recording/playing mechanism 140, and the play operation is performed from the corresponding position.

The exemplary modification described above can also provide advantages similar to those in the foregoing embodiment. That is, the position display MA of the remote controller 200 on the liquid crystal display unit 3 can be utilized as a pointer for selecting and specifying the play start position from the contents display CT, thereby enabling the operator S to easily select and specify a desired play start position in the content display CT using the very physically and intuitively easy-to-understand operation of moving the position of the remote controller 200 itself without looking away from the liquid crystal display unit 3. At this time, the burden on the operator S is not increased since gesture memorization is not required as in the case of prior art, thereby improving the convenience of the operator during remote control. The additional advantages obtained are substantially the same as the foregoing embodiment, though details are omitted.

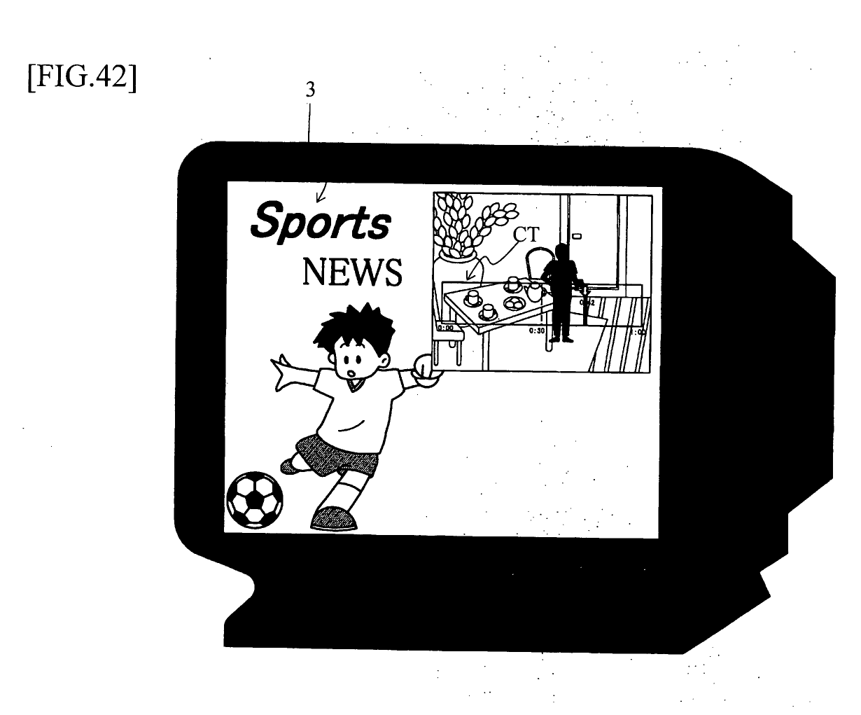

Furthermore, while in the above the real world video and contents display CT are displayed in large size on nearly the entire crystal liquid display unit 3, and the contents image CC of the play start position (or present broadcast image of a predetermined channel) is displayed in split screen format in the right upper area as shown in FIG. 40, the present invention is not limited thereto. That is, conversely, the contents image CC of the play start position (or present broadcast image of a predetermined channel) may be displayed in large size on nearly the enter liquid crystal display unit 3, and the real world video and contents display CT may be displayed in split screen format in the upper right area, as shown in FIG. 42.

Furthermore, the present invention is not limited within specifying the play start position based on the position of the remote controller 200 as described above, but may be used to specify the volume of the played video or played music, or the brightness of the display screen, for example. Additionally, the present invention is not limited within specifying play, but may be used to specify the record start position, etc.

(10) When the Present Invention is Applied to EPG

The above pointer function can also be applied to an electronic program guide (EPG), which has rapidly increased in popularity in recent years. The present exemplary modification is an example of such a case.

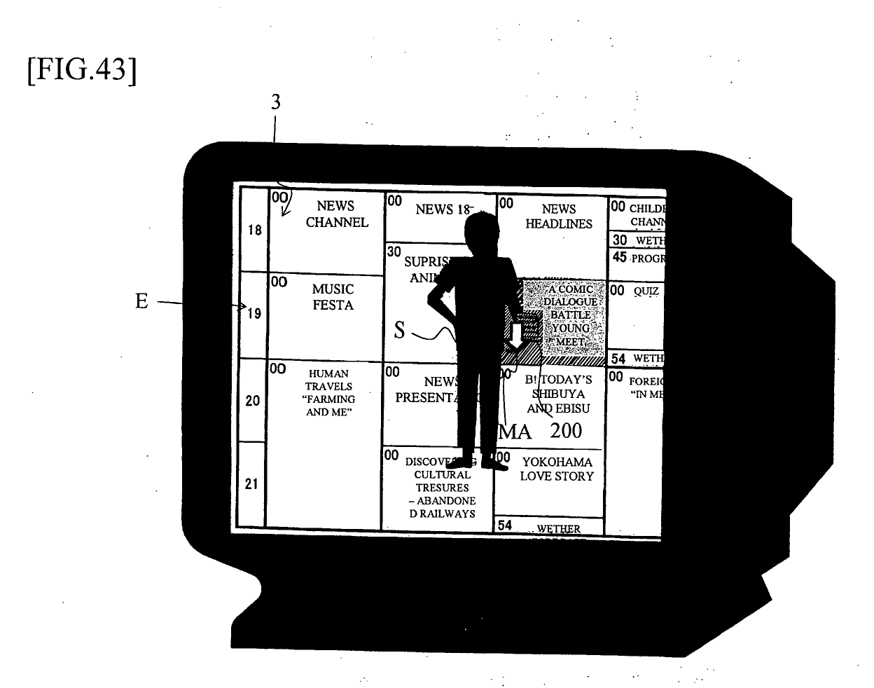

FIG. 43 is a diagram shows an example of a display of the liquid crystal display unit 3 of the image display apparatus 1 of the image display system of the present exemplary modification, and corresponds to the above mentioned FIG. 6 and FIG. 40. Note that the component parts identical to those in FIG. 6 are denoted by the same reference numerals. FIG. 43 shows a state where, in this example, the operators has displayed the electronic program guide E on the liquid crystal display unit 3 using a known function of the image display control apparatus 100 or the image display apparatus 1 and, intending to listen to a predetermined program displayed on the electronic program guide E, positions the handheld remote controller 200 on the liquid crystal display unit 3 in the program area (frame) of the electronic program guide E (refer to the arrow symbol), and presses the above mentioned “Enter” button to select and specify that area.

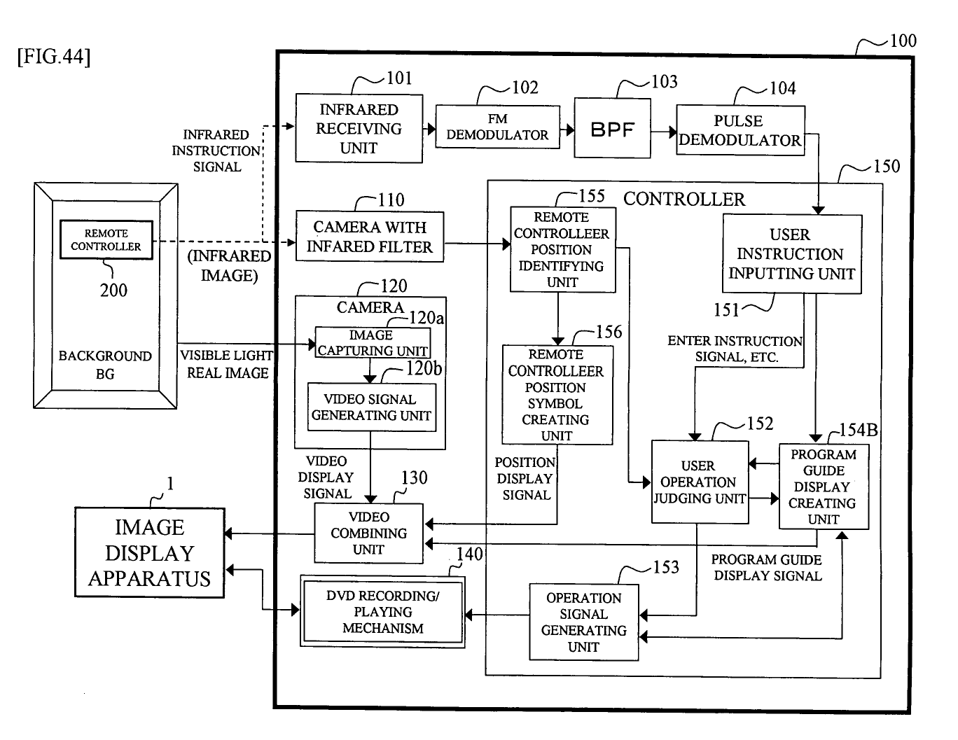

FIG. 44 is a functional block diagram shows the functional configuration of the above-described image display control apparatus 100. In FIG. 44, the image display control apparatus 100 comprises a program guide display creating unit 154B that generates a signal for displaying on the liquid crystal display unit 3 an electronic program guide E that includes the desired program the operator S would like to hear, in place of the contents display creating unit 154A shown in FIG. 41 of the exemplary modification (9) described above.

In this exemplary modification as well, similar to the foregoing exemplary modification (9), when the real world in which the operator S exists is displayed on the liquid crystal display unit 3 of the image display apparatus 1 based on the video display signal from the camera 120 and the operator S holds the remote controller 200 in hand and appropriately operates the operating unit 201, an identified corresponding infrared instruction signal (corresponding to electronic program guide display mode) is emitted from the infrared driving unit 202 and received by the infrared receiving unit 101 of the image display control apparatus 100, and the corresponding identification code is inputted to and decoded by the user instruction inputting unit 151 of the controller 150 via the FM demodulator 102, the BPF 103, and the pulse demodulator 104. The user instruction inputting unit 151 inputs a creation instruction signal to the program guide display creating unit 154B in response, and the program guide display creating unit 154B then makes an inquiring regarding the acquirable electronic program guide to the DVD recording/playing mechanism 140 (or to the image display apparatus 1 via the DVD recording/playing mechanism 140) to acquire the information (program contents, time, etc., to be displayed in the electronic program guide), and subsequently generates a program guide display signal (object display signal) for displaying the electronic program guide E (operable object) of the desired form such as that of the example shown in FIG. 43 on the liquid crystal display unit 3 of the image display apparatus 1.

This program guide display signal, as described above, is combined with a video display signal from the video signal generating unit 120b of the camera 120 and the combined signal is outputted to the image display apparatus 1 by the video combining unit 130, thereby displaying on the liquid crystal display unit 3 a combined video of the video captured by the camera 120 and the electronic program guide E from the program guide display creating unit 154B (transitioning the mode to electronic program guide display mode or, in other words, screen position selection mode). Furthermore, in the present exemplary modification as well, the identified infrared instruction signal (low power consumption) is continually issued from the remote controller 200 while the mode is transitioned to the electronic program guide display mode (until the mode ends).

On the other hand, as in the above exemplary modification (9), the identified infrared instruction signal issued from the remote controller 200 held by the operator S is captured by the camera 110 with an infrared filter, the position occupied by the remote controller 200 during image capturing by the camera 110 with an infrared filter is identified by the remote controller position identifying unit 155, and a position display signal is generated by the remote controller position symbol creating unit 156 based on that position information and inputted to the video combining unit 130, thereby displaying the position display MA (arrow symbol, refer to FIG. 43) on (or near) the position of the captured remote controller 200 on the liquid crystal display unit 3. With this arrangement, by holding the remote controller 200 and moving its position (spatially changing its location), the operator S can move on the liquid crystal display unit 3 the position display MA of the remote controller 200 displayed superimposed on the electronic program guide E on the liquid crystal display unit 3.

On the other hand, as in the above exemplary modification (9), the position information of the remote controller 200 identified by the remote controller position identifying unit 155 is also inputted to the user operation judging unit 152, and the electronic program guide display related information (the programs of what length, what content, and what time periods are to be displayed) of the program guide display signal created by the program guide display creating unit 154B is also inputted to the user operation judging unit 152 at this time.

When the operator S moves the remote controller 200 to move the position display MA on the liquid crystal display unit 3 and appropriately operates the operating unit 201 (presses the “Enter” button, for example) to enter the selection when the position display MA arrives in the display area of the desired program of the electronic program guide display E as described above, as in the above exemplary modification (9), the corresponding infrared instruction signal is emitted from the infrared driving unit 202 and received by the infrared receiving unit 101 of the image display control apparatus 100, the corresponding identification code is inputted to and decoded by the user instruction inputting unit 151 of the controller 150 via the FM demodulator 102, the BPF 103, and the pulse demodulator 104 (the instruction signal inputting device), and the enter instruction signal is in response inputted to the user operation judging unit 152.

The user operation judging unit 152 to which the enter instruction signal is inputted determines (the operation area determining device), as in the above exemplary modification (9), the selected and specified desired program area (operable specification object) of the electronic program guide E displayed on the liquid crystal display unit 3, based on the position information of the remote controller 200 obtained from the remote controller position identifying unit 155 and the electronic program guide display information obtained from the program guide display creating unit 154B, and inputs the corresponding signal to the program guide display creating unit 154B. The program guide display creating unit 154B generates and outputs to the video combining unit 130 a program guide display signal so that the selected and specified program area (program frame) is displayed in a form different from the other areas based on the inputted signal.

As a result, as shown in FIG. 2, in this example the selected and specified program area is displayed in a color different from the other areas. Then, the operation instruction signal corresponding to the selection and specification of the program area is outputted from the user operation judging unit 152 to the operation signal generating unit 153, the operation signal generating unit 153 outputs the corresponding operation signal to the image display apparatus 1 via the DVD recording/playing mechanism 140, and the corresponding program is displayed on and heard from the liquid crystal display unit 3 of the image display apparatus 1.

The exemplary modification described above can also provide advantages similar to those in the foregoing embodiment. That is, the position display MA of the remote controller 200 on the liquid crystal display unit 3 can be utilized as a pointer for selecting and specifying a desired program from the electronic program guide E, thereby enabling the operator S to easily select and specify a desired program area of the electronic program guide E using the very physically and intuitively easy-to-understand operation of moving the position of the remote controller itself without looking away from the liquid crystal display unit 3. At this time, the burden on the operator S is not increased since gesture memorization is not required as in the case of prior art, thereby improving the convenience of the operator during remote control. The additional advantages obtained are substantially the same as the foregoing embodiment, though details are omitted.

(11) When the Captured Image is Omitted

While the above utilized the infrared image of the remote controller 200 as a pointer in a state where the position of the remote controller 200 based on the infrared video and the real world video from a camera are displayed superimposed on the liquid crystal display unit 3 of the image display apparatus 1, the captured video is not necessarily required and may be omitted as long as the above-described advantage of enabling the operator S to easily select and specify a desired operation area of the operation menu ME using a very physically and intuitively easy-to-understand operation can be achieved. The present exemplary modification is an example of such a case.

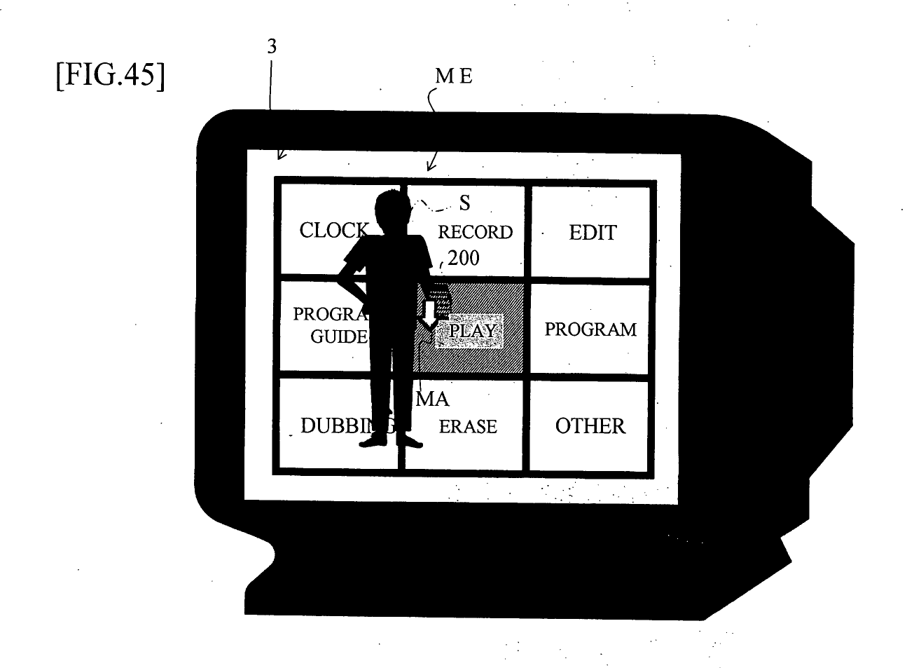

FIG. 45 is a diagram shows an example of a display on the liquid crystal display unit 3 of the image display apparatus 1 of the image display system of the present exemplary modification, and corresponds to the above mentioned FIG. 6, FIG. 40, FIG. 43, etc. Note that the component parts identical to those in FIG. 6 are denoted by the same reference numerals. Furthermore, for the ease of explanation and comprehension, the real video of the operator S and the remote controller 200 is shown in the same manner as FIG. 6, etc., but in actuality this are not displayed (refer to the dashed-two dotted line) and only the position display MA (white arrow) of the remote controller 200 appears on the liquid crystal display unit 3.

FIG. 45 shows the state when the operator S displays the operation menu ME on the liquid crystal display unit 3 and, intending to perform a predetermined operation included in the operation menu ME, positions on the operation area corresponding to the operation menu ME the position of the handheld remote controller 200 on the liquid crystal display unit 3, and presses the “Enter” button to select and specify that area.

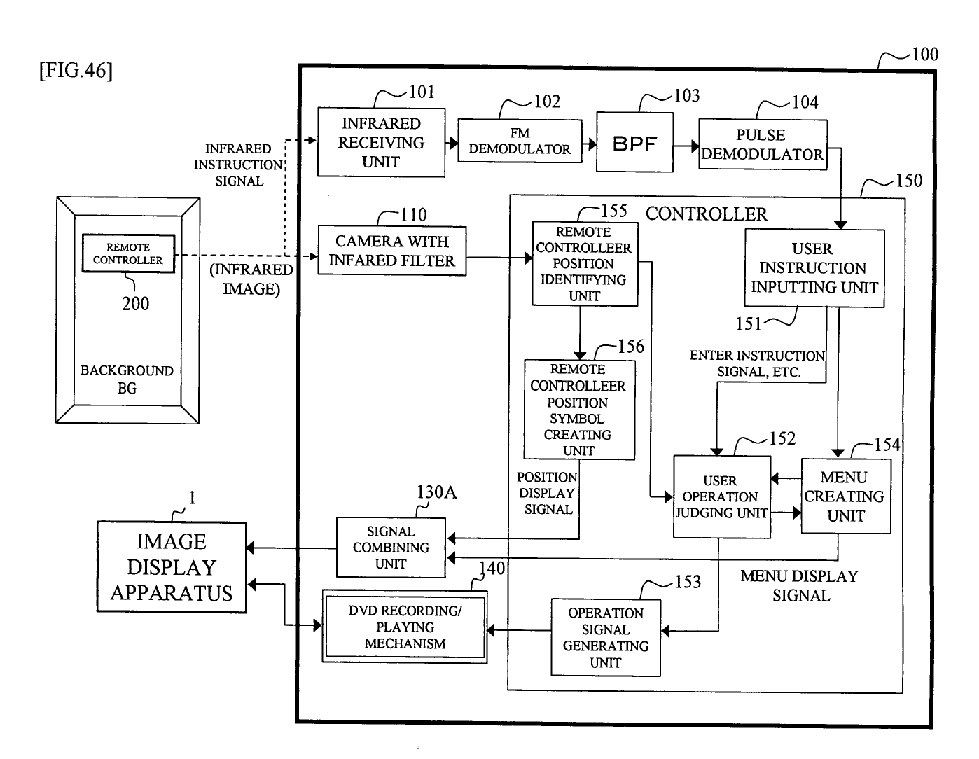

FIG. 46 is a functional block diagram shows the functional configuration of the above-described image display control apparatus 100. In FIG. 46, the image display control apparatus 100, based on the configuration shown in FIG. 3 of the foregoing embodiment, comprises a signal combining unit 130A in place of the video combining unit 130, and no longer comprises the camera 120. The signal combining unit 130A receives only two signals—the position display signal from the remote controller position symbol creating unit 156 and the menu display signal from the menu creating unit 154—and combines and outputs these signals to the image display apparatus 1, resulting in a display such as the display described using FIG. 45 on the liquid crystal display unit 3 of the image display apparatus 1.

That is, the identified infrared instruction signal issued from the remote controller 200 held by the operator S is captured and recognized as an infrared image by the camera 110 with an infrared filter, the captured signal is inputted to the remote controller position identifying unit 155, and the remote controller position identifying unit 155 identifies the position occupied by the remote controller 200 during image capturing by the camera 110 with an infrared filter based on the recognition result.

The position information of the remote controller 200 identified by the remote controller position identifying unit 155 is inputted to the remote controller position symbol creating unit 156, a position display signal for displaying the position of the remote controller 200 on the liquid crystal display unit 3 is generated, and the generated position display signal is inputted to the signal combining unit 130A. As a result, a predetermined position display MA (arrow symbol, refer to FIG. 45) corresponding to the position of the remote controller 200 is displayed superimposed on the operation menu ME already displayed based on the menu display signal from the menu creating unit 154 using the above-described technique in the liquid crystal display unit 3. With this arrangement, by holding the remote controller 200 and moving its position (spatially changing its location), the operator S can move on the liquid crystal display unit 3 the position display MA of the remote controller 200 displayed superimposed on the operation menu ME on the liquid crystal display unit 3.

When the operator S moves the handheld remote controller 200 to move the position display MA on the liquid crystal display unit 3 and appropriately operates the operating unit 201 (pressing the “Enter” button, for example) to enter the operation of the operation area when the position display MA arrives in the desired operation area of the operation menu ME, the corresponding infrared instruction signal is emitted from the infrared driving unit 202 and received by the infrared receiving unit 101 of the image display control apparatus 100, and the corresponding identification code is inputted to and decoded by the user instruction inputting unit 151 of the controller 150 via the FM demodulator 102, the BPF 103, and the pulse demodulator 104 (the instruction signal inputting device). In the user instruction inputting unit 151, the enter instruction signal is then inputted to the user operation judging unit 152.

The user operation judging unit 152 to which the enter instruction signal is inputted determines (operation area determining device) the selected and specified operation area (operable specification object) of the operation menu ME displayed on the liquid crystal display unit 3, based on the position information of the remote controller 200 obtained from the above-described remote controller position identifying unit 155 and the menu display information obtained from the menu creating unit 154, and inputs the corresponding signal to the menu creating unit 154. The menu creating unit 154 generates and outputs to the signal combining unit 130A a menu display signal such as a signal that displays the selected and specified operation area in a form different from the other areas based on the inputted signal.

The other operations are substantially the same as the foregoing embodiment, and descriptions thereof will be omitted.

The present exemplary modification described above, similar to the foregoing embodiment, comprises the menu creating unit 154 that creates a menu display signal for displaying an operation menu ME on the liquid crystal display unit 3 provided in the image display apparatus 1; the camera 110 with an infrared filter capable of recognizing, in distinction from visible light that comes from the background of the remote controller 200, an infrared signal that comes from the remote controller 200 and shows condition and attributes different from the visible light; the remote controller position identifying unit 155 that identifies the position which the remote controller 200 occupies during image capturing by the camera 110 with an infrared filter on the basis of the recognition result of the infrared signal of the camera 110 with an infrared filter; the remote controller position signal creating unit 156 that generates a position display signal for displaying on the liquid crystal display unit 3 the position of the remote controller 200 identified by the remote controller position identifying unit 155; and the user operation judging unit 152 that determines the operation area of the operation menu ME displayed on the liquid crystal display unit 3 based on the position of the remote controller 200 identified by the remote controller position identifying unit 155, thereby enabling use of the position display MA of the remote controller 200 of the liquid crystal display unit 3 as a pointer for selecting and specifying an operation area from the operation menu ME. As a result, the operator S can easily select and specify a desired operation area of the operation menu ME and perform the corresponding operation using the very physically and intuitively easy-to-understand operation of moving the position of the remote controller 200 itself without looking away from the liquid crystal display unit 3. At this time, the burden on the operator S is not increased since gesture memorization is not required as in the case of prior art, thereby improving the convenience of the operator during remote control.

(12) When Using a Wired Controller

While the above describes an example of a case where the remote controller 200 for performing radio remote control is used as a handheld controller on the operator side, the present invention is not limited thereto. That is, a wired handheld controller may also be used with the image display control apparatus 100 and a predetermined cable, etc.

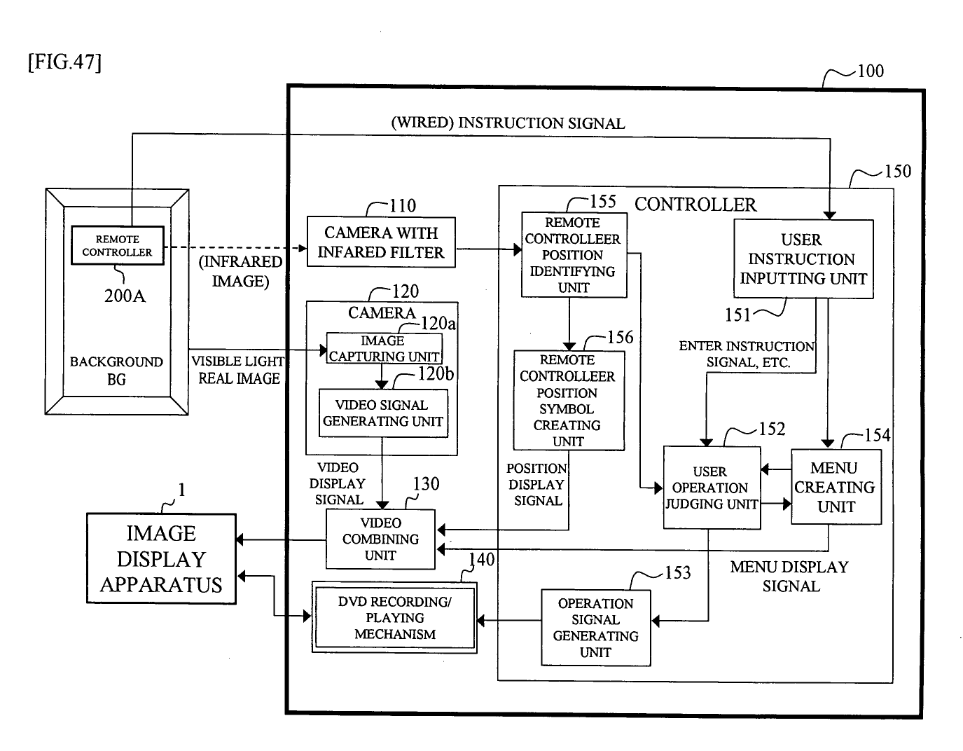

FIG. 47 is a functional block diagram shows an example of the functional configuration of the image display control apparatus 100 of this exemplary modification, and corresponds to the above-described FIG. 3, etc. Note that the parts identical to those in FIG. 3 are denoted using the same reference numerals, and descriptions thereof will be suitably omitted. In FIG. 47, the present exemplary modification comprises in place of the remote controller 200 of FIG. 3 a wired (so-called pendant type) handheld controller 200A that fulfills the same function, and connects by wire the controller 200A and the user instruction inputting unit 151 using an appropriate wire, cable, etc. Thus, the infrared receiving unit 101, the FM demodulator 102, the BPF 103, and the pulse demodulator 104 are omitted.

In FIG. 47, in the present exemplary modification, the signal outputted from the controller 200A in response to a predetermined operation instruction from the operator S is inputted to the user instruction inputting unit 151 via the cable, etc. Then, the user operation judging unit 152 outputs the operation instruction signal corresponding to the signal inputted by the user instruction inputting unit 151 to the operation signal generating unit 153, and the operation signal generating unit 153 generates and outputs to the DVD recording/playing mechanism 140 a corresponding operation signal in response to that operation instruction signal. The other operations are the same as the foregoing embodiment, and descriptions thereof will be omitted.

The present exemplary modification described above, similar to the foregoing embodiment, comprises the menu creating unit 154 that creates a menu display signal for displaying an operation menu ME on the liquid crystal display unit 3 provided in the image display apparatus 1; the camera 110 with an infrared filter capable of recognizing, in distinction from visible light that comes from the background of the controller 200A, an infrared signal that comes from the controller 200A and shows condition and attributes different from the visible light; the remote controller position identifying unit 155 that identifies the position which the controller 200A occupies during image capturing by the camera 110 with an infrared filter on the basis of the recognition result of the infrared signal of the camera 110 with an infrared filter; the remote controller position signal creating unit 156 that generates a position display signal for displaying on the liquid crystal display unit 3 the position of the controller 200A identified by the remote controller position identifying unit 155; and the user operation judging unit 152 that determines the operation area of the operation menu ME displayed on the liquid crystal display unit 3 based on the position of the controller 200A identified by the remote controller position identifying unit 155. With the arrangement, it is possible to be able to use the position display MA of the controller 200A on the liquid crystal display unit 3 as a pointer for selecting and specifying an operation area from the operation menu ME. As a result, the operator S can easily select and specify a desired operation area of the operation menu ME and perform the corresponding operation using the very physically and intuitively easy-to-understand operation of moving the position of the controller 200A itself without looking away from the liquid crystal display unit 3. At this time, the burden on the operator S is not increased since gesture memorization is not required as in the case of prior art, thereby improving the convenience of the operator during remote control.

(13) Other

(1) When the Range Selectable and Specifiable from the Operation Menu, Etc., is Restricted

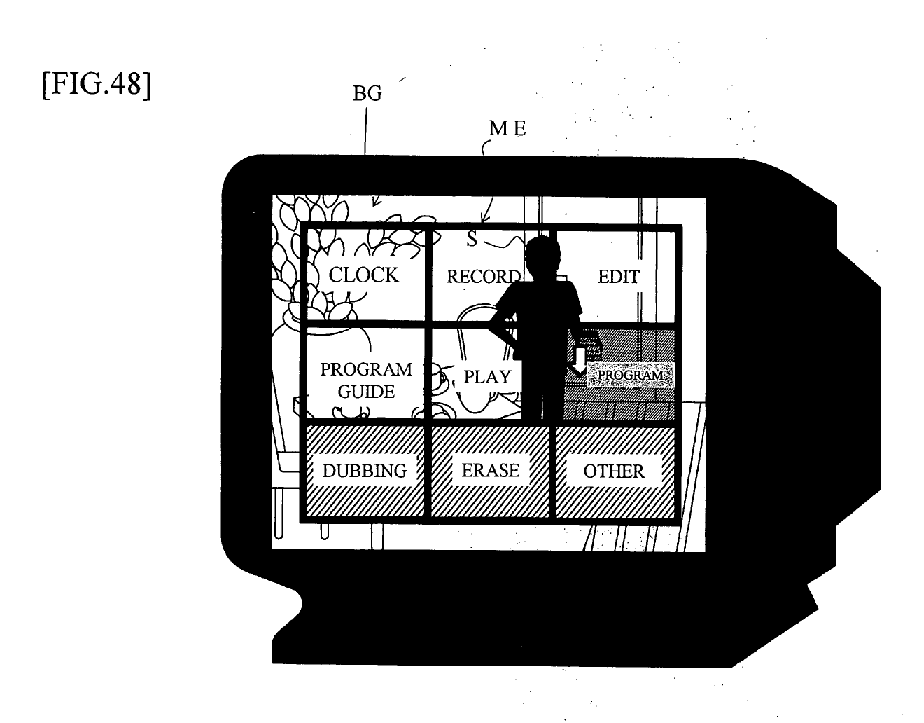

For example, restrictions may be placed so that several of the plurality of operation areas included in the operation menu ME displayed on the liquid crystal display unit 3 in FIG. 6, etc., cannot be selected or specified. FIG. 48 shows a display example of the liquid crystal display unit 3 of such a case, where the text display of the “Dubbing,” “Erase,” and “Other” areas of the “Clock (Set Time),” “Record,” “Edit,” “Program Guide,” “Play,” “Program,” “Dubbing,” “Erase,” and “Other” areas included in the operation menu display in this case appears different from the others (in outline format on a colored background), and the video captured by the camera 120 is not displayed in each area (in other words, the menu creating unit 154 generates a menu display signal that results in such a display). That is, the display of the real world is restricted to only the selectable areas. With this arrangement, the areas that are selectable and specifiable and the areas that are not are obvious at a glance for the operator S.

(2) Example where all Operation Areas are Selectable in a Narrow Movement Range of the Remote Controller

For example, to make each “Clock (Set Time),” “Record,” “Edit,” “Program Guide,” “Play, “Program,” “Dubbing,” “Erase,” and “Other” area of the operation menu ME displayed substantially across the entire screen of the liquid crystal display unit 3 selectable and specifiable in FIG. 6, etc., the operator S must stretch his/her hand to the left and right in the same location to move the remote controller 200 left and right and, in some cases, must walk in the room if such movement is insufficient.

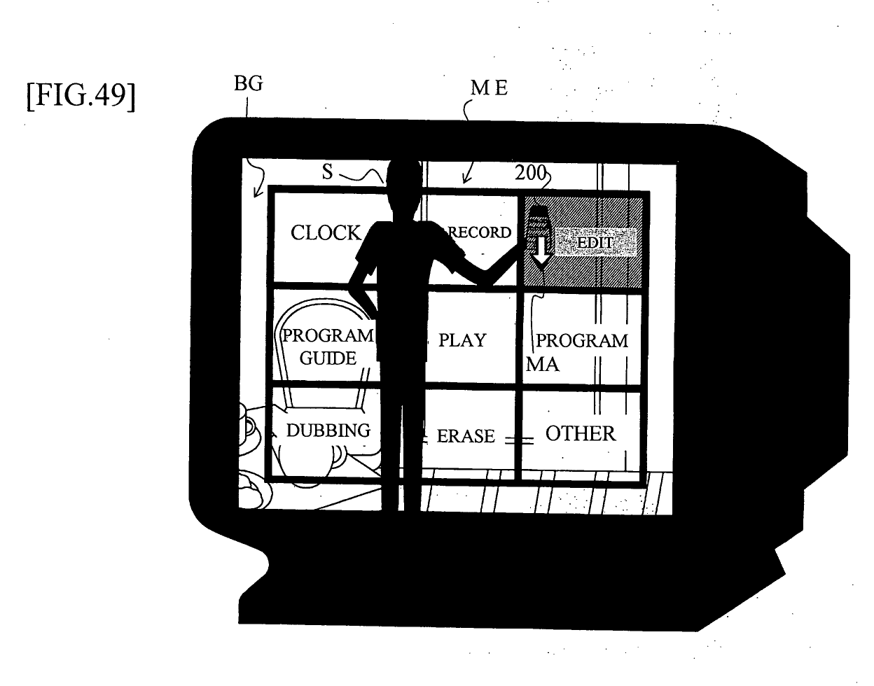

The present exemplary modification thus enables selection and specification of all operation areas with as little movement of the remote controller 200 as possible. In this example, a known facial image recognition technique is used to detect and recognize a face near the remote controller 200 when the mode enters the above mentioned menu selection mode, and the video signal generating unit 120b of the camera 120 processes and outputs the video signal to the video combining unit 130 so that only the area that is to a certain extent below that position becomes the operation range. As a result, the operation menu ME of a typical shape and the captured video of the background (room) BG that has been processed (distorted so that the vertical direction is greatly enlarged and the horizontal direction is slightly enlarged in this example) so that the relatively small range below the neck of the operator S substantially extends across the entire screen of the liquid crystal display unit 3, as shown in FIG. 49. With this arrangement, the operator S can select and specify a desired operation area based on the smaller movement behavior (the movement in the relatively small range below the neck in this example) of the remote controller 200. Furthermore, the operation range is identified according to the position of the operator S, thereby also enabling a decrease in the movement amount of the remote controller 200 required for operation.

(3) Variations of Video Superimposing Method

While in the above the operation menu ME, the position display MA of the remote controller 200, and the captured video of the background BG of the remote controller 200 captured by the camera 210 are all displayed superimposed on the liquid crystal display unit 3 as shown in FIG. 6, etc., the present invention is not limited thereto. That is, the above is not absolutely necessary as long as the position display MA is used as the operation menu ME pointer to achieve the advantage of enabling the operator S to easily select and specify an operation area using the very physically and intuitively easy-to-understand operation of moving the position of the remote controller 200 itself without looking away from the liquid crystal display unit 3. That is, for example, among the position display MA of the remote controller 200, the operation menu ME, and the captured video of the background BG, two may be displayed superimposed in the same area on the liquid crystal display unit 3 while the remaining one is displayed on an adjacent (or interposed) separate screen or separate window. Or, all three may be separately arranged (or interposed) horizontally and displayed on separate screens or separate windows. In this case as well, the above advantage can be achieved if all three are displayed in list format so that the operator S can view them virtually simultaneously on the same liquid crystal display unit 3.

(4) When Recorded Captured Video is Used

While, for example, the captured video of the background BG of the remote controller 200 is captured by the regular camera 120 (in real-time), the video display signal is outputted to the video combining unit 130, and the position information signal of the remote controller 200 from the remote controller position symbol creating unit 156 based on the image captured by the camera 110 with an infrared filter and the menu display signal from the menu creating unit 154 are combined and displayed on the liquid crystal display unit 3 in the foregoing embodiment, etc., the present invention is not limited thereto.

That is, in a case where temporally there is no significant variation in the background BG, or where such an exact video of the background BG is not required, etc., only one camera may be provided, and the image of the background BG only may be captured (i.e., used as the same function as the camera 120) and recorded by an appropriate recording device in advance. Subsequently, an infrared filter may be attached to that camera to capture the infrared image of the remote controller 200 (i.e., used for the same function as the camera 110), the image recorded by the recording device may be played, and the video display signal may be continually outputted to the video combining unit 130 so that the position information signal of the remote controller 200 from the remote controller position symbol creating unit 156 based on the image captured by the camera to which the infrared filter was installed and the menu display signal from the menu creating unit 154 are combined in the video combining unit 130 and displayed on the liquid crystal display unit 3.

In this case, while the captured video becomes the image of only the background BG in which the remote controller 200 and the operator S do not exist, and the operation menu ME and remote controller position display MA are displayed superimposed, as in the foregoing embodiment, the advantage of enabling the operator S to easily select and specify an operation area using the very physically and intuitively easy-to-understand operation of moving the position of the remote controller 200 itself without looking away from the liquid crystal display unit 3 is achieved. Further, the advantage of being able to construct a more inexpensive system since one camera is sufficient is also achieved.

(5) When Reflected Light is Used

While the remote controller 200 itself emits infrared light as the second light in the above, the present invention is not limited thereto and, for example, infrared light may be projected from the image display control apparatus 100 (or from a separate device), and the remote controller 200 may transmit an infrared image and/or an infrared instruction signal to the image display control apparatus 100 by reflecting this infrared light. In this case as well, the same advantage as that of the foregoing embodiment is achieved, and the advantage of not requiring a power supply is also achieved since the infrared emitting function of the remote controller 200 is no longer needed.

(6) When Light Other than Infrared Light is Used

While regular visible light was established as the first light entering the camera 120, etc., from the background BG of the remote controller 200, and infrared light was established as the second light entering the camera 110, etc., from the remote controller 200 in the above, the present invention is not limited thereto. For example, the second light may be light having a different wavelength than visible light (i.e., light comprising a wavelength outside the wavelength range of visible light) such as another infrared light, etc., for example. Additionally, the attributes such as wavelength do not necessarily have to be different. For example, light having the same attributes but different only in form may be used, such as establishing the first light as continual regular visible light and the second light as intermittent visible light emitted intermittently, etc. Furthermore, in a case where the first light that comes from the background has a certain attribute, such as in a case where the background is completely white, visible light with a different attribute (such as a red color, for example) may be used as the second light. The point is that as long as the second light comprises attributes and a form that permit recognition in distinction from the first light, the advantage of enabling the operator S to easily select and specify an area using a very physically and intuitively easy-to-understand operation as described above is achieved.

(7) Application to Other AV Devices, Etc.

While the above describes an example where the image display control apparatus 100 is a DVD player/recorder, the present invention is not limited thereto. That is, the image display control apparatus 100 may be any control apparatus comprising a video output function that outputs video to a video output apparatus such as a video deck, CD player/recorder, or MD player/recorder, a contents playing apparatus, or other image display apparatus 1. For example, in a case of a video deck, CD player/recorder, MD player/recorder, etc., a known video tape, CD, and MD recording/playing mechanism and the video tape, CD, and MD storing unit, etc., are provided in the housing 101.

Furthermore, the present invention is not limited within items used in a general household, but may be applied to use in an office or institute, for example. Additionally, the present invention is not limited within a fixed layout, but may be applied to the various devices of in-car audio devices, etc.

(8) Integrating the Display Control Apparatus and Display Apparatus

While the above describes as an example of a case where the image display control apparatus 100 and image display apparatus 1 are separate apparatuses and the system is configured by respectively dividing the functions, the present invention is not limited thereto. That is, the present invention may be configured as one image display apparatus wherein the function of the image display control apparatus 100 is incorporated therein.

In this case, the function of the menu creating unit 154 as the object display signal generating device, and the function of the remote controller position symbol creating unit 156 as the position display signal generating device, etc., are all incorporated in the image display apparatus, and the technical ideas of the present invention are realized in an image display apparatus comprising a display screen; a object display controlling device that displays an operable object on the display screen; a second light image capturing device capable of recognizing, in distinction from a first light that comes from the background of a handheld controller, a second light that comes from the controller and shows condition and attributes different from the first light; a position identifying device that identifies the position which the controller occupies during image capturing by the second light image capturing device on the basis of the recognition result of the second light of the second light image capturing device; a position display controlling device that displays on the display screen the position of the controller identified by the position identifying device; and an operation area determining device that determines the operable specification object of the operable object displayed on the display screen based on the position of the controller identified by the position identifying device.

Note that various modifications which are not described in particular can be made according to the present invention without departing from the spirit and scope of the invention.

1-24. (canceled)

25. An image display control apparatus comprising:
an object display signal generating device that generates an object display signal for displaying an operable object on a display screen provided in an image display apparatus;
a second light image capturing device capable of recognizing, in distinction from a first light that comes from the background of a handheld controller, a second light that comes from said controller and shows condition and attributes different from said first light;
a position identifying device that identifies the position which said controller occupies during image capturing by said second light image capturing device on the basis of the recognition result of said second light of said second light image capturing device;
a position display signal generating device that generates a position display signal for displaying on said display screen the position of said controller identified by said position identifying device;
an operation area determining device that determines the operable specification object of said operable object displayed on said display screen, based on the position of said controller identified by said position identifying device; and
a first light image capturing device that captures said first light that comes from the background of said controller.

26. The image display control apparatus according to claim 25, wherein said second light image capturing device is capable of recognizing, in distinction from said first light, said second light that comes from said controller of a remote scheme wherein signal transmission and reception are performed based on radio communication.

27. The image display control apparatus according to claim 25, wherein said object display signal generating device generates said object display signal that displays said operable specification object of said operable object determined by said operation area determining device on said display screen in a form different from that of other areas.

28. The image display control apparatus according to claim 25, further comprising a video display signal generating device that generates a video display signal for displaying on said display screen the background of said controller captured by said first light image capturing device.

29. The image display control apparatus according to claim 28, wherein said object display signal generating device, said position display signal generating device, and said video display signal generating device generate said object display signal, said position display signal, and said video display signal that display said operable object, the position of said controller, and the background of said controller superimposed on said display screen.

30. The image display control apparatus according to claim 29, further comprising an extraction processing device extracts a part of the background of said controller in said video display signal generated by said video display signal generating device, and displays the enlarged part of said background on said display screen.

31. The image display control apparatus according to claim 30, further comprising a distance detecting device that detects the distance to said controller, wherein said extraction processing device determines the mode of said extraction and enlargement according to the detection result of said distance detecting device.

32. The image display control apparatus according to claim 30, wherein said extraction processing device determines the mode of said extraction and enlargement according to the movement information of said controller recognized based on said video display signal generated by said video display signal generating device, or the identified position identification result of said position identifying device.

33. The image display control apparatus according to claim 30, wherein said extraction processing device determines the mode of said extraction and enlargement so as to avoid video of an obstacle between said image display control apparatus and said controller in said video display signal generated by said video display signal generating device.

34. The image display control apparatus according to claim 29, further comprising a object position setting device for setting not to superimposed the display position of said operable object on said display screen on video of an obstacle between said image display control apparatus and said controller in said video display signal generated by said video display signal generating device.

35. The image display control apparatus according to claim 29, further comprising an estimated position setting device sets an estimated movement position of said controller that differs from the identified position, that is based on movement information of said controller recognized on the basis of the identified position result from said position identifying device.

36. The image display control apparatus according to claim 35, wherein said estimated position setting device sets said estimated movement position so that the position is in the intermediate area between two neighboring points successively identified by said position identifying device when said controller is moved.

37. The image display control apparatus according to claim 35, wherein said estimated position setting device sets said estimated movement position on a line extended in the movement direction successively identified by said position identifying device when said controller is moved.

38. The image display control apparatus according to claim 28, wherein said second light image capturing device receives and recognizes light comprising a wavelength outside the wavelength range of visible light, as said second light.

39. The image display control apparatus according to claim 38, wherein said second light image capturing device is a camera with an infrared filter capable of recognizing infrared light as said second light, in distinction from visible light as said first light.

40. The image display control apparatus according to claim 38, wherein said second light image capturing device is a highly-sensitive infrared camera serving as said first light image capturing device as well, wherein the sensitivity with respect to infrared light as said second light is higher than the sensitivity with respect to visible light as said first light.

41. The image display control apparatus according to claim 28, further comprising a correcting device that corrects the position of said controller based on the identification of said position identifying device, or corrects the video display signal generated by said video display signal generating device, in accordance with the image capturing result from said first light image capturing device and the image capturing result from said second light image capturing device.

42. The image display control apparatus according to claim 25, further comprising an instruction signal inputting device that inputs an enter instruction signal from said controller, wherein said operation area determining device determines said operable specification object of said operable object, in accordance with the position of said controller identified by said position identifying device, and said enter instruction signal inputted by said instruction signal inputting device.

43. The image display control apparatus according to claim 25, wherein said second light image capturing device receives and recognizes a predetermined optical signal emitted by said controller as said second light.

44. An image display apparatus comprising:
a display screen;
an object display control device that displays an operable object on said display screen;
a second light image capturing device capable of recognizing, in distinction from a first light that comes from the background of a handheld controller, a second light that comes from said controller and shows condition and attributes different from said first light;
a position identifying device that identifies the position which said controller occupies during image capturing by said second light image capturing device on the basis of the recognition result of said second light of said second light image capturing device;
a position display controlling device that displays on said display screen the position of said controller identified by said position identifying device;
an operation area determining device that determines the operable specification object of said operable object displayed on said display screen, based on the position of said controller identified by said position identifying device; and
a first light image capturing device that captures said first light that comes from the background of said controller.

45. A handheld remote controller for performing image display operations, comprising:
an optical signal generating device that generates an optical signal having condition and attributes different from regular visible light; and
an optical signal transmitting device that transmits said optical signal generated by said optical generating device to an image display control apparatus; wherein said image display control apparatus comprising: a second light image capturing device capable of recognizing, in distinction from said regular visible light, said optical signal; a first device that generates a signal for displaying an operable object on a display screen; a second device that generates a signal for identifying and displaying on said display screen the position which said remote controller occupies during image capturing by said second light image capturing device in the video of the background of said remote controller, on the basis of the recognition result of said optical signal of said second light image capturing device; a third device that generates a signal for determining and displaying the operable specification object of said operable object displayed on said display screen based on said identified position of said remote controller; and
a first light image capturing device that captures said regular visible light that comes from the background of said controller.

46. An image display system comprising a handheld controller and an image display control apparatus that generates a signal for displaying an image based on the operation of said controller, wherein:
said image display control apparatus comprises an object display signal generating device that generates an object display signal for displaying an operable object on a display screen provided in an image display apparatus; a second light image capturing device capable of recognizing, in distinction from a first light that comes from the background of said controller, a second light that comes from said controller and shows condition and attributes different from said first light; a position identifying device that identifies the position which said controller occupies during image capturing by said second light image capturing device on the basis of the recognition result of the second light of said second light image capturing device; a position display signal generating device that generates a position display signal for displaying on said display screen the position of said controller identified by said position identifying device; an operation area determining device that determines the operable specification object of the operable object displayed on said display screen, based on the position of said controller identified by said position identifying device; and a first light image capturing device that captures said first light that comes from the background of said controller.

47. An image display system comprising:
a handheld controller;
an object display signal generating device that generates an object display signal for displaying an operable object on a display screen provided in an image display apparatus;
a second light image capturing device capable of recognizing, in distinction from a first light that comes from the background of said controller, a second light that comes from said controller and shows condition and attributes different from said first light;
a position identifying device that identifies the position which said controller occupies during image capturing by said second light image capturing device on the basis of the recognition result of said second light of said second light image capturing device;
a position display signal generating device that generates a position display signal for displaying on said display screen the position of said controller identified by said position identifying device;
an operation area determining device that determines the operable specification object of said operable object, based on the position of said controller identified by said position identifying device; and
a first light image capturing device that captures said first light that comes from the background of said controller.
